(19) United States
(12) Patent Application Publication
(10) Pub. No.: US 2018/0150869 A1
(43) Pub. Date: May 31, 2018

(54) SYSTEM, METHOD, AND PROGRAM PRODUCT FOR IDENTIFYING DISCOUNTED ITEMS

(71) Applicant: Jet.com, Inc., Hoboken, NJ (US)

(72) Inventors: Katie Finnegan, New York, NY (US); Erica Bell, New York, NY (US)

(73) Assignee: Jet.com, Inc., Hoboken, NJ (US)

(21) Appl. No.: 15/881,787

(22) Filed: Jan. 28, 2018

Related U.S. Application Data
(62) Division of application No. 14/328,691, filed on Jul. 10, 2014.
(60) Provisional application No. 61/856,549, filed on Jul. 19, 2013.
(60) Provisional application No. 61/909,187, filed on Nov. 26, 2013.
(60) Provisional application No. 61/933,463, filed on Jan. 30, 2014.

(51) Int. Cl. G06Q 30/02

(52) U.S. Cl. CPC G06Q 30/0239

(57) ABSTRACT

A system for receiving a request associated with a pre-defined user purchase criteria for a product of one or more products from a software application (“app”) installed on an electronic device of a user, wherein the product is stored in a user database; retrieving a pre-determined threshold price, for the product; monitoring prices for the product and at least one discount applicable to the product at one or more websites of retailers based on the pre-defined user purchase criteria and the pre-determined threshold price; based on the monitoring, determining when an effective price for the product matches the pre-defined user purchase criteria and is less than the pre-determined threshold price for the product, wherein the effective price is determined based on the at least one discount, and the at least one discount has a coupon code; confirming whether the coupon code is active; when the coupon code is confirmed to be active, transmitting a notification comprising the coupon code and a period of time when the coupon code remains active from a particular website of a particular retailer to the software app to be displayed on a graphical user interface of the electronic device of the user, wherein the user (a) accepts the notification, (b) declines the notification, or (c) requests other coupons, and wherein the one or more websites comprise the particular website, and the retailers comprise the particular retailer; and upon acceptance of the notification by the user, automatically displaying the coupon code to the graphical user interface of the electronic device of the user.

### CROSS-REFERENCE TO RELATED APPLICATIONS

This application is a divisional of U.S. patent application Ser. No. 14/328,691, filed Jul. 10, 2014, which claims the benefit of U.S. Provisional Application No. 61/856,549, filed Jul. 19, 2013; U.S. Provisional Application No. 61/909,187, filed Nov. 26, 2013; and U.S. Provisional Application No. 61/933,463, filed Jan. 30, 2014. U.S. patent application Ser. No. 14/328,691; and U.S. Provisional Application Nos. 61/856,549, 61/909,187, and 61/933,463 are incorporated herein by reference in their entirety.

### FIELD

The present invention generally relates to systems, methods, and program products for facilitating sales, in particular monitoring prices and identifying discounted items for sale.

### SUMMARY

Systems, methods, and program products for identifying discounted items for sale are provided. A user of the system may select for storage, from one or more merchants, information related to one or more items for sale. The user may specify discount notification criteria to govern when the user may receive notifications regarding the prices of the one or more items related to the stored information. They system may monitor the prices of the items, and when the prices satisfy the discount notification criteria, the system may notify the user that the current price of the item satisfies the user's notification criteria. In embodiments, the system may monitor the availability of discounts using coupon codes and include the information relating to the coupon codes in email notifications to users to allow users to obtain discounts associated with such coupon codes. In embodiments, program products may be used with mobile devices to store information associated with items from one or more physical retail stores.

In some implementations, a processor-implemented method for allocating discounts may comprise receiving a product-discount request from a user for a product, extracting via a processor information associated with a preference identifier associated with the product from the product-discount request, querying via the processor a database for an indication of at least one discount, determining if the at least one discount is applicable for the product based on the information associated with the preference identifier, and providing via the processor the at least one discount to the user if the at least one discount is applicable for the product.

### BRIEF DESCRIPTION OF THE DRAWINGS

Exemplary embodiments of the present invention will be described with references to the accompanying figures, wherein:

FIG. 1 is a schematic diagram of an exemplary system to identify discounted prices in accordance with exemplary embodiments of the present invention.

FIG. 2 is a schematic diagram of an exemplary user device used in the system to identify discounted prices in accordance with exemplary embodiments of the present invention.

FIG. 3A is schematic diagram of an exemplary payment fulfillment server in accordance with exemplary embodiments of the present invention.

FIG. 3B is schematic diagram of an exemplary server in the system to identify discounted prices in accordance with exemplary embodiments of the present invention.

FIGS. 3C-31 are schematic diagrams of an exemplary server in the system to identify discounted prices in accordance with exemplary embodiments of the present invention.

FIGS. 4A and 4B are flow charts of exemplary processes for a user to obtain software to interface between the program product and websites offering items for sale in accordance with exemplary embodiments of the present invention.

FIGS. 5A and 5B are exemplary screen shots of a website providing software to interface between the program product and websites offering items for sale in accordance with exemplary embodiments of the present invention.

FIG. 6 is an exemplary screen shot of a website sign-up screen in accordance with exemplary embodiments of the present invention.

FIG. 7 is an exemplary screen shot of a website login screen in accordance with exemplary embodiments of the present invention.

FIGS. 8A-8G are exemplary screen shots of the interface provided by the software to store information related to an item for sale for later action in accordance with exemplary embodiments of the present invention.

FIGS. 9A-9E are exemplary screen shots of a web site associated with the program product that displays items for sale whose information was stored by a user in accordance with exemplary embodiments of the present invention.

FIGS. 10A-10F are exemplary screen shots of a notification of a discounted price of an item for sale in accordance with exemplary embodiments of the present invention.

FIGS. 11A-11C are flow charts of exemplary processes for storing information related to an item for sale at a user's request and providing a notification of discounted prices in accordance with exemplary embodiments of the present invention.

FIGS. 12A-12C are flow charts of exemplary processes by which a user may request storage of information related to an item for sale for later action in accordance with exemplary embodiments of the present invention.

FIG. 13A is a flow chart of an exemplary process by which a user may access stored information related to an item for sale and perform optional actions in accordance with exemplary embodiments of the present invention.

FIG. 13B is a flow chart of an exemplary process to provide a user with access to stored information related to items for sale and providing optional actions in accordance with exemplary embodiments of the present invention.

FIGS. 14A-D are flow charts of exemplary processes for attribute assignment and filtering in accordance with exemplary embodiments of the present invention.

FIGS. 15A-B are flow charts of an exemplary administrative process to identify discounted items in accordance with exemplary embodiments of the present invention.

FIG. 16 is a flow chart of an exemplary administrative process to identify discounted items and store item price information for future analysis in accordance with exemplary embodiments of the present invention.

FIG. 17 a schematic diagram of a website that presents exemplary attributes in accordance with exemplary embodiments of the present invention

FIGS. 18A-C are flow charts of exemplary processes to display product recommendations in accordance with exemplary embodiments of the present invention.

FIG. 19 is a screen shot of an exemplary website related to the process of identifying suggested product recommendations, providing up-to-date sale price information of those products, providing links to the products and the ability to share that product with a user's contacts in accordance with exemplary embodiments of the present invention.

FIGS. 20A-B are flow charts of exemplary processes to apply coupon codes to a product and send a notification to a user as well as to apply a coupon code to a product in real-time when the item storing and discount notification technology is used on a merchant's website in accordance with exemplary embodiments of the present invention.

FIG. 21A is a flow chart of an exemplary process that takes user stored items and transforms them into products and product variants in accordance with exemplary embodiments of the present invention.

FIGS. 21B-C are flow charts of exemplary processes for creating associations between product variants in accordance with exemplary embodiments of the present invention.

FIG. 22 is a flow chart of an exemplary process for setting strike prices for automatic purchase of chosen product variants in accordance with exemplary embodiments of the present invention.

FIG. 23 is a flow chart of an exemplary process for monitoring product variants and executing an automatic purchase of chosen products in accordance with exemplary embodiments of the present invention.

FIG. 24 is a flow chart of an exemplary process to provide users with the ability to create product registries for weddings, babies, and other similar events in accordance with exemplary embodiments of the present invention.

FIG. 25 is an exemplary screen shot of a website sign-up or login screen in accordance with exemplary embodiments of the present invention.

FIG. 26 is an exemplary screen shot of an interface provided by software to store information related to an online retailer visited by a user and to store information associated with a product in accordance with exemplary embodiments of the present invention.

FIG. 27 is an exemplary screen shot of an interface provided by software to provide instructions for obtaining product information necessary to store data associated with a product while shopping in a store in accordance with exemplary embodiments of the present invention.

FIG. 28 is an exemplary screen shot of an interface provided by software for a user to enter product information in order to store data associated with a product in accordance with exemplary embodiments of the present invention.

FIG. 29 is an exemplary screen shot of the interface provided by software to store information related to an item for sale for later action in accordance with exemplary embodiments of the present invention.

### DETAILED DESCRIPTION

An embodiment of a system comprises: one or more processing modules; and one more non-transitory memory storage modules storing computing instructions configured to run on the one or more processing modules and perform: receiving a request associated with a pre-defined user purchase criteria for a product of one or more products from a software application (“app”) installed on an electronic device of a user, wherein the product is stored in a user database; retrieving a pre-determined threshold price, for the product; monitoring prices for the product and at least one discount applicable to the product at one or more websites of retailers based on the pre-defined user purchase criteria and the pre-determined threshold price; based on the monitoring, determining when an effective price for the product matches the pre-defined user purchase criteria and is less than the pre-determined threshold price for the product, wherein the effective price is determined based on the at least one discount, and the at least one discount has a coupon code; confirming whether the coupon code is active; when the coupon code is confirmed to be active, transmitting a notification comprising the coupon code and a period of time when the coupon code remains active from a particular website of a particular retailer to the software app to be displayed on a graphical user interface of the electronic device of the user, wherein the user (a) accepts the notification, (b) declines the notification, or (c) requests other coupons, and wherein the one or more websites comprise the particular website, and the retailers comprise the particular retailer; and upon acceptance of the notification by the user, automatically displaying the coupon code to the graphical user interface of the electronic device of the user.

An embodiment of a method comprises: receiving, with a computer system using one or more processors, a request associated with a pre-defined user purchase criteria for a product of one or more products from a software application (“app”) installed on an electronic device of a user, wherein the product is stored in a user database; retrieving, with the computer system, a pre-determined threshold price, for the product; monitoring, with the computer system, prices for the product and at least one discount applicable to the product at one or more websites of retailers based on the pre-defined user purchase criteria and the pre-determined threshold price; based on the monitoring, determining, with the computer system, when an effective price for the product matches the pre-defined user purchase criteria and is less than the pre-determined threshold price for the product, wherein the effective price is determined based on the at least one discount, and the at least one discount having a coupon code; confirming, with the computer system, whether the coupon code is active; when the coupon code is confirmed to be active, transmitting, with the computer system, a notification comprising the coupon code and a period of time when the coupon code remains active from a particular website of a particular retailer to the software app to be displayed on a graphical user interface of the electronic device of the user, wherein the user (a) accepts the notification, (b) declines the notification, or (c) requests other coupons, and wherein the one or more websites comprise the particular website, and the retailers comprise the particular retailer; and upon acceptance of the notification by the user, automatically displaying, with the computer system, the coupon code to the graphical user interface of the electronic device of the user.

The present invention generally relates to systems, methods, and program products for identifying and/or providing notification of discounted items for sale. In some implementations, users may be able to obtain discounts for products sold by merchants, e.g., from a website aggregating a plurality of products from a plurality of third-party merchant websites (e.g., as search results from the plurality of third-party merchant websites), from a mobile device application with access to the plurality of products from the plurality of third-party websites, and/or from a mobile product-discount search device provided in a retail store and configured to run software which allows the user to view the plurality of products from a plurality of merchants. In some implementations, a discount may be a coupon and/or coupon code, a cart checkout coupon (e.g., a coupon which activates when a user checks out at a merchant with a product eligible for the coupon), a price markdown, and/or a similar type of product price modifier.

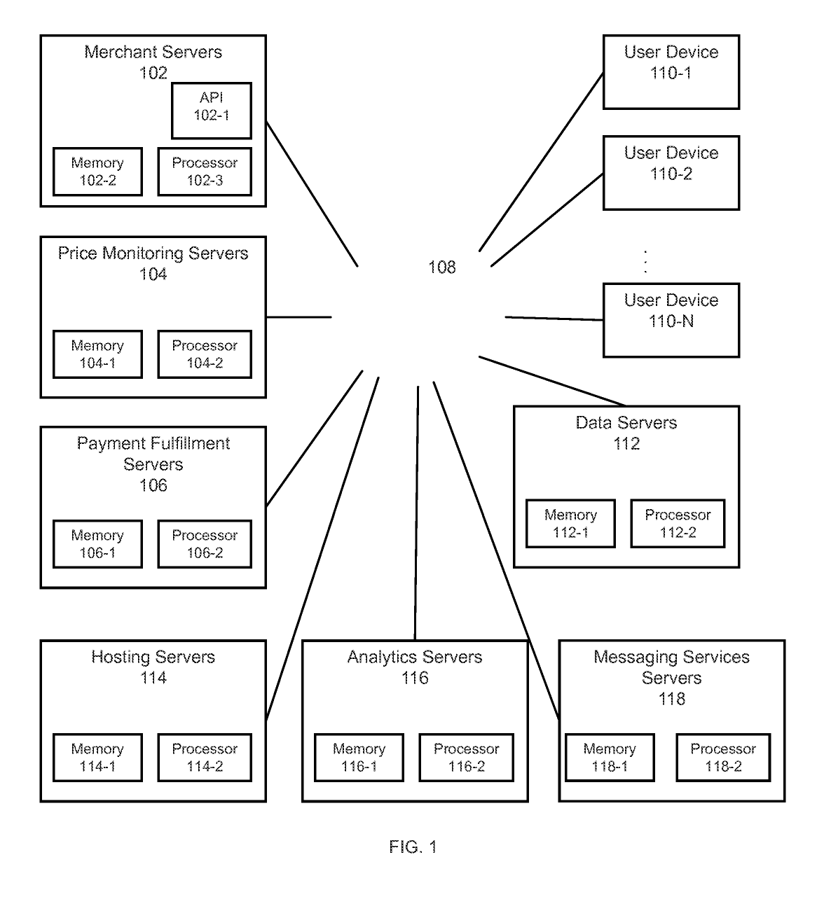

The user may request a product discount, which may invoke a system such as the exemplary system in FIG. 1, to extract data from the request, such as product data and/or a preference identifier. In some implementations a preference identifier may be uniquely associated with at least one of product attribute settings and at least one notification setting stored in a database and related to the product. Examples of product attribute settings include a product SKU, a product description, a size (e.g., weight, dimensions, clothing size), a color, a product type (e.g. shirt, dress, mobile phone, smart phone), a sale status (e.g. on sale, regular price, flash sale), a brand, a department (e.g., electronics, clothing, food, furniture), a category, a discount exclusion list, fabric, a fit, a style, a gender, and a condition (e.g., new, used, refurbished). The product notification setting may include a user-defined preference of when the user should be notified of discounts for the product associated with the preference identifier. For example, a user may be able to indicate that she would only like notifications of discounts once a discount is above a provided threshold, once the price of a discounted product falls below a specified threshold, once a discount for a product is available at a particular merchant, once a discount for a related product has been found, and/or under similar scenarios.

The system may use the preference identifier to query a database for any discounts which match the product attribute settings associated with the preference identifier, e.g., by determining which (if any) discounts in the database match the attributes of the product the user would like a discount for. For example, discounts may contain lists and/or other aggregations of various products and/or product attributes to which they may be applied. For example, a discount may indicate it is applicable to T-shirt from Guess which have a particular SKU, are blue, and are sizes Large to )0(L. The system may therefore determine whether at least some (or in some cases, all) of the attributes specified in the discount match the data specified by the preference identifier. The system may also check the discount to determine whether it is still valid, may determine if the product requested is still in stock at the merchant(s) offering the discount, and/or may perform similar checks in order to ensure that the discount can be properly used to discount the requested product. The system may also associate the discount with the requested product (e.g., by linking the product to the discount in the database) if the discount has been determined to be functional and applicable to the product, and/or may disassociate a discount with a product if the discount has been deactivated, or otherwise is no longer applicable to the product. In some implementations, discounts may already be pre-associated with particular products, and the system may search for products which match the user's preference identifier information in order to determine whether a working discount exists for the product.

If a discount or a collection of discounts is found which may be applied to the product, the system may provide the discount or collection of discounts to the user, and the user may choose to accept the discount and use it towards the product, to search for discounts for other products, or to set a notification for the product to be notified if other discounts for the product enter the database. If the user requests discounts for multiple products, the system may infer, based on product identifiers for each product, trends in terms of which product attributes tend to be requested most by the user (e.g., whether the user usually requests discounts for blue products, or mostly requests discounts for electronics, or mostly requests discounts for products at a particular merchant, etc.). The system may store such trends in the user's profile (e.g., in a user product profile), and may use the correlations to offer tailored discount recommendations to the user even when the user has not specified a particular product to obtain a discount for.

Referring to FIG. 1, the systems, methods and program products of the present invention can generally be operated within a system comprising one or more user electronic devices that interact through a network with one or more merchant servers 102 that offer goods for sale via a web page or electronic application, one or more price monitoring servers 104 that can monitor prices of items for sale and/or can detect changes in price and/or identify discount coupons that can be applied by consumers, one or more transaction (e.g., payment fulfillment) servers 106 that can process transactions, e.g., purchases of items for sale, and/or one or more data servers 112 to store information, such as login information, stored information related to items for sale, purchase information (e.g., credit card information, billing address, to name a few), and/or contact information, to name a few.

In order to notify users of discounts the system may be configured to facilitate monitoring of the discount database to determine when new discounts are added, and to determine which users and products the discounts may be relevant to. For example, if a user specifies that they would like a discount on a particular product with particular product attributes, the system may use this data to match the user's notification settings to discounts as they come in, and send messages to users when a discount is saved to the database which matches their criteria. In some implementations, users may also be able to set auto-purchase parameters, which may allow the system to purchase a product automatically under certain circumstances. For example, the user may be able to specify a product, a target price, and any information necessary for a transaction, such as shipping and payment information. The system may then use the information to search for discounts as described above, until a discount and/or collection of discounts which may be combined on a single product, can be found which modifies the cost of the product to meet or fall below the target price. The system may then execute a transaction in order to purchase the product at the discounted price, using the user's shipping and payment information. In some implementations, rather than automatically executing the transaction, the system may notify the user as though the user has provided notification settings, allowing the user to confirm or decline the purchase transaction.

In some implementations, the discount process may also be applied to registry websites. For example, a user navigating a registry website for a friend's wedding may be able to request discounts for at least some of the items selected in the registry, and may be able to set up notifications, auto-purchase settings, and/or like settings for the products in a manner similar to how the user would normally obtain and/or become notified of a discount. If the user purchases the product and/or the system auto-purchases the product, the registry website may be updated by the system after the transaction has been processed, to indicate that someone has bought some quantity of the product. If the user bought the requested quantity of the product (e.g., the person who created the registry website requested three sets of glasses and the user bought three sets via the discount system), the system may indicate to the registry web site that the requested quantity of the product has been met, and the product may be removed from the website. If two or more users are attempting to obtain discounts on the same product, the first user to accept a discount may be the user able to purchase the product at that discount; in some implementations, users may also be notified if others are attempting to find a discount for an item, and/or may be encouraged to purchase another item on the registry. The system may also search for discounts for other products and present them to one of the users in order to encourage users to purchase other products. In some implementations the creator(s) of registry web sites which facilitate discount purchasing may not be told who purchased a product, whether they purchased the product at a discount, and/or any other such information.

Referring further to FIG. 1, the system may include one or more users 110-1, 110-2, . . . 110-N, connect through a network, such as the internet 108, one or more merchant servers 102, one or more price monitoring servers 104, one or more payment fulfillment servers 106, one or more hosting servers 114, one or more analytics servers 116, and one or more messaging service servers 118, to name a few. In embodiments, one or more of the functions of each of these servers may be combined into a single server, and/or divided up among one or more other servers performing duplicate and/or portions of the functions.

In embodiments, users may utilize the program product and/or participate in the system using one or more user electronic devices. A user device may be a computer, tablet computer, set-top box, cell phone, personal digital assistant, or other networked portable or stationary device. User electronic devices and/or servers may comprise one or more processors and/or computer-readable memory.

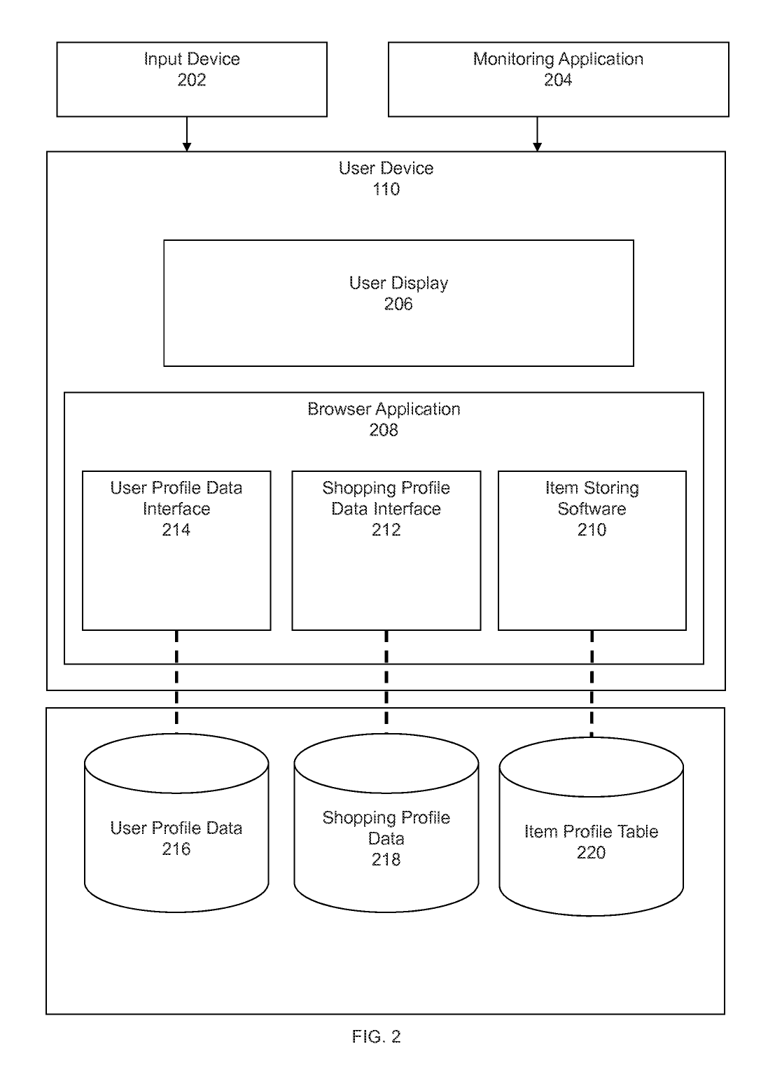

Referring to FIG. 2, an exemplary user device may contain a user display 206 for viewing content, e.g. websites. A user device may be operatively connected to an input device 202, which may be operated to input data to the user device. The input device may be connected by wire to the user device. In embodiments, the input device may form a wireless connection with the user device. In embodiments, the input device may be integrated into the user device. An input device may be a keyboard, mouse, microphone, camera, and/or touchscreen, to name a few.

Still referring to FIG. 2, one or more data servers 112 may contain one or more databases, such as user profile data 216 and shopping profile data 218. The servers 112 may also host an item profile table 220. Data generated, received, fetched, stored, accessed, and/or used by the systems and processes of the present invention are described herein.

Referring further to FIG. 2, a user device, 110, may include computer-readable memory, which may comprise one or more computer-readable storage devices. A user device 110 can further include software running on one or more processors. The processors may be operatively connected to the computer-readable storage devices. Software can include one or more instances of a browser application 208, item storing software 210, and/or monitoring application 204, to name a few. A user device 110 may contain one or more user profile data interface 214 to access, display, and/or interact with user profile data 216, e.g., via API calls. A user device may also contain one or more shopping profile data interface 212 to access, display, and/or interact with user shopping profile data via API calls.

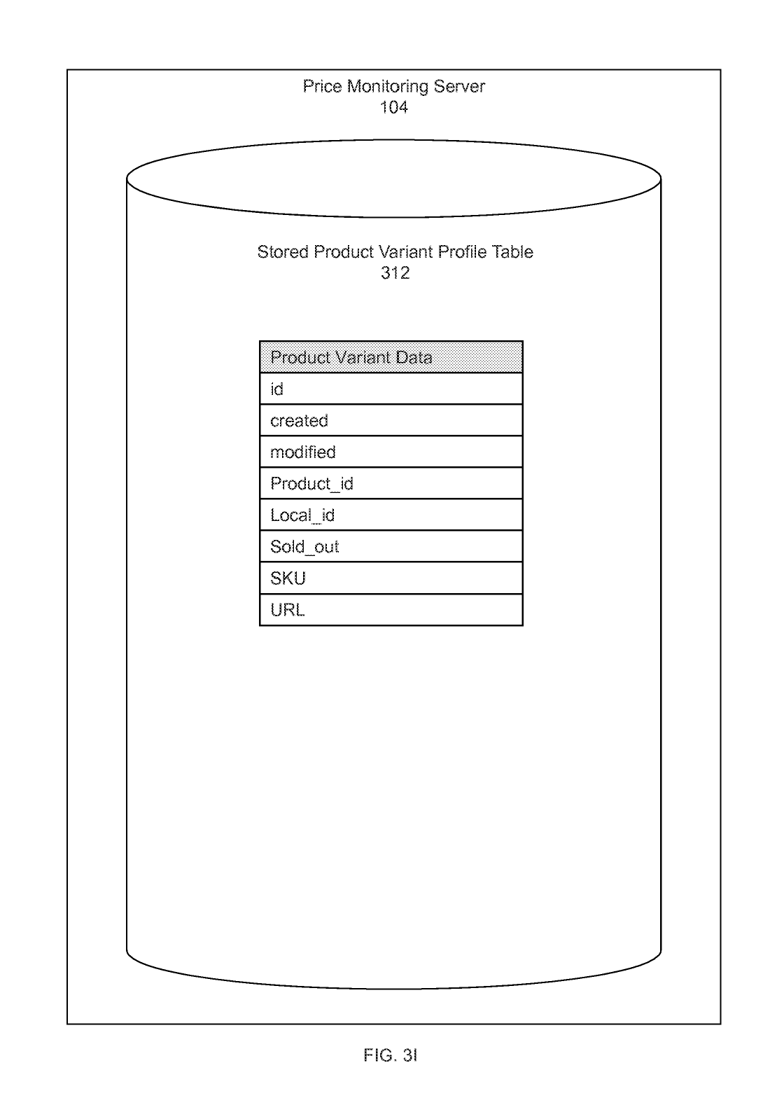

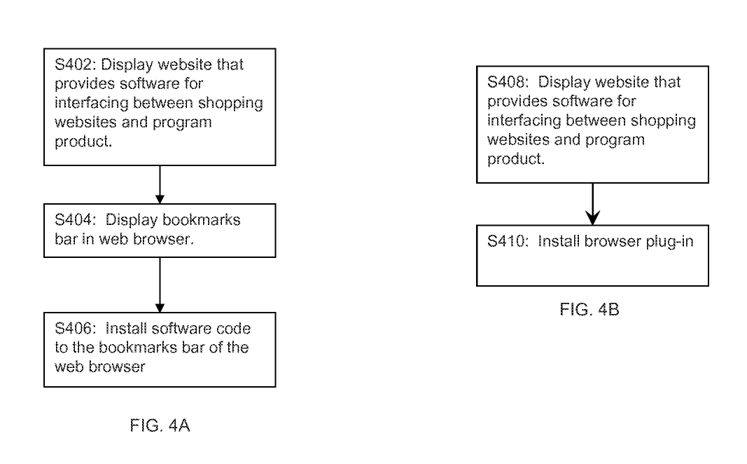

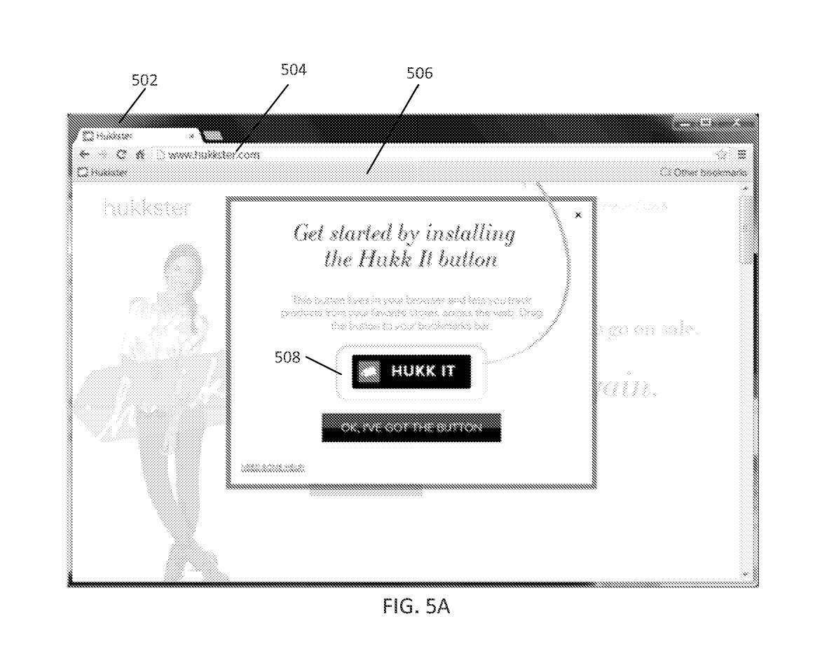

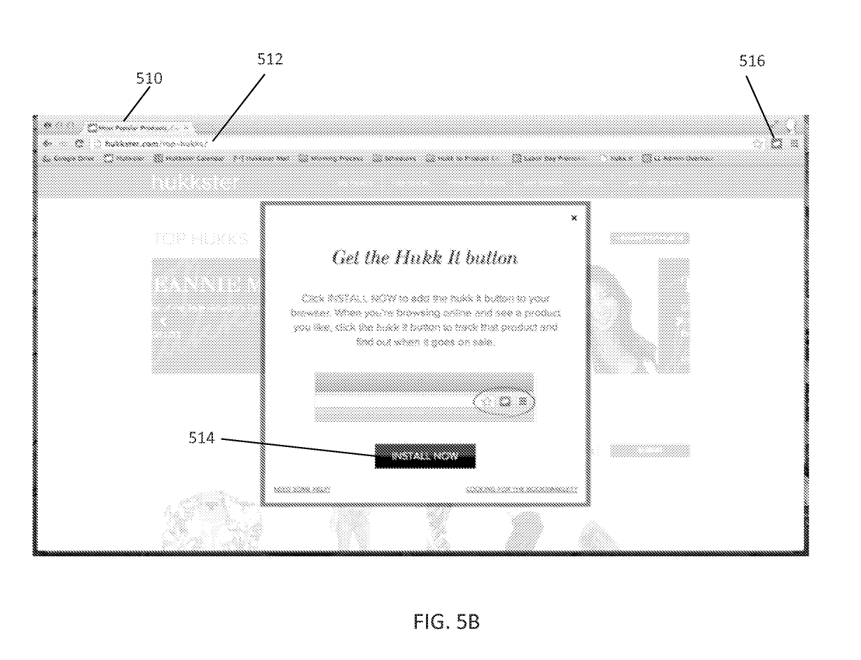

A user device 110 may contain, interface with, and/or provide, e.g., through software, a browser application. In embodiments, the browser application may connect to the Internet or another network. The browser application may be used to access, display, and/or interact with a website, which may be located at a URL. The browser may contain item storing software 210. Item storing software 210 may interface between any of a user electronic device, merchant websites, the program product, and a computer system for storing and monitoring product information and taking actions associated therewith, in order to enable storage of information related to items for sale. In embodiments, item storing software 210 may be a bookmark or bookmarklet, which may run Javascript. In other embodiments, item storing software 210 may be downloadable software, such as a mobile application, or a portion thereof. Such downloadable software may include a web browser or may interface with a third-party web browser. FIG. 4A describes an exemplary process for installing exemplary item storing software 210 in the form of a browser bookmark. FIG. 4A may be better understood through the exemplary screen shot of FIG. 5A, which shows a webpage providing item storing software 210. In the embodiment shown in FIG. 5A, the item storing software 210 may be provided as a browser bookmark. A user may navigate to the webpage by entering in a web browser 502 the URL 504. The user may ensure that the bookmarks bar 506 is displayed in the browser. The user may then drag a browser bookmark icon or button, e.g., “HUKK IT” button 508, from the webpage to the bookmarks bar 506.

In embodiments, the user device may further comprise a monitoring application 204. A monitoring application may be software. In embodiments, the monitoring application may monitor prices of one or more items for sale. Monitoring may involve periodic ascertainment of the price. In embodiments, a user device may contain user profile data and/or shopping profile data.

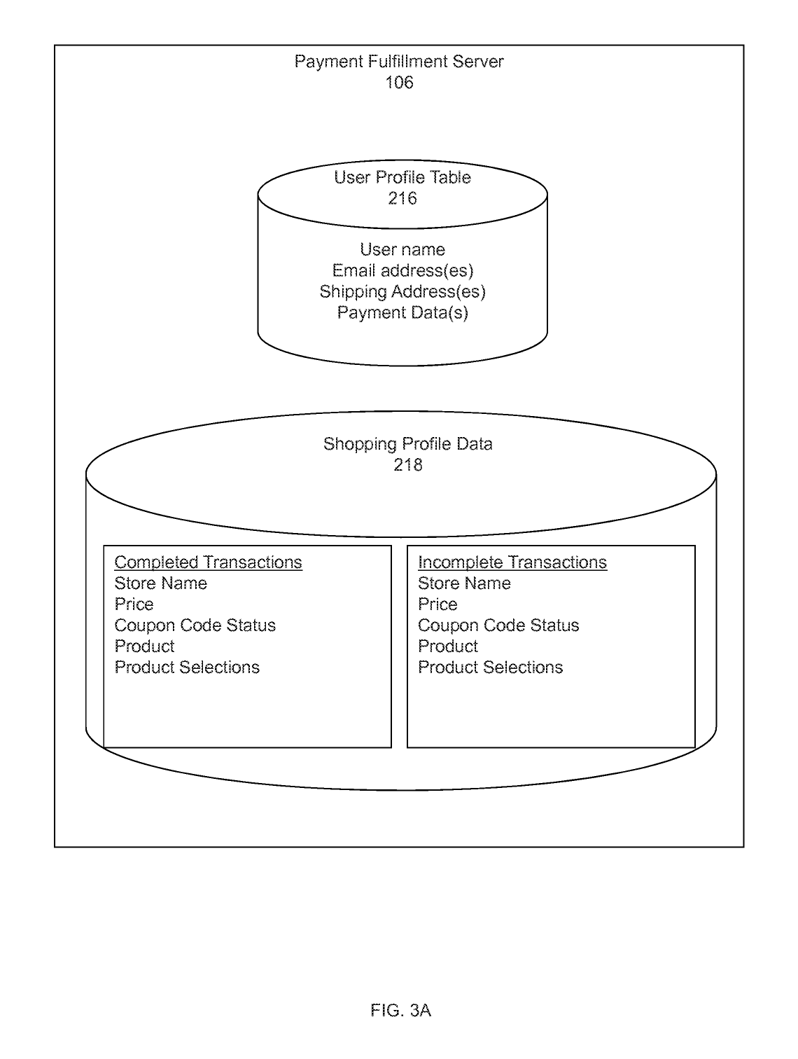

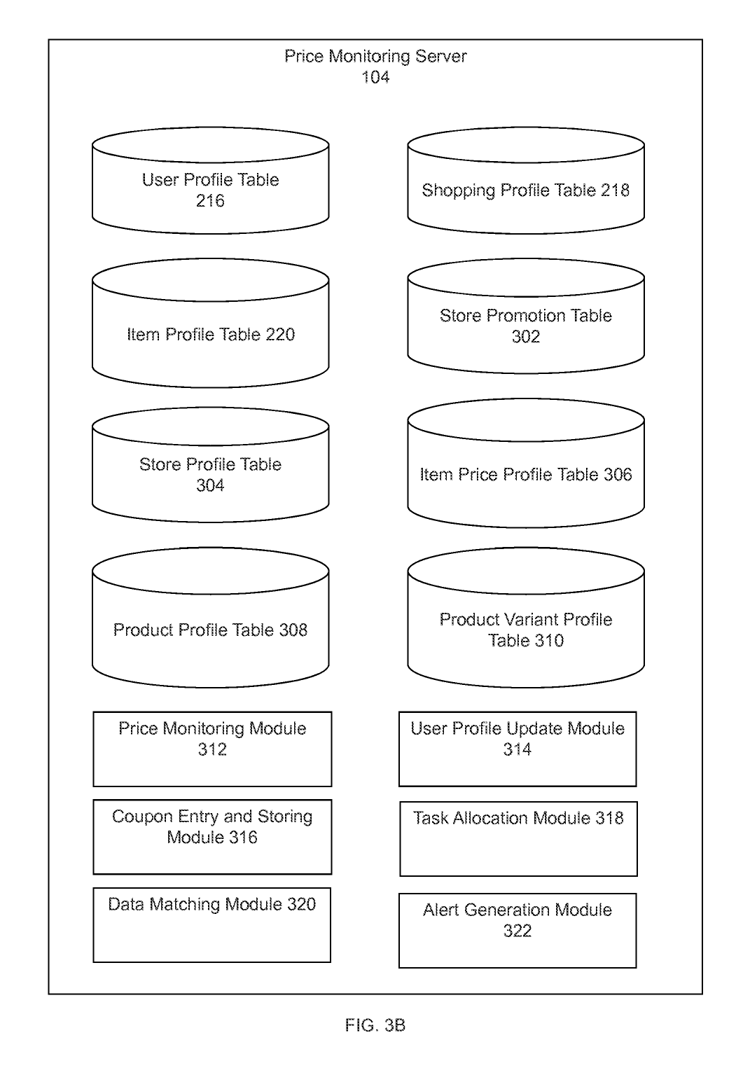

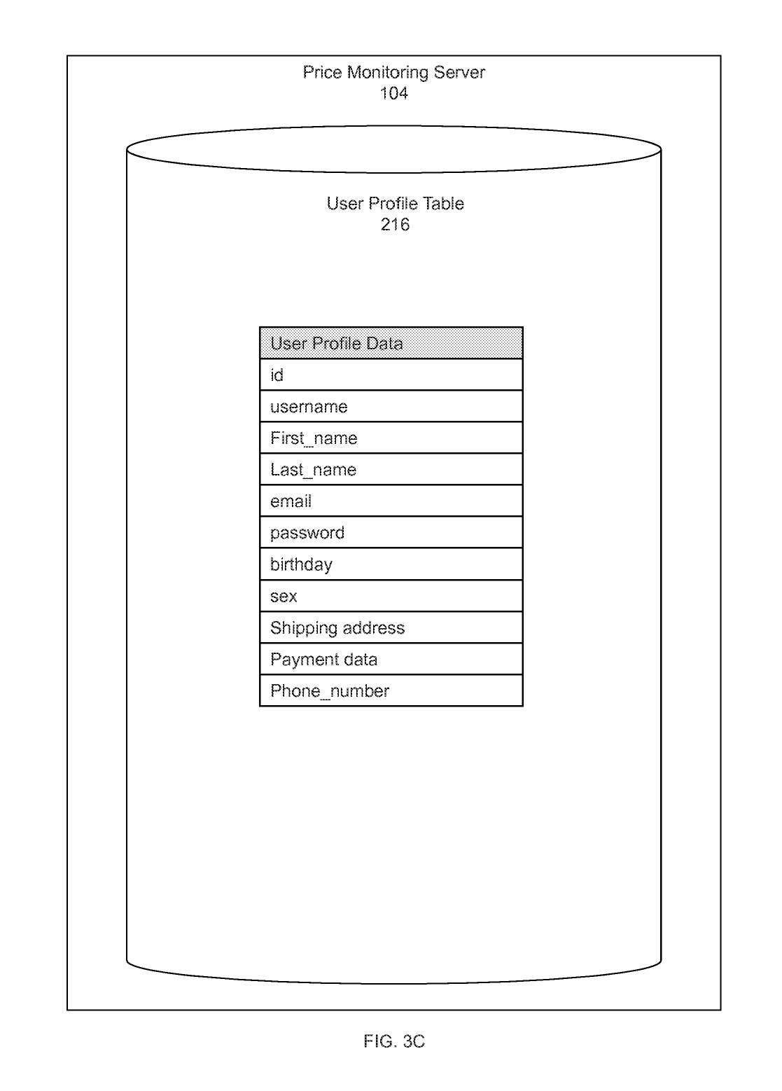

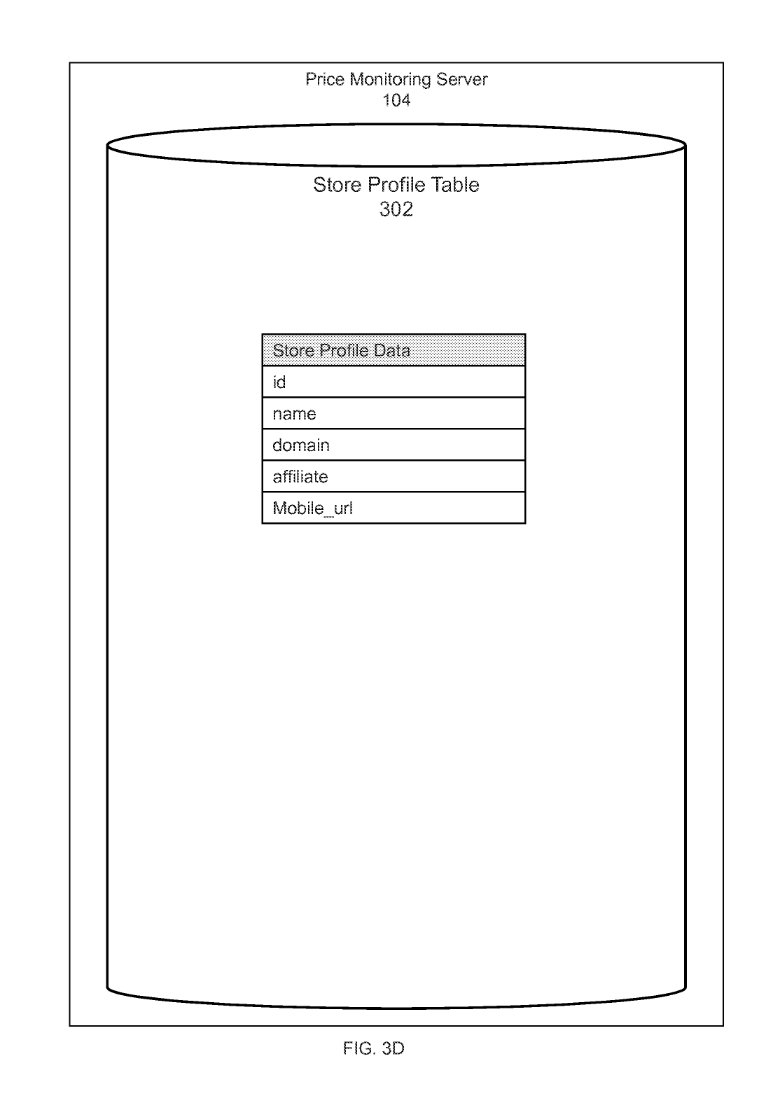

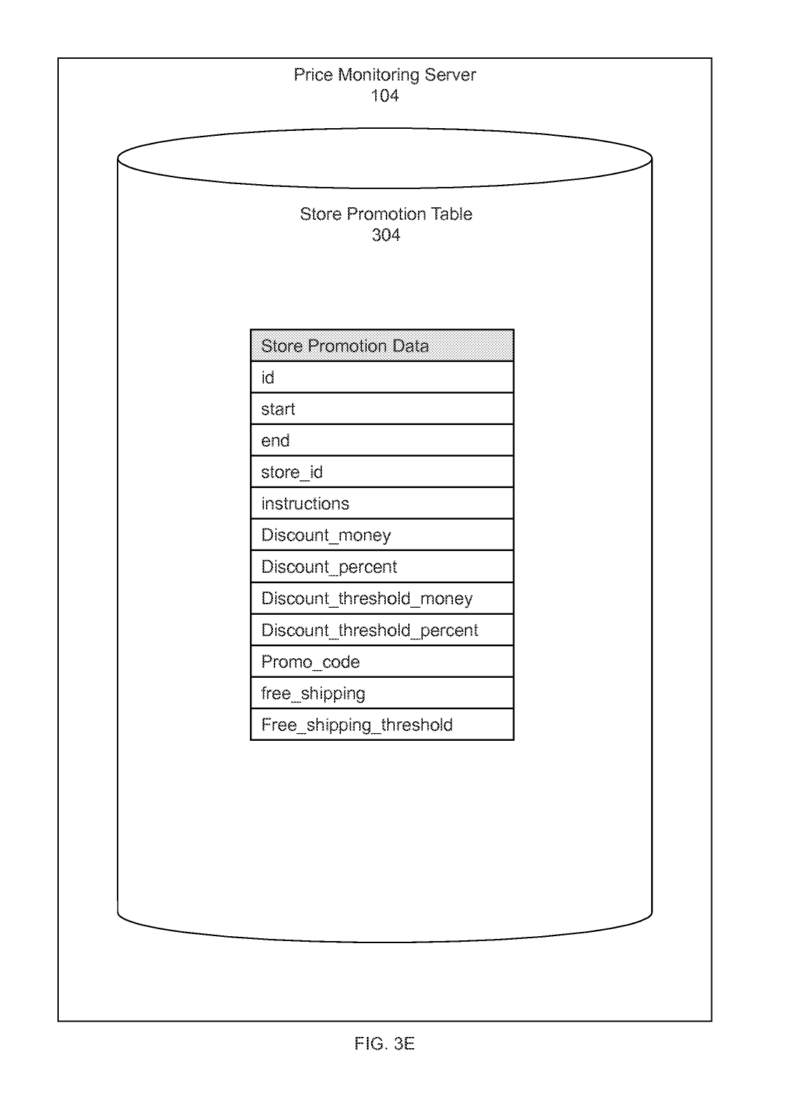

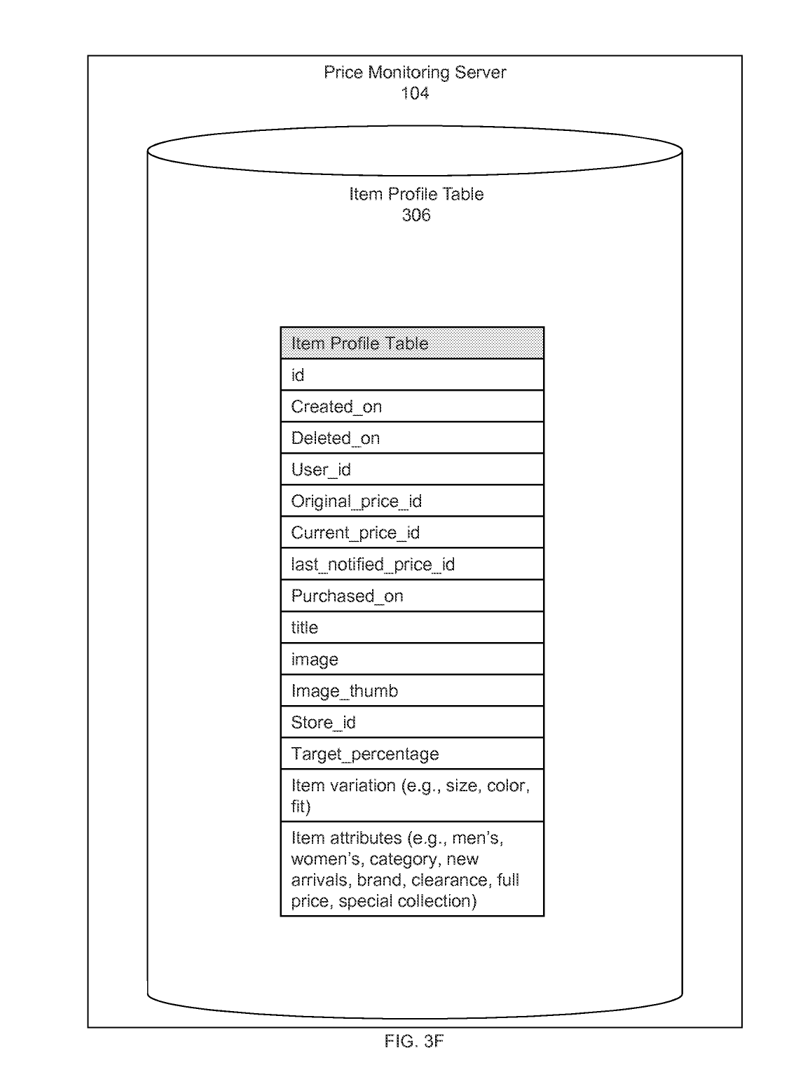

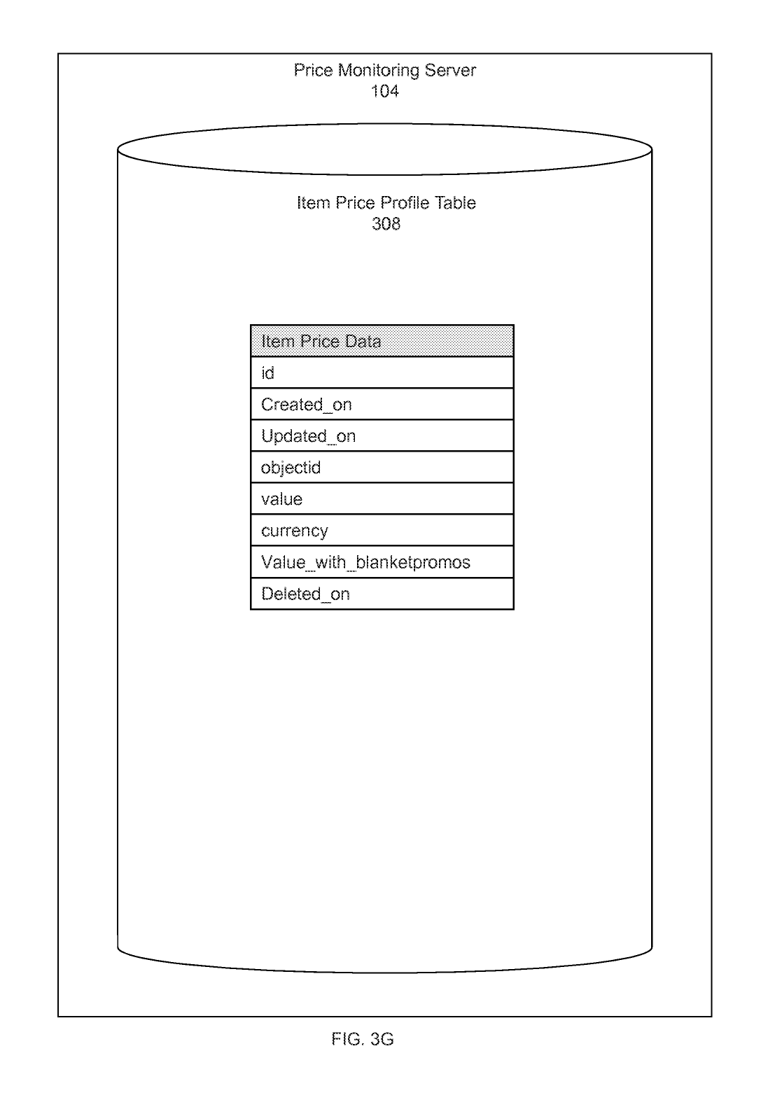

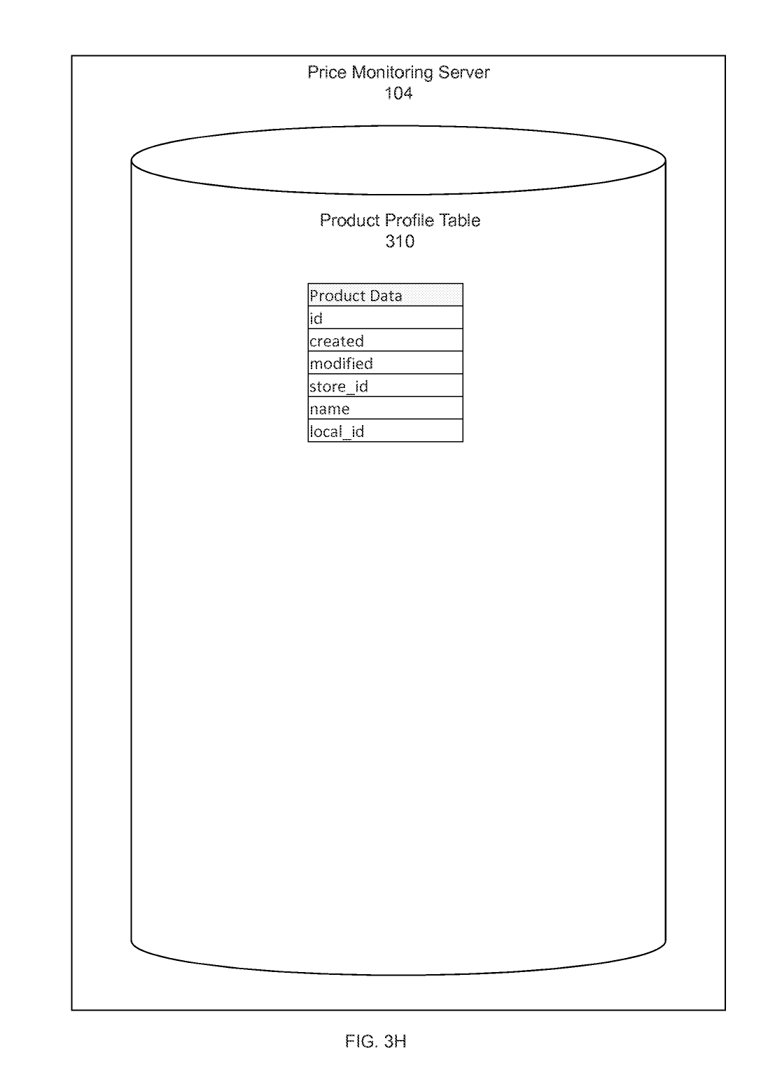

Referring to FIG. 3A, in embodiments, one or more payment fulfillment servers 104 may be used. Payment fulfillment servers 106 may comprise one or more processors operatively connected to one or more databases stored on one or more computer-readable storage devices. Such databases may include user profile data 216, such as, e.g., use name, email address, shipping address and payment data, to name a few. Such databases may include shopping profile data 218, including completed transaction data and incomplete transaction data, to name a few. Completed transactions data may include store name, price, coupon code status, product, product selections, to name a few. Incomplete transactions data may include store name, price, coupon code status, and product status and/or product selections, to name a few.

Referring to FIG. 3B, in embodiments, one or more price monitoring servers 104 may be used. Price monitoring servers 104 may comprise one or more processors operatively connected to one or more databases stored on one or more computer-readable storage devices. Such databases may include user profile table 216, shopping profile table 218, item profile table 220, store promotion table 302, store profile table 304, item price profile table 306, product profile table 308, and product variant profile table 310, to name a few.

Price monitoring servers 104 may also include various modules comprising software stored on computer-readable media and running on processors. Such modules can include a price monitoring module 312, coupon entry and storing module 316, data matching module 320, user profile update module 314, task allocation module 318, and alert generation module 322, to name a few.

Referring to FIG. 3C, in embodiments, one or more price monitoring servers 104 may be employed. Price monitoring servers 104 may comprise one or more processors operatively connected to one or more databases stored on one or more computer-readable storage devices. Such databases may include user profile table 216. User profile data may include, but is not limited to, a user ID, username, birthday, email address, shipping address, first name and last name, password, sex, phone number, and payment data, for example. In some implementations, any given record may hold values for only a subsection of the exemplary fields.

Referring to FIG. 3D, in embodiments, one or more price monitoring servers 104 may be used. Price monitoring servers 104 may comprise one or more processors operatively connected to one or more databases stored on one or more computer-readable storage devices. A price monitoring server 104 can include one or more databases, such as store profile table 302. Store information may include at least any of a store ID, store name, store URL, store domain, store affiliates, store websites (e.g., for normal website and/or for the mobile website), store logo, or any of the data items illustrated in FIG. 3D.

Referring to FIG. 3E, in embodiments, one or more price monitoring servers 104 may be used. Price monitoring servers 104 may comprise one or more processors operatively connected to one or more databases stored on one or more computer-readable storage devices. Such databases may include a store promotion table 304. As shown in FIG. 3E, store promotions may include promotion type (e.g., percentage or amount of discount, by one get one free, rebates, coupon applicable for future purchases), promotion rules (e.g., sale above $50 or sale only for men's apparel, to name a few), discount amount, promotion code, start date, end date, to name a few.

Referring to FIG. 3F, in embodiments, one or more price monitoring servers 104 may be used. Price monitoring servers 104 may comprise one or more processors operatively connected to one or more databases stored on one or more computer-readable storage devices. Such databases may include item profile table 306. Item data (e.g., Hukk data), may include creation date, product, store, product style, product url, product id, product title, product description, product images, produce price history with and without promotions, product selections (e.g., size, color, fit), product attributes (e.g., men's, women's, clearance, new arrival status, full price, category, brand, material, fabric, color, to name a few), associated product lists, sold out/in stock status, to name a few.

Referring to FIG. 3G, in embodiments, one or more price monitoring servers 104 may be used. Price monitoring servers 104 may comprise one or more processors operatively connected to one or more databases stored on one or more computer-readable storage devices. Such databases may include item price profile table 308. Item price data (e.g., Hukk price data), may include creation date, value, currency, value with blanketpromos, to name a few.

Referring to FIG. 3H, in embodiments, one or more price monitoring servers 104 may be used. Price monitoring servers 104 may comprise one or more processors operatively connected to one or more databases stored on one or more computer-readable storage devices. Such databases may include product profile table 310. Stored product data may include creation date, store id, name, and local id, to name a few.

Referring to FIG. 31, in embodiments, one or more price monitoring servers 104 may be used. Price monitoring servers 104 may comprise one or more processors operatively connected to one or more databases stored on one or more computer-readable storage devices. Such databases may include product variant profile table 312. Product variant data may include creation date, product id, sold out status, to name a few.

FIGS. 4A and 4B are flow charts of exemplary processes for a user to obtain software to interface between the program product and websites offering items for sale in accordance with exemplary embodiments of the present invention.

FIG. 4A describes an exemplary process for installing exemplary item storing software 210 in the form of a browser bookmark. In a step 5402, a user may use a web browser to navigate to a URL for a webpage at which the item storing software 210 may be downloaded or otherwise obtained. In a step 5404, a user may ensure that the bookmarks bar of the web browser is displayed. In a step 5406, the user may drag a button, hyperlink, and/or other icon from the webpage to the bookmarks bar. The button is compatible with a variety of browsers, including Google Chrome, Firefox, Safari, and Internet Explorer Versions 8 and 9, to name a few. FIG. 4A may be better understood through the exemplary screen shot of FIG. 5A, which shows a webpage providing item storing software 210. In the embodiment shown in FIG. 5A, the item storing software 210 may be provided as a browser bookmark. A user may navigate to the webpage by entering in a web browser 502 the URL 504. The user may ensure that the bookmarks bar 506 is displayed in the browser. The user may then drag the “HUKK IT” button 508 from the webpage to the bookmarks bar 506.

FIG. 4B describes an exemplary process for installing exemplary item storing software 210 in the form of a browser plug-in, also referred to as a browser extension. In a step S408, a user may use a web browser to navigate to a URL for a webpage at which the item storing software 210 may be downloaded or otherwise obtained. In a step 5410 a user may select a button that installs the plug-in to the browser. The browser plug-in can be compatible with a variety of browsers, including Chrome and Safari, to name a few. FIG. 4B may be better understood through the exemplary screen shot of FIG. 5B, which shows a webpage providing item storing software 210, as discussed herein. In the embodiment shown in FIG. 5B, the item storing software 210 may be provided as a browser plug-in. A user may navigate to the webpage by entering in a web browser 510 the URL 512. The user may then click the “INSTALL NOW” button 514 that will prompt the installation of the browser plug-in, 516 to the user's web browser.

FIGS. 5A and 5B are exemplary screen shots of a website providing software to interface between the program product and websites offering items for sale in accordance with exemplary embodiments of the present invention. Such software may be provided by a computer system, such as an item storing computer system, and/or may be operatively connected to such a computer system.

In the embodiment shown in FIG. 5A, the item storing software 210 may be provided as a browser bookmark. A user may navigate to the webpage by entering in a web browser 502 the URL 504. The user may ensure that the bookmarks bar, 506, is displayed in the browser. The user may then drag the “HUKK IT” button 508 from the webpage to the bookmarks bar, 506. The button is compatible with a variety of browsers, including Google Chrome, Firefox, Safari, and Internet Explorer Versions 8 and 9, to name a few.

In the embodiment shown in FIG. 5B, the item storing software 210 may be provided as a browser plug-in. A user may navigate to the webpage by entering in a web browser 510 the URL 512. The user may then click the “INSTALL NOW” button 514 that may prompt the installation of the browser plug-in, 516 to the user's web browser. The browser plug-in is compatible with a variety of browsers, including Chrome, Safari, to name a few. In embodiments, a specialized browser may be provided, which may be configured to communicate or otherwise integrate with the item storing computer system, and which may provide features for storing information related to products for sale, notification features, monitoring features and/or any features as are discussed herein.

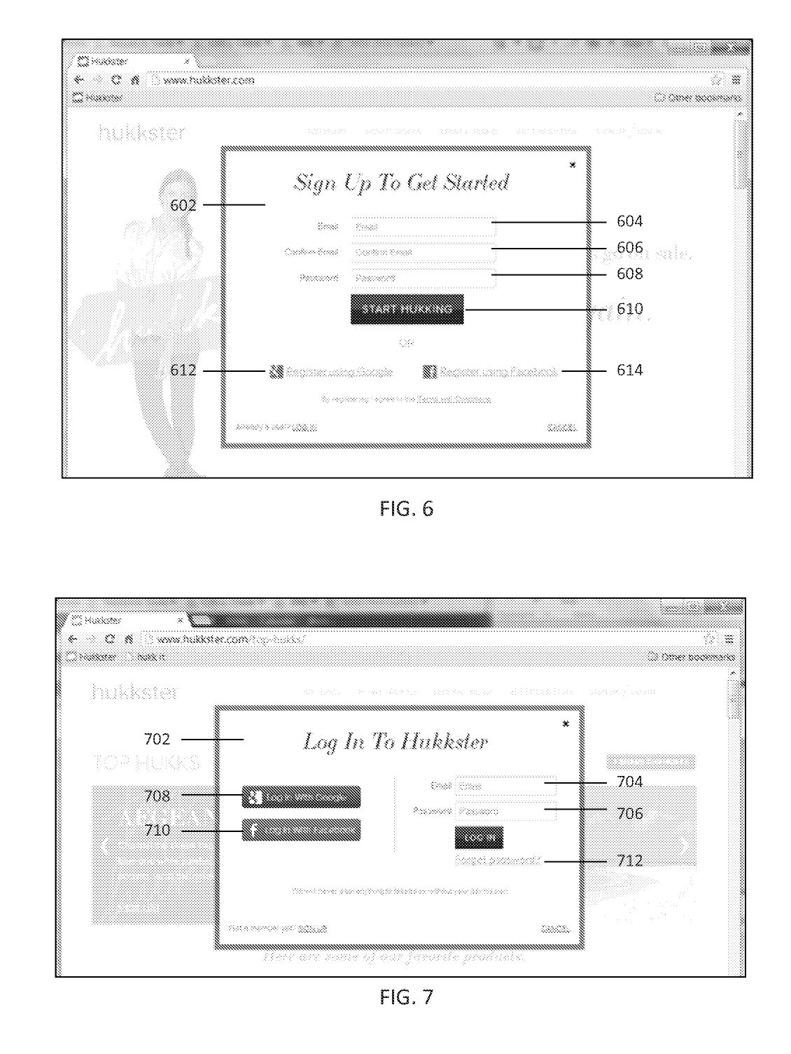

FIG. 6 is an exemplary screen shot of a registration screen in accordance with exemplary embodiments of the present invention. Such a software interface may be provided by and/or operatively connected to a computer system, such as the item storing computer system. A new user may register for monitoring services by accessing a registration website at a registration URL (e.g., www.hukkster.com/register). A user may be prompted to register when the user requests to store information related to a product using the item storing software 210. The new user may then select a registration request option from the website or from a window associated with the website, such as a “register now” button provided through a software interface. A registration screen, such as a pop-up window 602, may then be generated by the computer system. To register, the website may request input of a unique email 604 and a unique password 606. The user may also register using a social network, such as Facebook 614, or Google+ 612. Upon inputting the required registration fields, a user may request to return to the website via a submit button, such as the “START HUKKING” button 610. Upon or before completion of a registration process, a user device can download monitoring software for installation on the user device. Monitoring or other software may be provided by the computer system. A user may then be prompted to install the downloaded monitoring software. In embodiments, new users may register through other means such as directly through a downloadable application, and/or through an app store.

FIG. 7 is an exemplary screen shot of a website log in window in accordance with exemplary embodiments of the present invention. The website, including the log in window, may be provided by a computer system, which may include one or more servers. A user may log in by accessing a website at a log in URL (e.g., www.hukkster.com). A user may be prompted, e.g., by the website, to log in upon receipt by the website or underlying computer system of a request from the user to store information related to a product using the item storing software 210. If the user has an existing account with the item storing software 210, the computer system may generate a modal 702, such as a pop-up window. If a user is already registered with the website, the user may log in, e.g., by providing a specific, previously chosen unique username 704 and password 706. In embodiments, a username may be an email address. In embodiments, a user's log in credentials may be associated with a social network, such as Facebook 710 or Google+ 708, to name a few. Should a user need to access the username's associated password, a user may request password information via a “forgot password” button 712, which may provide the password via email upon satisfaction of security protocols, such as lost password security questions, or which may trigger creation of a temporary password and/or an opportunity to generate or input a new password. If an application is installed on a user device and/or a user is already registered, then a user may use the monitoring software, e.g., accessed through the installed software and/or through the website, to identify one or more goods, services, or other items for which to receive alerts when such items become available at a discount, as described herein.

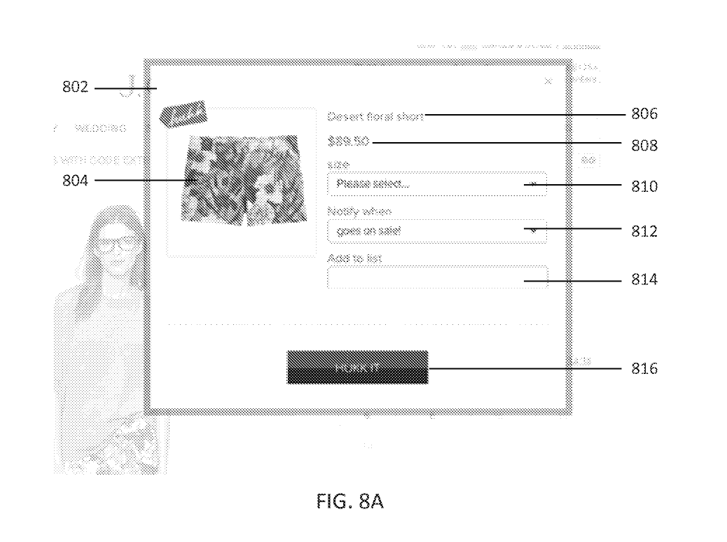

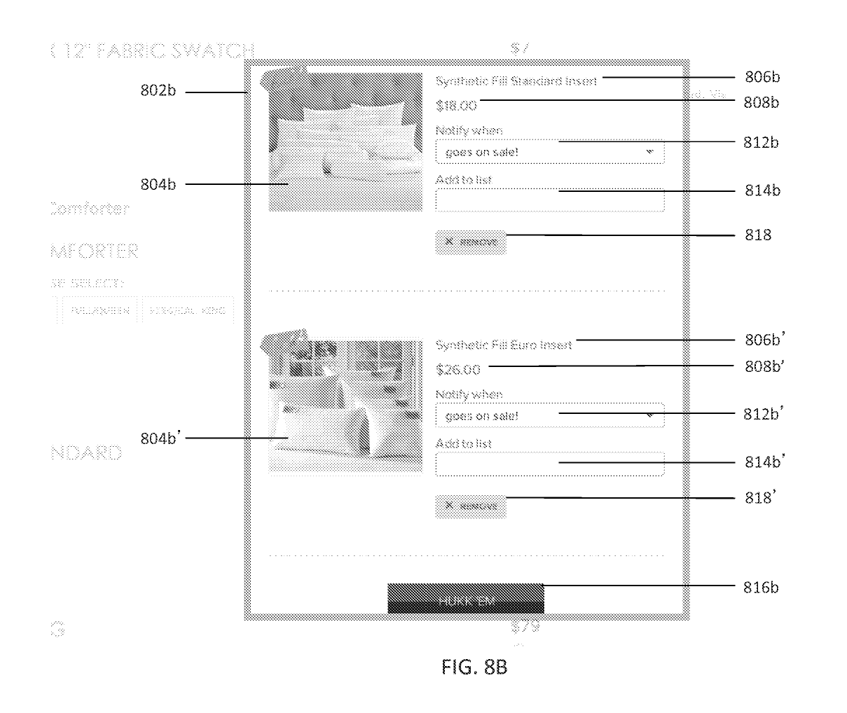

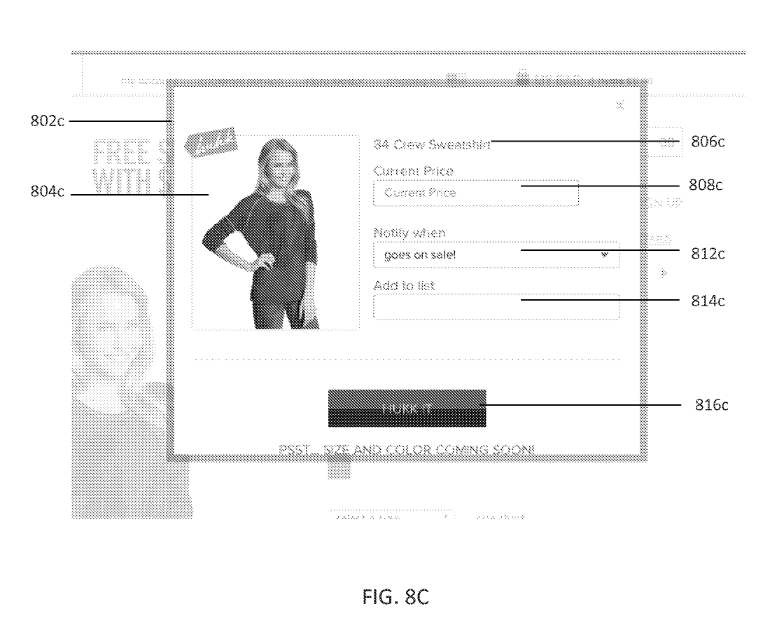

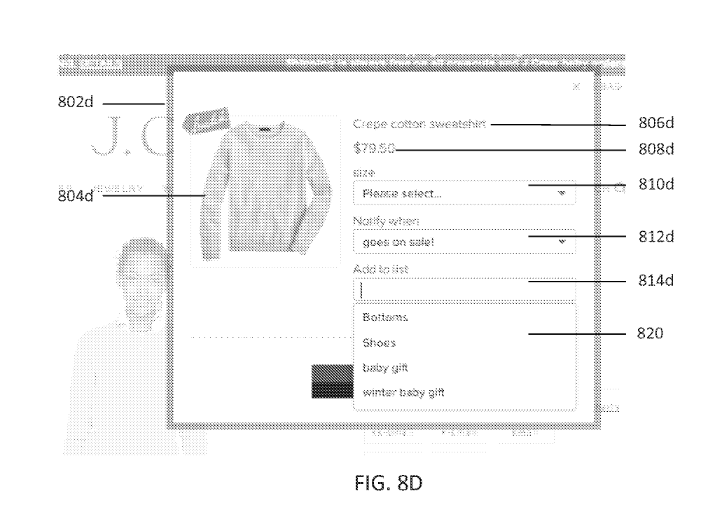

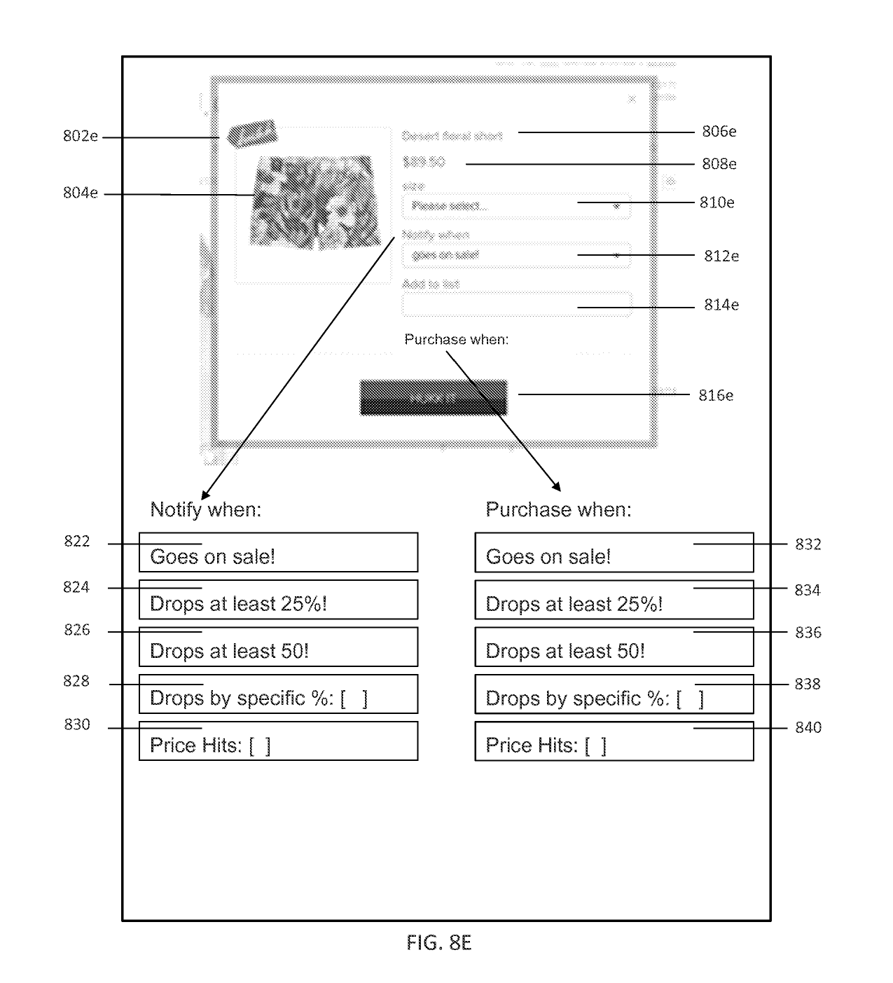

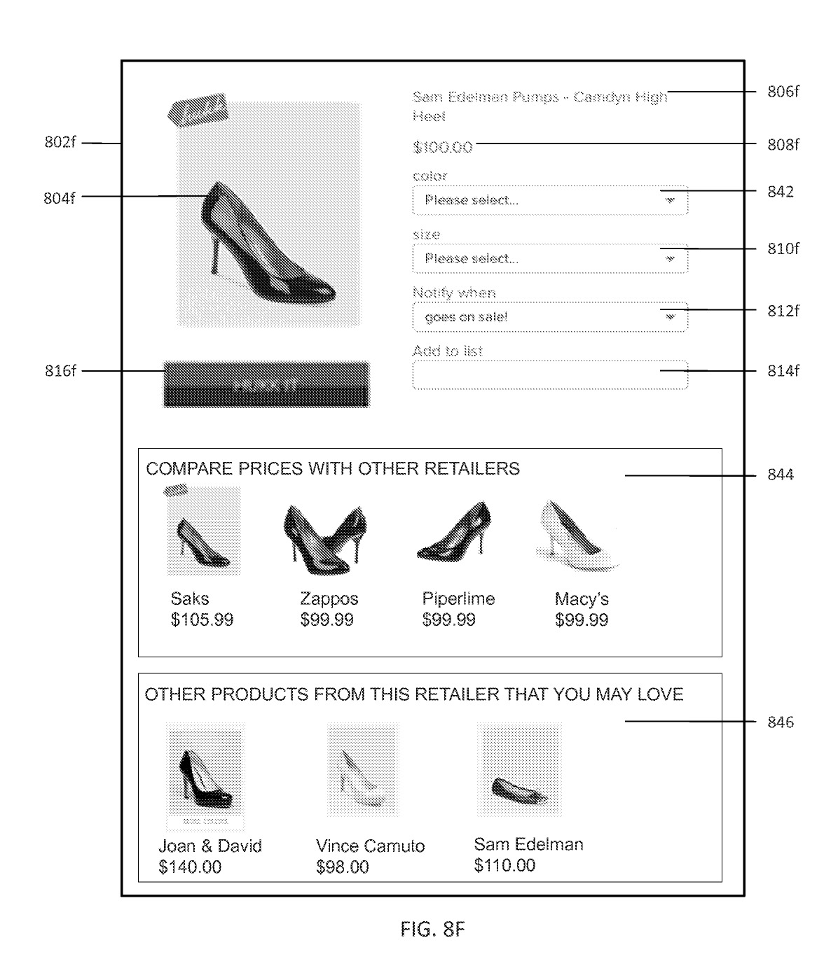

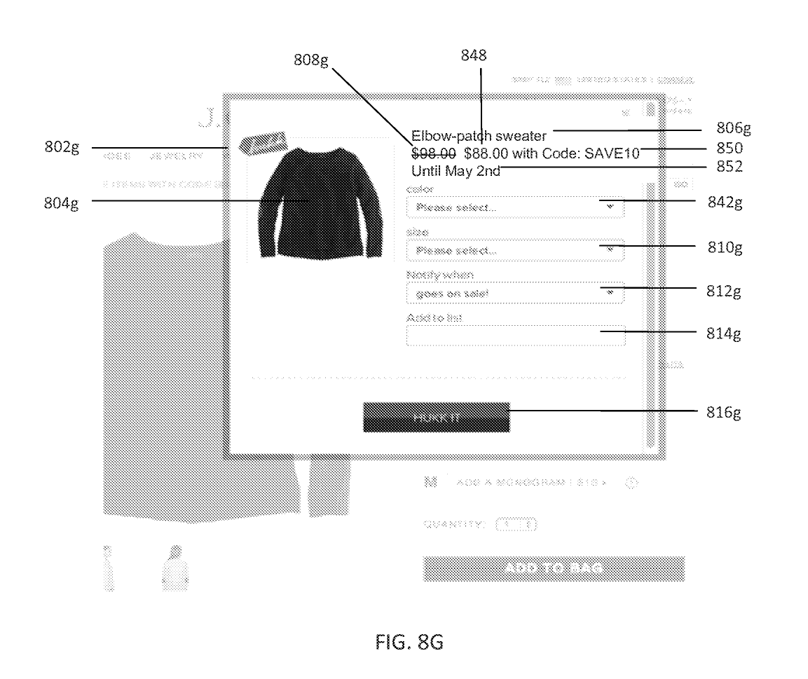

FIGS. 8A-8G are exemplary screen shots of an interface provided the software to store information related to an item for sale in accordance with exemplary embodiments of the present invention. The interface can allow a user to specify notification options, such as a sale price or percent reduction at which they wish to be notified. Similarly, in embodiments, the system may allow a user to specify a sale price, which may be a strike price at which the user wishes the system to purchase the product automatically, e.g., via express pay. As illustrated in FIGS. 8A-G and described herein, the interface may display the details of promotions and/or coupon codes, including promotion dates, coupon codes, and affected prices, and/or resulting prices, to name a few. The interface may further include a display of price comparisons of exact and/or similar products across a plurality of merchants and/or product recommendations based upon user specific information that is captured or otherwise stored in a database.

A user may use item storing software 210 to identify and store information related to items for sale. FIG. 8A shows an exemplary screen shot of an interface provided by item storing software 210 in accordance with exemplary embodiments of the present invention. The item storing software 210 interfaces between the program product and one or more merchant websites that present items for sale. Upon a user's activation of the item storing software 210, e.g., by clicking a browser bookmark button or a browser plug-in or by activating a browser in an item storing mobile application, the item storing software 210 may present an item storing window 802. The item storing window 802 may contain one or more product image 804, a product name 806, a product description, a product price 808, product specifications 810 and/or a merchant identification information (such as a merchant name), to name a few. Product specifications 810 can include size information, color information, or other options or information associated with a product. In embodiments, the item storing software 210 may automatically recognize and display any combination of these product identification data. For example, in embodiments, the item storing software 210 may automatically recognize and display the product price 808. In embodiments, the software 210 may provide the user with an input field for any combination of the product identification data.

Still referring to FIG. 8A, the item storing software 210 may provide a user with a price notification preference setting 812, e.g., an option to receive notifications when any discount is available for the item, when an item is discounted by 25%, or when an item is discounted at 50%, when an item is discounted by at least a specified amount or discounted to a certain price, to name a few. In embodiments, the software 210 may provide an option 814 to categorize the product information to be stored, such as by adding to a list, e.g., Summer Clothing, Shoes, Home Goods, Gift for Mom, to name a few. In embodiments, categories may be provided by the system, e.g., via a drop-down list of predetermined categories, or may be input by a user, e.g., through a data entry field. In embodiments, a user's existing categories may be auto-completed or populated in a selection menu, e.g., a drop-down list. The item storing software 210 may provide a button 816 to close the item storing window 802 and store or otherwise submit to the computer system the product information and user preferences, e.g., price notification preferences 812 and product categorization 814.

FIG. 8B shows another exemplary screen shot of an interface provided by item storing software 210 in accordance with exemplary embodiments of the present invention. Such an interface may be used to store product information for a plurality of products from a merchant website. The computer system may automatically detect products on a merchant website and add them to an item storing window 802b. Accordingly, the item storing window 802b may contain, for one or more products, the features as described with respect to FIG. 8A, such as a product image 804b, a product name 806b, a product description, a product price 808b, product specifications, price notification preference settings 812b, and a product categorization option 814b. A button 816b may be provided to enable closing of the item storing window 802b and storing of the product information and user preferences, e.g., price notification preferences 812b and product categorization 814b. In some cases, the website related to the item for sale for which the user is requesting to store information may contain multiple items. If a user does not wish to store product information related to one or more items for sale in the item storing window, the user may opt out of storing product information for specific products. Using a remove button 818 a user may remove items from the item storing window 802b so that no product information is stored for the removed products.

FIG. 8C shows an exemplary screen shot of an interface provided by item storing software 210 in accordance with exemplary embodiments of the present invention. An item storing window 802c may contain a product image 804c, a product name 806c, a product description, a product price 808c, and product specifications for one or more products from a merchant website. If the price of the item for sale is not auto-recognized, the price may be requested from the user and the user may enter the price into a data entry box 808c. The computer system may receive such price, e.g., in response to the clicking of a submit button 816c. In embodiments, price data may be mandatory. As described with respect to FIG. 8A, the item storing software 210 may provide a user with a price notification preference setting 812c for each product in the item storing window and/or a product categorization option 814c.

FIG. 8D shows an exemplary screen shot of an interface provided by item storing software 210 in accordance with exemplary embodiments of the present invention. The item storing window 802d may contain a product image 804d, a product name 806d, a product description, a product price 808d, and product specifications 810d for one or more products from a merchant website. As described with respect to FIG. 8A, the item storing software 210 may provide a user with a price notification preference setting 812d for each product in the item storing window and/or with an option 814d to categorize the product information for each product. In embodiments, categories may be provided by the system, e.g., via a drop-down list 820 of predetermined categories, or may be user input, e.g., through a data entry field 814d. In embodiments, a user's existing categories may be auto-completed or populated in a selection menu, e.g., a drop-down list 820.

FIG. 8E shows an exemplary screen shot of an interface provided by item storing software 210 in accordance with exemplary embodiments of the present invention. The item storing window 802e may contain a product image 804e, a product name 806e, a product description, a product price 808e, and product specifications 810e from a merchant website. As described herein, the software 210 may provide an option 814e to categorize product information and may provide a button 816e to close the item storing window 802e and store the product information and any user preferences, e.g., price notification preferences 812e and product categorization 814e.

Still referring to FIG. 8E, the item storing software 210 may provide a user with price notification preference settings 812e, which can include any of an option to receive notifications when an item is discounted to any degree 822, when an item is discounted by 25% 824, or when an item is discounted by 50% 826, to name a few. The software 210 may provide an option for a user to specify a discount percentage 828, a discount amount, or a sale price 830 at which the user requests that a sale notification be triggered. In embodiments, the item storing software 210 may provide a user with a preference setting to automatically purchase items for sale via express pay, e.g., a ‘strike price’. The purchase preference setting may provide an option to purchase items for sale when an item is discounted to any degree 832, when an item is discounted at 25% 834, or when an item is discounted at 50% 836, to name a few. In embodiments, the software 210 may provide an option for a user to specify a discount percentage 838, a discount amount, or a sale price 840 at which the item may be automatically purchased by the system using a user's stored account information. This account information can include credit card, billing, and shipping information previously provided by the user and stored in the user profile data 216.

FIG. 8F shows an exemplary screen shot of an interface provided by item storing software 210 including a real-time comparison of prices of an item for sale across different merchants and also including product recommendations across various merchants in accordance with exemplary embodiments of the present invention. The item storing window 802f may contain any of the features described with respect to FIGS. 8A-E, such as a product image 804f, a product name 806f, a product description, a product price 808f, and product specifications 810f for products from a merchant website. Product specifications, e.g., size options 810f and color options 842, may automatically populate in the item storing window 802f, e.g., via a drop down list. The item storing software 210 may also provide a user with a price notification preference setting 812f for each product in the item storing window and a product categorization option 814f. The item storing software 210 may provide a button 816f to close the item storing window 802f and store the product information and user preferences, e.g., price notification preferences 812f and product categorization 814f.

Still referring to FIG. 8F, the item storing window 802f may provide a real-time comparison of prices 844 for variants of the item across one or more merchant websites. In embodiments, the price comparison may be based upon the last-known (e.g., last received or last retrieved) prices from a plurality of merchants. The computer system may provide for display an indication of the time since price information was last updated. In addition to displaying the image of a product variant, the system may provide the item title, merchant name, current price or last known price, any live and/or applicable coupon codes, an indication of whether the product variant is currently discounted (such as whether it is available at a lower price that the ‘original’ price displayed on the website), product variant specifications (such as available size and/or color), and/or may provide a link to the product webpage on a third-party merchant website.

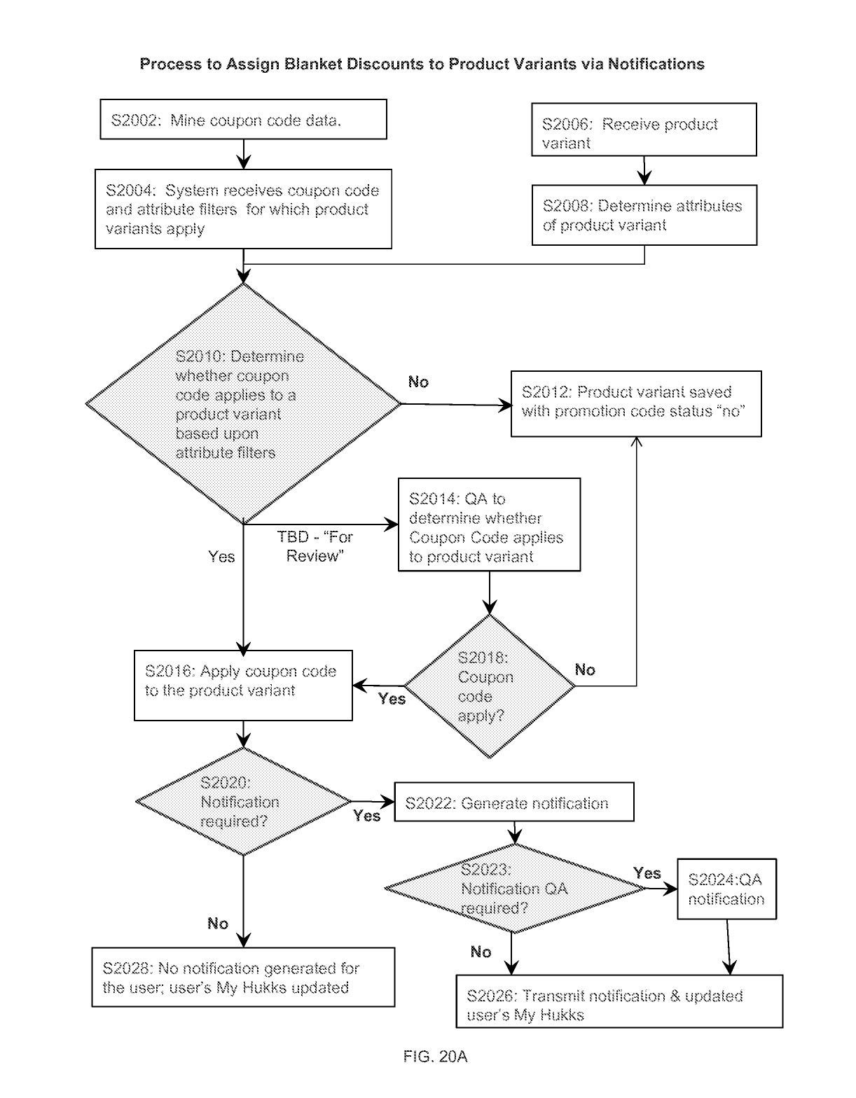

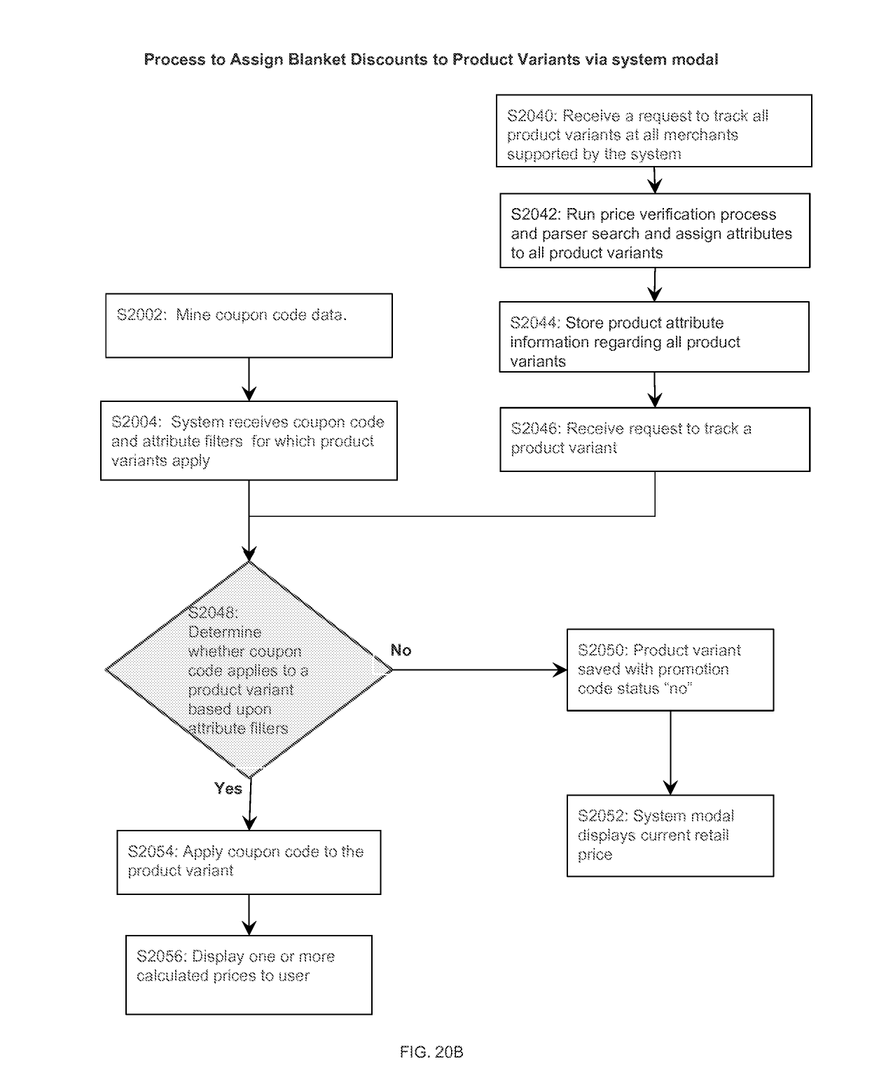

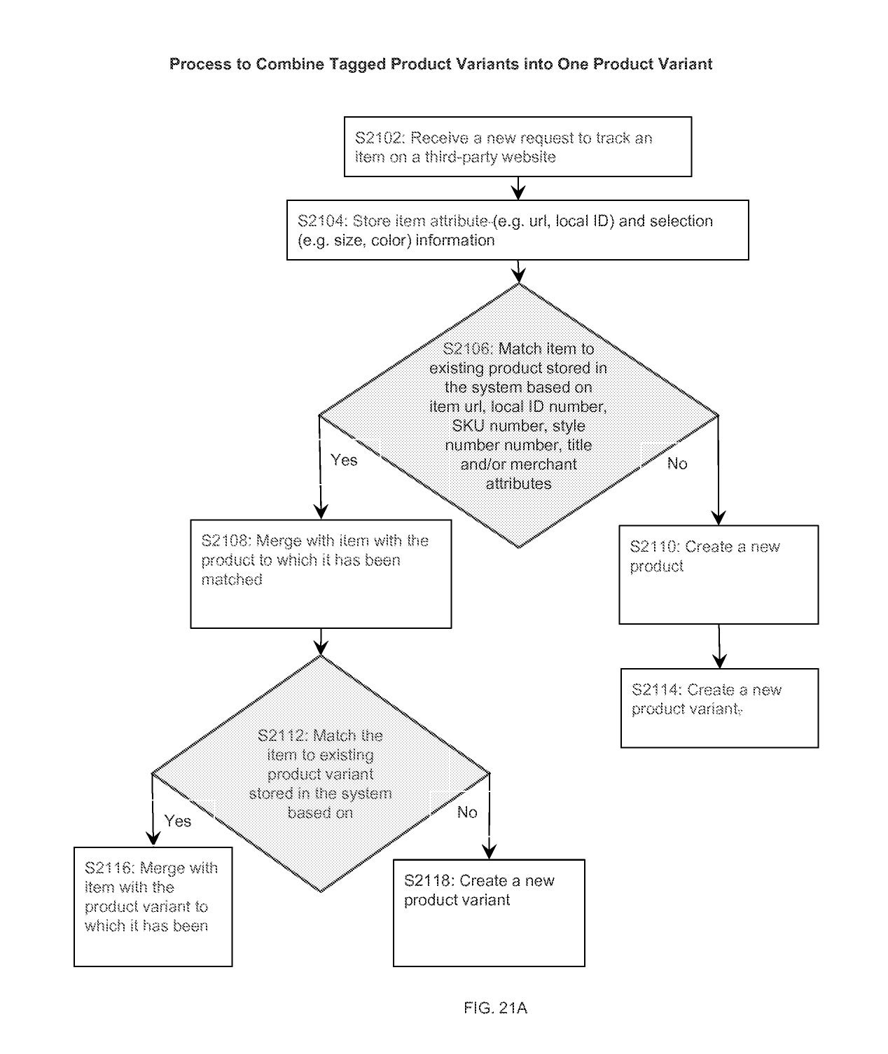

In embodiments, the computer system may recognize and display recommended items 846 that are available for purchase at one or more merchant websites based upon user specific information that may be captured in one or more data tables on one or more data servers 112. Such user specific information can include demographic information, geographic and season information, previously stored product information, search history, purchase history, and/or such information from the user's known acquaintances or contacts, to name a few. The system can identify one or more product variants associated with a specific item requested by the user. FIG. 21A, discussed herein, provides a flow chart of an exemplary process to display product recommendations in accordance with the present invention. The computer system can display an image of one or more of the recommended product variants 846 via the interface 802f. In addition to displaying the image of the product variant, the system may provide the item title, merchant name, current price, any live and/or applicable coupon codes, an indication of whether the product variant is currently discounted, and a link to the product webpage, e.g., on a third-party merchant website.

FIG. 8G shows an exemplary screen shot of an interface provided by item storing software 210 in accordance with exemplary embodiments of the present invention. The item storing window 802g may contain a product image 804g, a product name 806g, a product description, a product price 808g, and product specifications 810g for products from a merchant website. Product specifications, e.g., size specification 810g and color specification 842, may automatically populate in the item storing window 802g in a drop down list. The item storing window 802g may contain a price excluding any promotional discounts 808g and/or may indicate that such price is an original or otherwise not the most discounted price, e.g., with a strikethrough through the display of that price. In embodiments, the computer system may automatically recognize, determine, and/or display the discounted price 848, e.g., applying available promotional discounts. The item storing window 802g may further contain a promotion code 850 and promotion end dates 852, to name a few. In embodiments, other promotion criteria may be displayed, such as a category (e.g., men's) or brand of products to which the promotion applies. As described with respect to FIG. 8A, the item storing software 210 may provide other features and information, including a price notification preference setting 812g for each product in the item storing window and a product categorization option 814g. A submit button 816g may close the item storing window 802g and transmit to the item storing computer system and/or to one or more databases the product information and user preferences, e.g., price notification preferences 812g and product categorization 814g. Accordingly, information related to one or more items for sale may be stored in a stored items database.

Databases of stored item information may be accessed through a website associated with the computer system for storing and/or monitoring product information. In embodiments, such databases may be accessed through program products, such as downloadable software on computers, smart phones, or other user electronic devices.

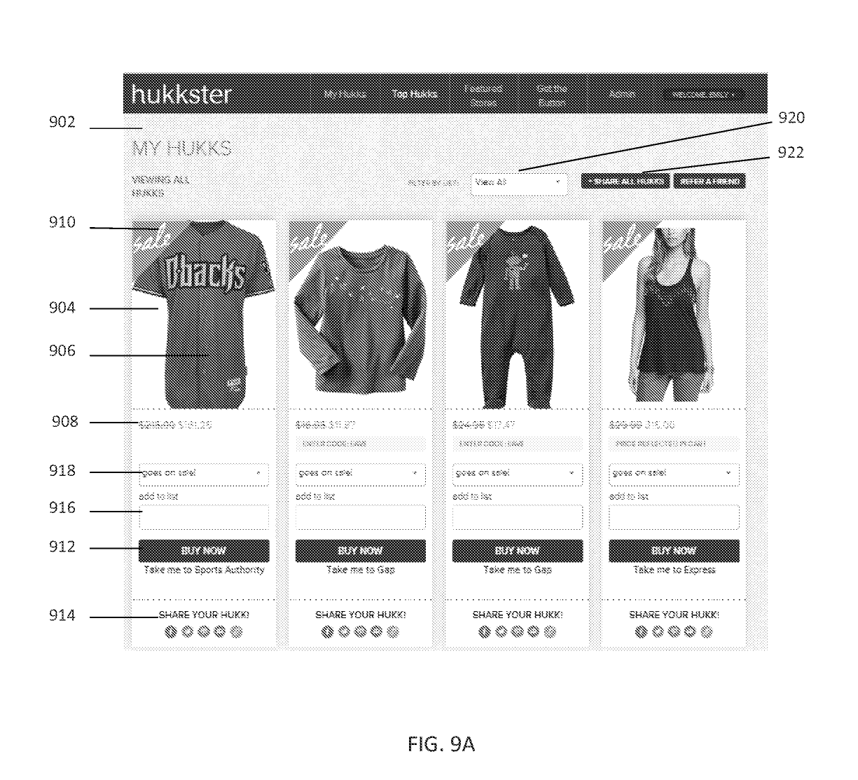

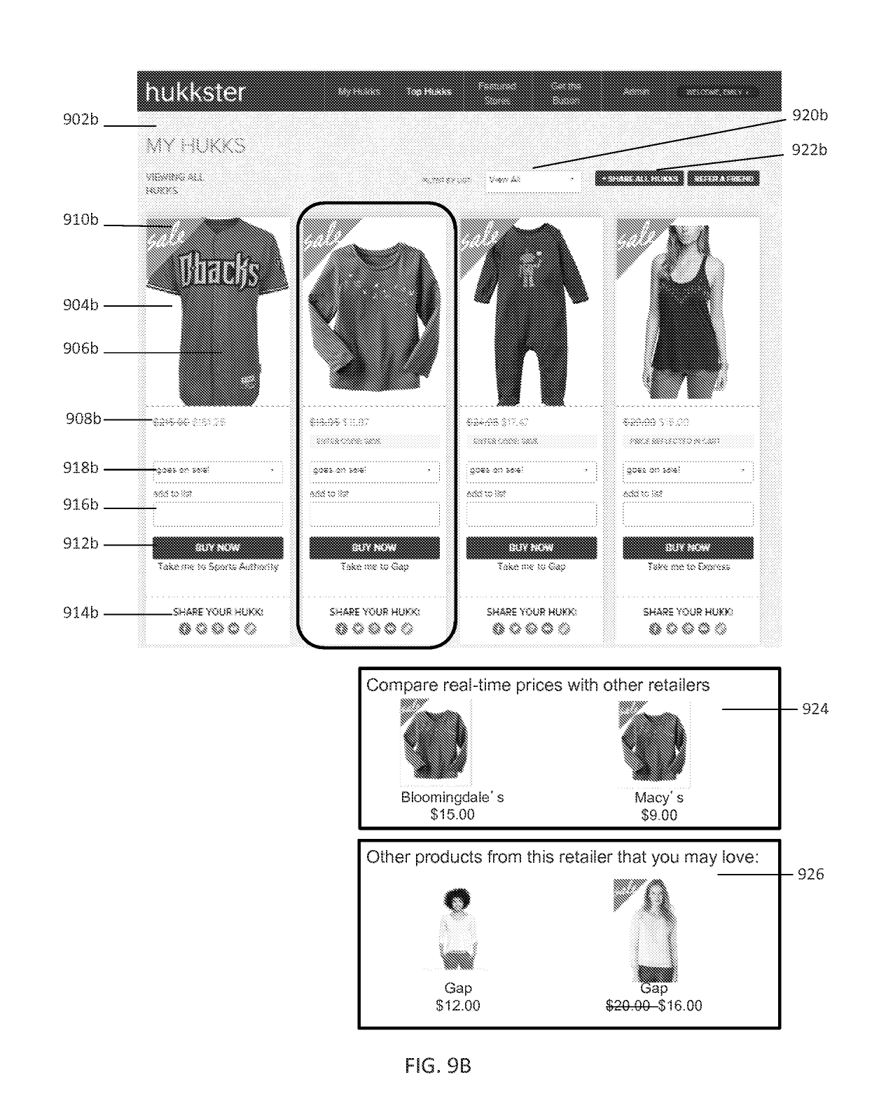

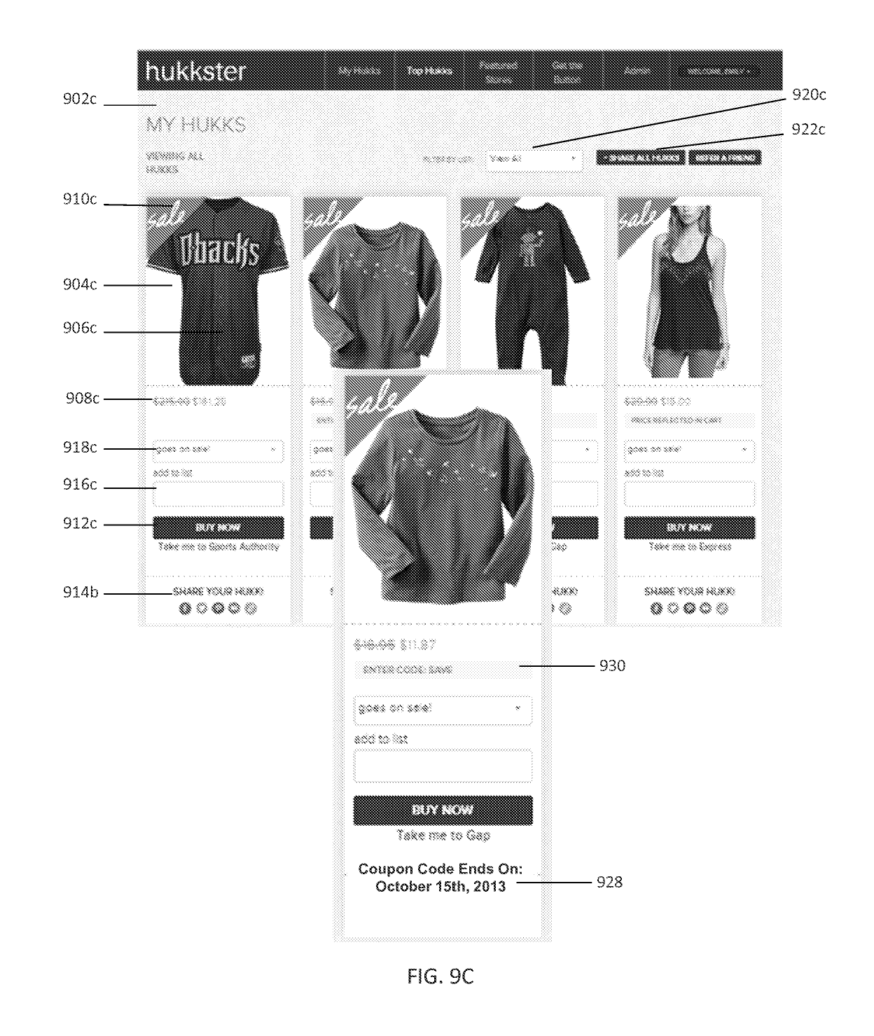

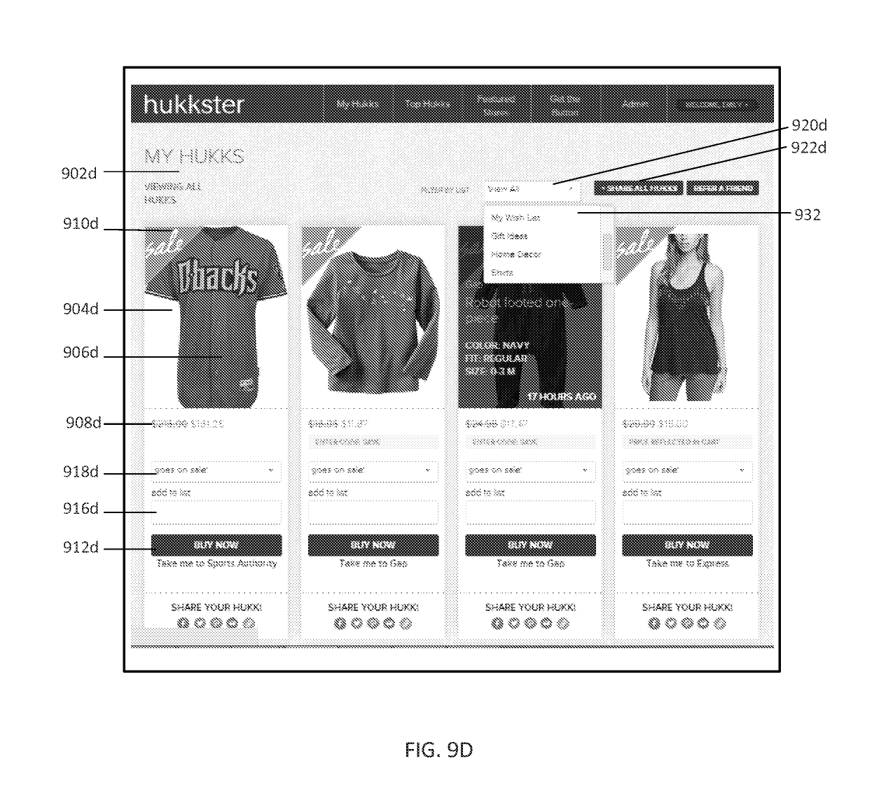

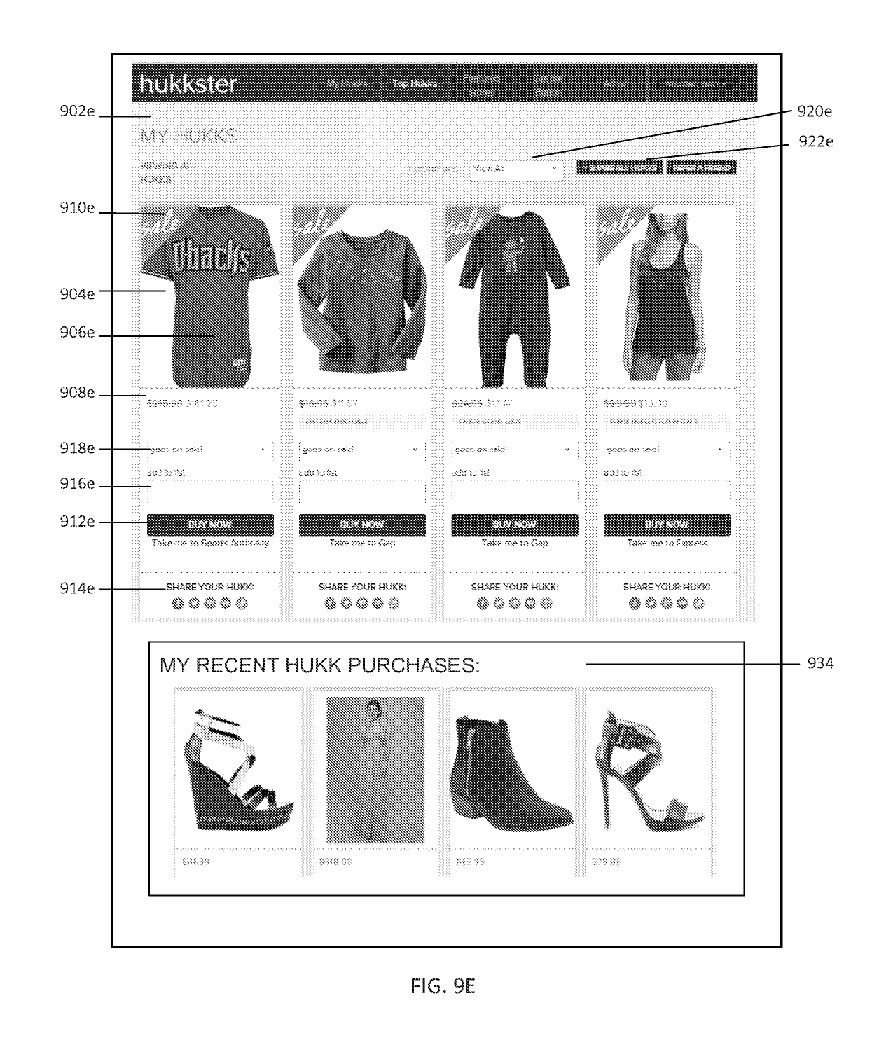

FIGS. 9A-9E are exemplary screen shots of a website that displays items for sale whose information was stored by a user in accordance with exemplary embodiments of the present invention. Such a website may also provide any of price comparisons of a product across merchants, suggestions of products based upon user specific information that is captured in an item storing database, promotion details, user-created lists of products that can be used for organization and/or sharing with a user's contacts, activity of user's contacts (e.g., items stored by a contact), and/or summaries of recent purchases, to name a few. The discount notification system of the present invention may monitor the prices of items for which a user of the system requested storage of product information. The user may specify discount notification criteria to govern when the user may receive notifications regarding the prices of the one or more items related to the stored information. In embodiments, the system may monitor the availability of discounts using coupon codes and include the information relating to the coupon codes in notifications, e.g., email notifications, text notifications, and/or push notifications to user electronic devices to alert users to discounts and/or provide opportunities to obtain the discounts associated with such coupon codes.

FIG. 9A shows an exemplary screen shot of a website 902 associated with the computer system that displays items for sale whose information was stored by a user in accordance with exemplary embodiments of the present invention. A user may be required to log into the website to access product information stored by the user and/or requested by the user to be stored by the website system. In the exemplary embodiment illustrated in FIG. 9A, a tile 904 may present data related to an item for sale. The tile may include a product image 906, a product name, a product description, merchant identification information, brand information, price information 908, and/or a sale notification 910, to name a few. The sale notification may be text or an image or other icon or coloring scheme indicating the existence of a sale. The product tile 904 may also include a purchase button 912 or other link to purchase the product, e.g., a “Buy Now” button, and/or instructions on how to purchase the product. In embodiments, product tiles 904 may be sorted by price, by category information, by date of storage, or by merchant, to name a few.

Still referring to FIG. 9A, a user may share a tile 904, e.g., through electronic mail, through the website to other users of the website, through text messaging or other user device messaging, and/or through social networking websites 914, e.g., Facebook, Twitter, and Pinterest, to name a few. In embodiments, a user may share all tiles 922. The website associated with the computer system may display a user's price notification preference settings 918, e.g., options to receive notifications at predetermined discounted percentages. The website associated with the computer system may provide an option 916 to categorize the product information to be stored, such as by adding to a list, e.g., Summer Clothing, Shoes, Home Goods, to name a few. In embodiments, categories may be provided by the system, e.g., via a drop-down list of predetermined categories, or may be user input, e.g., through a data entry field. In embodiments, a user's existing categories may be auto-completed or populated in a selection menu, e.g., a drop-down list. A user may select which product tiles 904 to display on the website, e.g., by selecting one or more lists 920, including an option to view all lists or all items, or by selecting other category information.

FIG. 9B shows an exemplary screen shot of a website 902b associated with the computer system that displays items for sale whose information was stored by a user in accordance with exemplary embodiments of the present invention. A tile 904b may present data related to an item for sale. The tile may include a product image 906b, a product name, a product description, merchant identification information, price information 908b, and/or a sale notification 910b, to name a few. The sale notification may be text or an image or other icon indicating the existence of a sale. The product tile 904b may also include a purchase button 912b or other link to purchase the product and/or instructions on how to purchase the product. In embodiments, product tiles 904b may be sorted by price, by category information, by date of storage, or by merchant, to name a few. A user may share a tile 904b, as described with respect to FIG. 9A. The website can include any of the other features described with respect to FIG. 9A.

Still referring to FIG. 9B, the website 902b may provide a real-time price comparison 924 of exact and/or similar products across merchants. In embodiments, similar products can include product variants having different colors or other characteristics. In embodiments, similar products can include separate products that have common characteristics, such as common style elements, colors, and/or shapes, to name a few. In embodiments, the item storing software 210 may display a comparison of an identical or similar item for sale across different merchants websites 924. The system may display an image 924, item title, merchant name, current price, applicable coupon codes, an indication of whether the product variant is currently discounted, and/or a link to the product webpage on a third-party merchant website. The system may also provide an option to purchase one or more of the recommended product variants via an express pay feature. The user may purchase the item for sale directly through an express pay link without accessing the associated merchant website. A third-party provider may store user purchase information (e.g., credit card information, billing address, to name a few) enabling the user to perform a purchase using the third-party service.

In embodiments, the website 902b can provide suggestions of different items for sale 926, which may be based upon user specific information that is captured in one or more data tables on one or more the data servers 112. The system can identify one or more product variants that are associated with the specific item requested by the user. FIG. 9B may be better understood through FIG. 21B, a flow chart of an exemplary process to display product recommendations in accordance with exemplary embodiments of the present invention. For one or more of the recommended items for sale, the system may display any of the information that may be displayed for regularly stored items. The system may also provide an option to purchase one or more of the recommended product variants via an express pay feature, as described herein with respect to other items available for purchase.

FIG. 9C shows an exemplary screen shot of a website 902c that displays items for sale whose product information was stored by a user in accordance with exemplary embodiments of the present invention. A tile 904c may present data related to an item for sale, as described with respect to FIG. 9A. The tile may include a product image 906c, a product name, a product description, merchant identification information, price information 908c, and/or a sale notification 910c, to name a few. The sale notification may be text or an image or other icon indicating the existence of a sale. The product tile 904c may also include a purchase button 912c or other link to purchase the product and/or instructions on how to purchase the product. In embodiments, product tiles 904c may be sorted by price, by category information, by date of storage, or by merchant, to name a few. A user may share a tile 904c through a variety of communication platforms, such as email, SMS, and/or social networking websites 914c, e.g., Facebook, Twitter and Pinterest, to name a few. In embodiments, a user may share all tiles 922c through electronic mail or social networking websites. The website may display a user's price notification preference setting 918c, e.g., option to receive notifications at predetermined discounted percentages. The website may provide an option 916c to categorize the product information to be stored, such as by adding to a list. A user may select which product tiles 904c to display on the website, e.g., by selecting one or more lists 920c or other category information.

Still referring to FIG. 9C, a tile 904c may indicate the duration of a sale or the period 928 during which a coupon code is available for an item for sale. The website may also display the specific coupon code 930 on the tile 904c, e.g., for the duration of a promotion. The website may provide updates, which may be real-time updates, to the promotional information, e.g., the promotion code 930 and promotion period 928, displayed on the website so as to reflect any changes to such information or the availability thereof.

FIG. 9D shows an exemplary screen shot of a website 902d that displays items for sale whose information was stored by a user in accordance with exemplary embodiments of the present invention. A tile 904d may present data related to an item for sale. The tile may include a product image 906d, a product name, a product description, merchant identification information, price information 908d, and/or a sale notification 910d, to name a few. The sale notification may be text or an image or other icon indicating the existence of a sale. The product tile 904d may also include a purchase button 912d or other link to purchase the product, e.g., a “Buy Now” button, and/or instructions on how to purchase the product. In embodiments, product tiles 904d may be sorted by price, by category information, by date of storage, or by merchant, to name a few. A user may share a tile 904d with one or more other users and/or may publish the information from the tiles using social networking websites 914d, e.g., Facebook, Twitter and Pinterest, to name a few. In embodiments, a user may share all tiles 922d through electronic mail or social networking websites. The website may display a user's price notification preference setting 918d, e.g., option to receive notifications at predetermined discounted percentages. The website may provide an option 916d to categorize the product information to be stored, such as by adding to a list, e.g., “My Wish List,” “Gift Ideas” or “Shirts”, to name a few. In embodiments, categories may be provided by the system, e.g., via a drop-down list of predetermined categories 932, or may be user input, e.g., through a data entry field. In embodiments, a user's existing categories may be auto-completed or populated in a selection menu, e.g., a drop-down list. A user may select which product tiles 904d to display on the website, e.g., by selecting one or more lists 920d or other category information. The website may display items stored as part of one or more of the lists 932 in the drop down list, e.g., a list entitled “My Wish List,” “Gift Ideas” or “Shirts.”

FIG. 9E shows an exemplary screen shot of a website 902e programmed to display items for sale whose information was stored by a user in accordance with exemplary embodiments of the present invention. The website may include any of the features described with respect to FIGS. 9A-D, including one or more tiles 904e that present data related to one or more items for sale. In embodiments, the website, using an item storing system and/or discount notification system, may display items recently purchased by a user 934. The website may access data stored in a shopping profile table 218 to display information related to a user's purchases 934, including any of an image, item title, merchant name, purchased price, and a link to the product webpage on a third-party merchant website, to name a few.

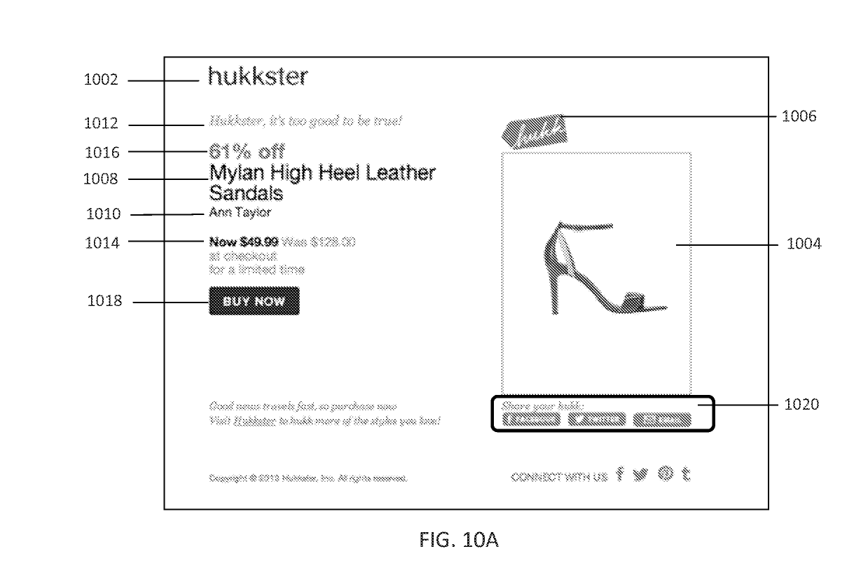

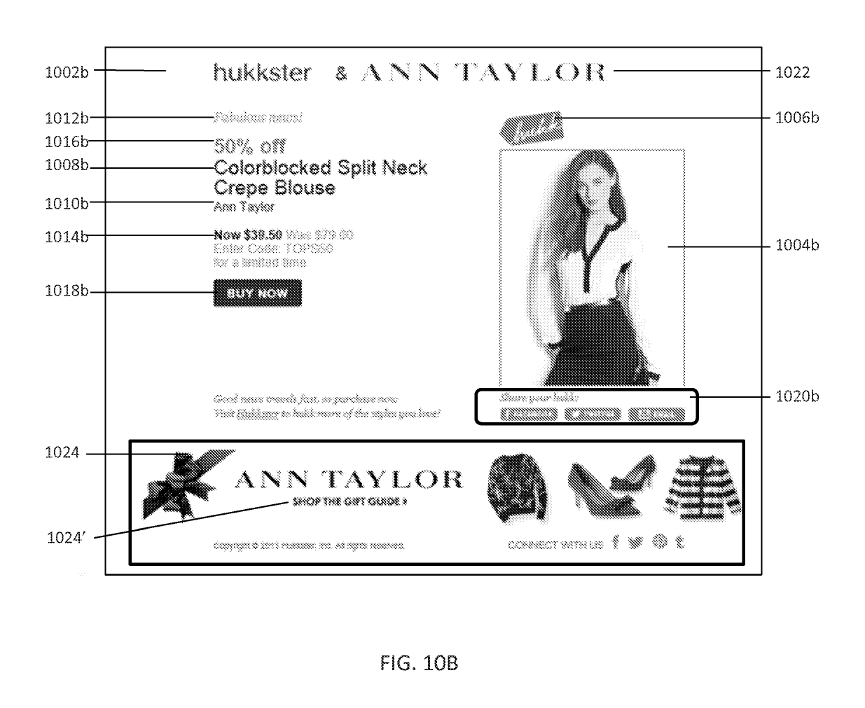

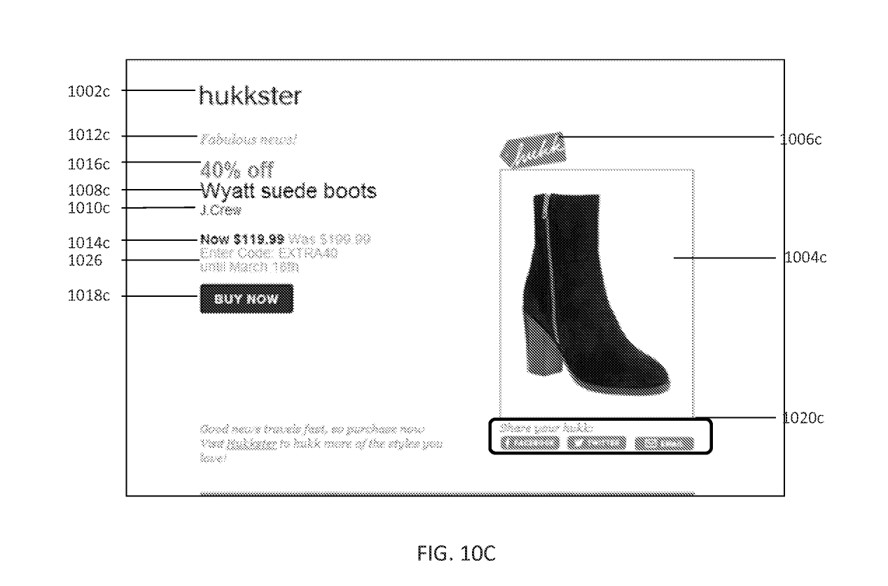

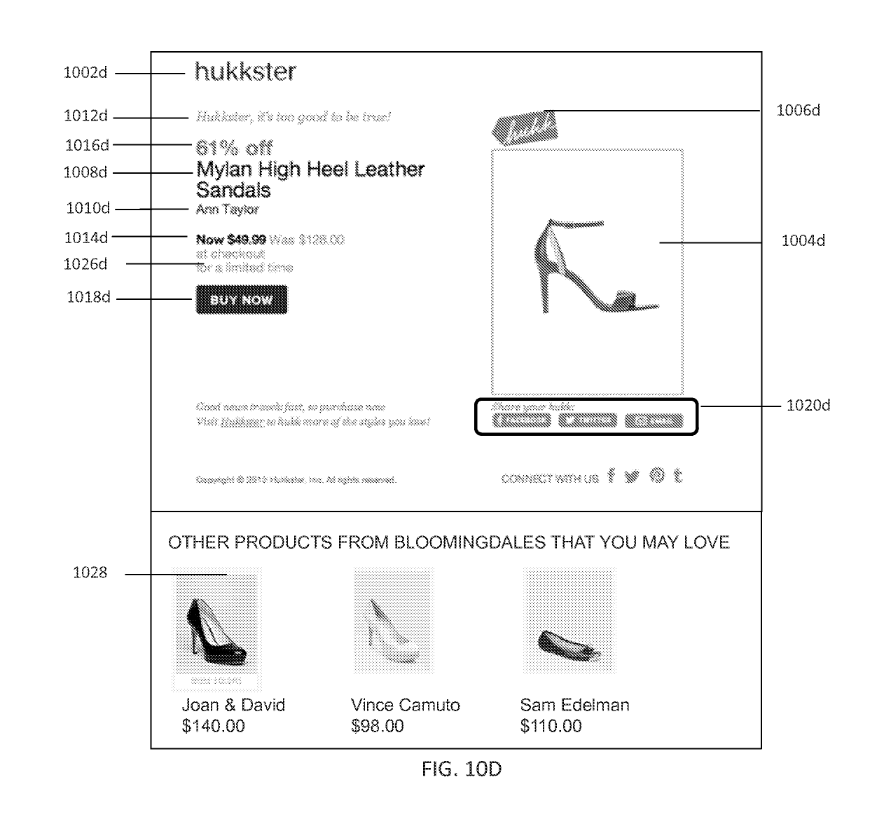

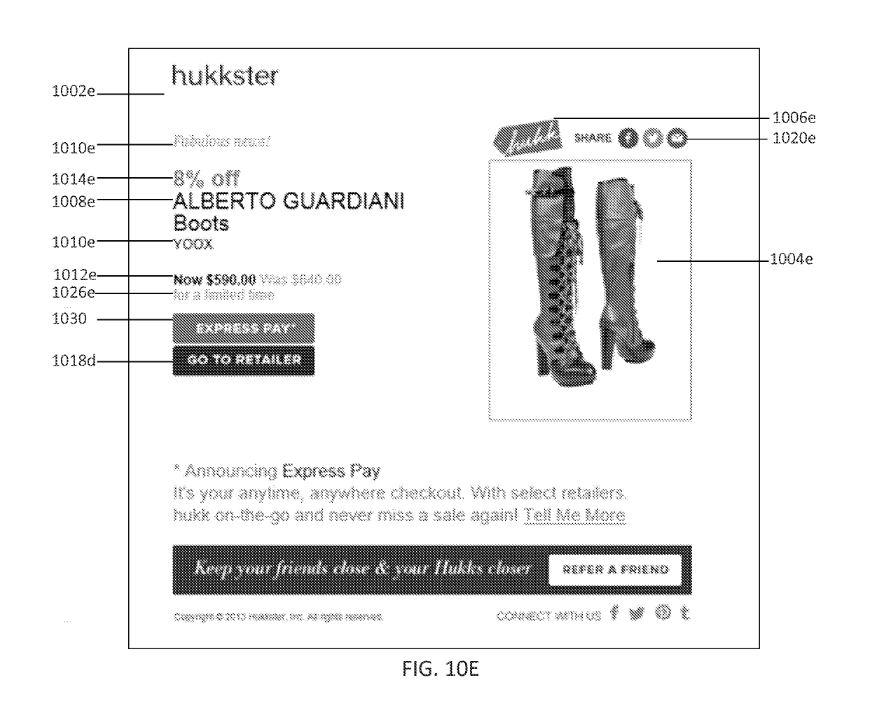

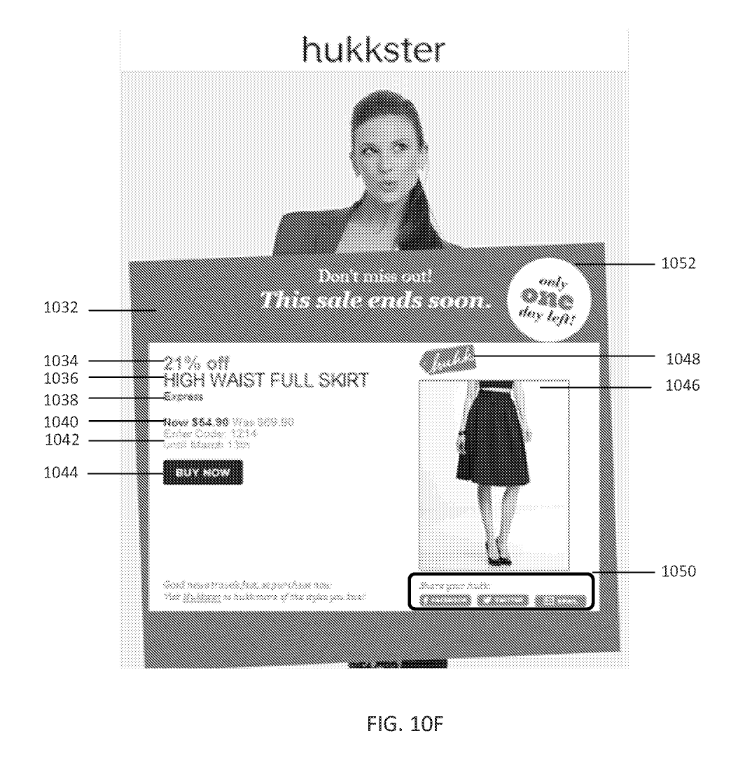

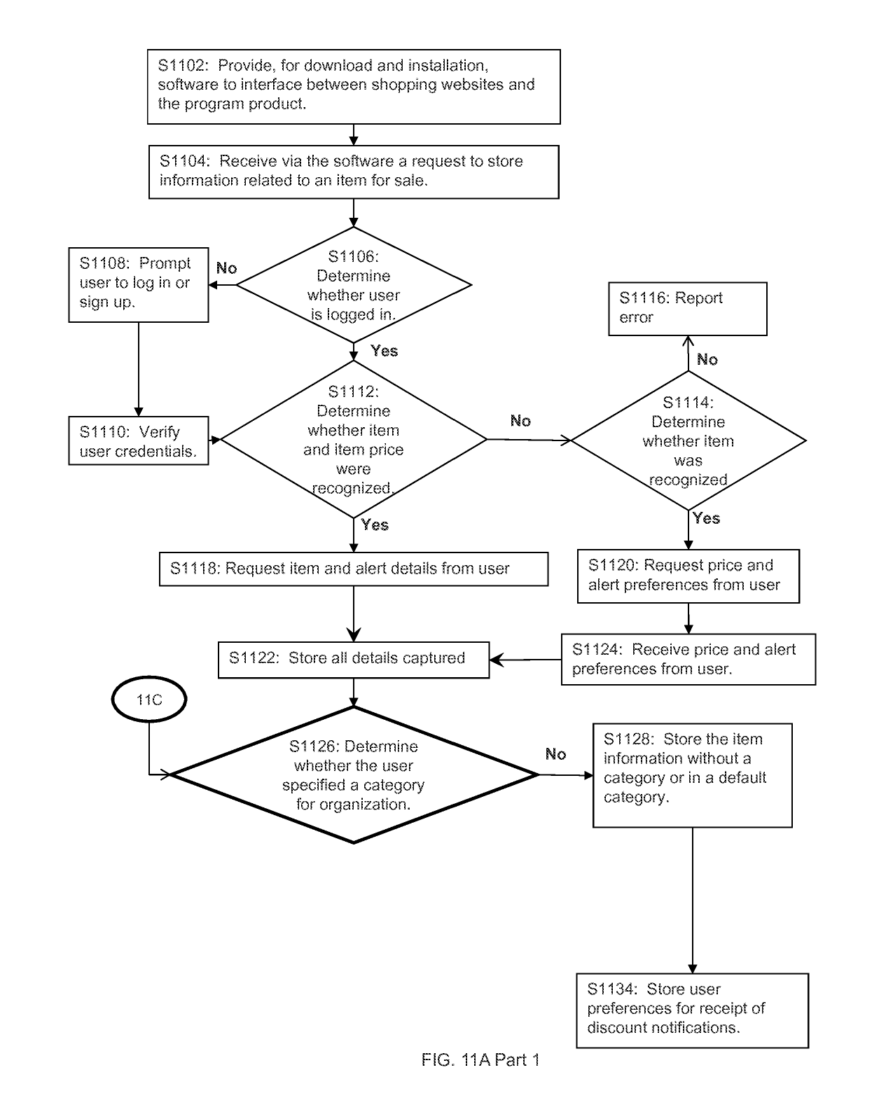

FIGS. 10A-10F are exemplary screen shots of a notification of a discounted price of an item for sale in accordance with exemplary embodiments of the present invention. Such a notification may be displayed on a webpage and/or on an interface corresponding to downloadable software. In embodiments, such a notification may be transmitted to one or more user electronic devices, e.g., via email.

FIG. 10A shows an exemplary screenshot of a discount notification 1002 in accordance with exemplary embodiments of the present invention. In embodiments, the notification 1002 may include any of a product image 1004, a storage indication 1006 to indicate that the product was stored by the user, a product name or identification information 1008, merchant identification information 1010, a personalized message 1012 (which may comprise a user's name), price information 1014, a discount indication 1016, which may indicate the discount amount or percentage, e.g., 41%, a discount duration, discount conditions (e.g., available with purchase of two or more items), a purchase button 1018, and/or product share links 1020, e.g., a Facebook button, to share any of the product information with other people, via e-mail or social networking websites, to name a few.

FIG. 10B shows an exemplary screen shot of a discount notification 1002b in accordance with exemplary embodiments of the present invention. In embodiments, the notification 1002b may include any of a product image 1004b, a storage indication 1006b to indicate that the product was stored by the user, a product name or identification information 1008b, merchant identification information 1010b, a personalized message 1012b (which may comprise a user's name), price information 1014b, a discount indication 1016b, a purchase button 1018b, and/or product share links 1020b. In embodiments, the notification 1002b may be customized for a specific merchant. The notification format may dynamically change depending on merchant identification information 1010b of the item for sale. In embodiments, the notification customization may include a co-branded notification header featuring an item storing and/or discount notification service identifier 1002b with a merchant or brand identifier 1022. Notification customization can also entail generation, transmission, and/or display of a customized banner 1024, which may include additional item recommendations from the specified merchant, a link to a third-party merchant website 1024′. The notification may also include a direct link to a list 932 on the website 902 associated with the program product and/or a link to display items for sale from a specified merchant, to name a few.

FIG. 10C shows an exemplary screen shot of a discount notification 1002c in accordance with exemplary embodiments of the present invention. In embodiments, the notification 1002c may include any of a product image 1004c, a storage indication 1006c to indicate that the product was stored by the user, a product name or identification information 1008c, merchant identification information 1010c, a personalized message 1012c, price information 1014c, a discount indication 1016c, a purchase button 1018c, and/or product share links 1020c, to name a few. In embodiments, the notification may indicate a promotion or coupon code 1026 and a period 1026 for which a discounted price will be in effect, e.g., “until March 18^{th}”, “sale lasts until Sunday”, or “until March 18^{th} at 5 PM”, to name a few. The promotional details may be automatically updated on the website via the computer system for item storing, monitoring, and/or discount notifications.

FIG. 10D shows an exemplary screen shot of a discount notification in accordance with exemplary embodiments of the present invention. In embodiments, the notification 1002d may include any of a product image 1004d, a storage indication 1006d to indicate that the product was stored by the user, a product name or identification information 1008d, merchant identification information 1010d, a personalized message 1012d, price information 1014d, a discount indication 1016d, a purchase button 1018d, and/or product share links 1020d. In embodiments, the notification may provide suggestions 1028 of items for sale, which suggestions may be based upon user specific information that is captured in one or more data tables on one or more the data servers 112. The suggested items may be similar products from one or more other merchants and/or similar products from the same merchant 1010d as the discounted item. The computer system can identify one or more product variants that are associated with and/or similar to the specific item requested by the user. In embodiments, supplemental products may be recommended, such as leather treatment as a supplemental product to a leather boots main product. FIG. 10D may be better understood through FIG. 21C, a flow chart of an exemplary process to display product recommendations in accordance with exemplary embodiments of the present invention. In addition to displaying the image of the product variant, the system may provide the item title, merchant name, current price, any live and/or applicable coupon codes, an indication of whether the product variant is currently discounted, and/or a link to the product webpage on a third-party ecommerce website, to name a few.

FIG. 10E shows an exemplary screen shot of a discount notification in accordance with exemplary embodiments of the present invention. In embodiments, the notification 1002e may include any of a product image 1004e, a storage indication 1006e to indicate that the product was stored by the user, a product name or identification information 1008e, merchant identification information 1010e, a personalized or other message 1012e aimed at the user, price information 1014e, a discount indication 1016e, a link to the merchant to purchase the item for sale 1018e, and/or product share links 1020e. In embodiments, the notification may provide the option to purchase the item for sale through a third-party provider, e.g., through a payment button 1030, such as an “Express Pay” button. The user may purchase the item for sale directly by selecting the payment button 1030, which may execute the purchase without accessing the associated merchant website. The third-party provider may store user purchase information (e.g., credit card information, billing address, to name a few) enabling the user to purchase through this third-party service.

FIG. 10F shows an exemplary screen shot of a discount notification reminder in accordance with exemplary embodiments of the present invention. The discount notification reminder 1032 may be sent to a user and/or displayed after the user receives an initial notification 1002. A notification reminder 1032 may be sent out at any point before the product's promotional discount expires, including 24 hours before the promotion ends, 1 hour before the promotion ends, to name a few. In embodiments, the notification reminder may display the time remaining 1052 until the promotional discount expires. In embodiments, the reminder 1032 may include any of a product image 1046, a storage indication 1048 to indicate that the product was stored by the user, a product name or identification information 1036, merchant identification information 1038, price information 1040, a discount indication 1034, which may indicate the discount amount or percentage, e.g., 21% off, a purchase link 1044 (e.g., to the merchant website) to purchase the item for sale, promotion details 1042, and/or product share links 1050.

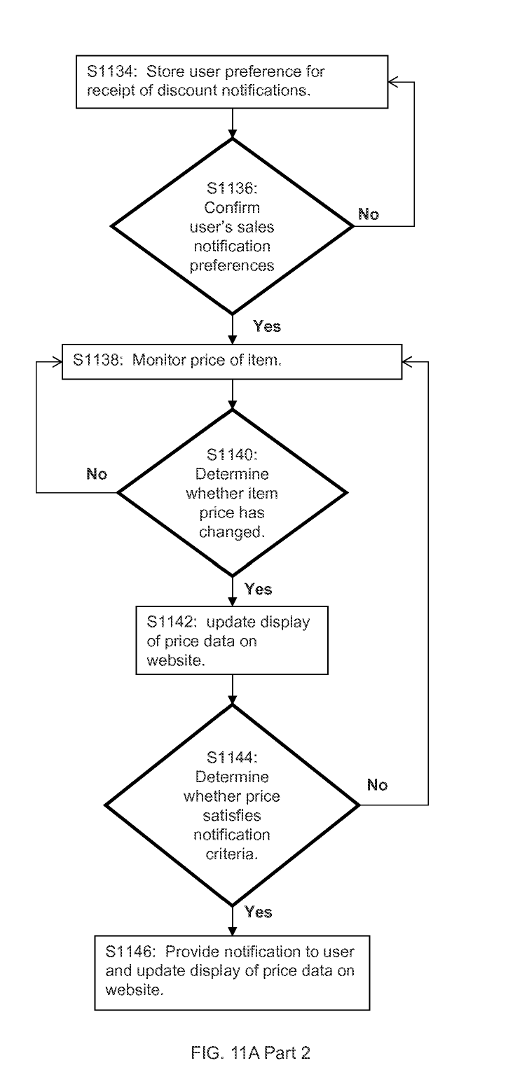

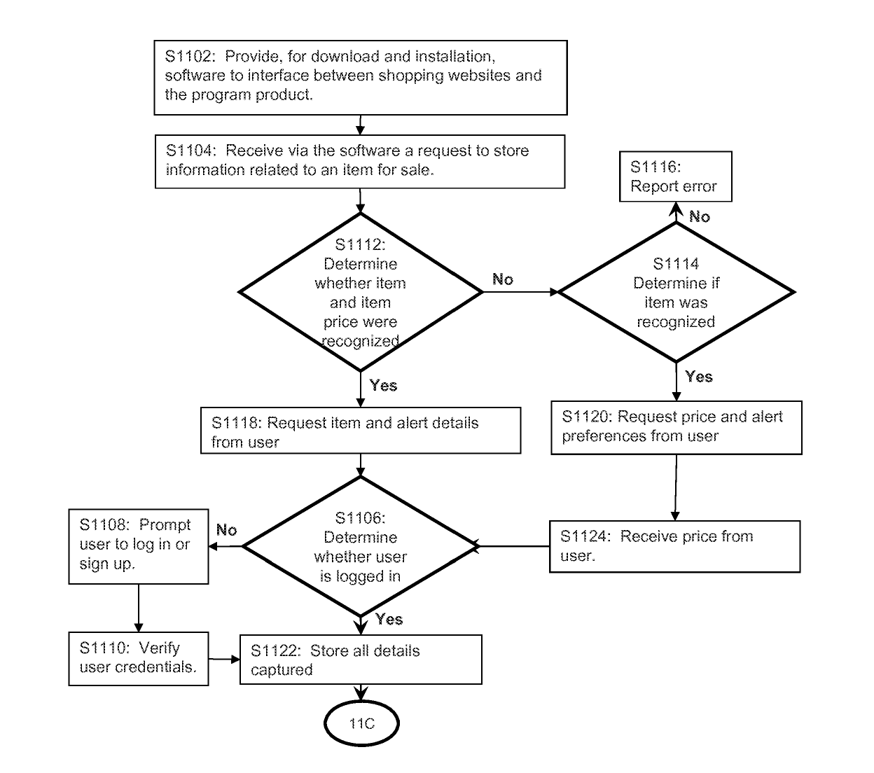

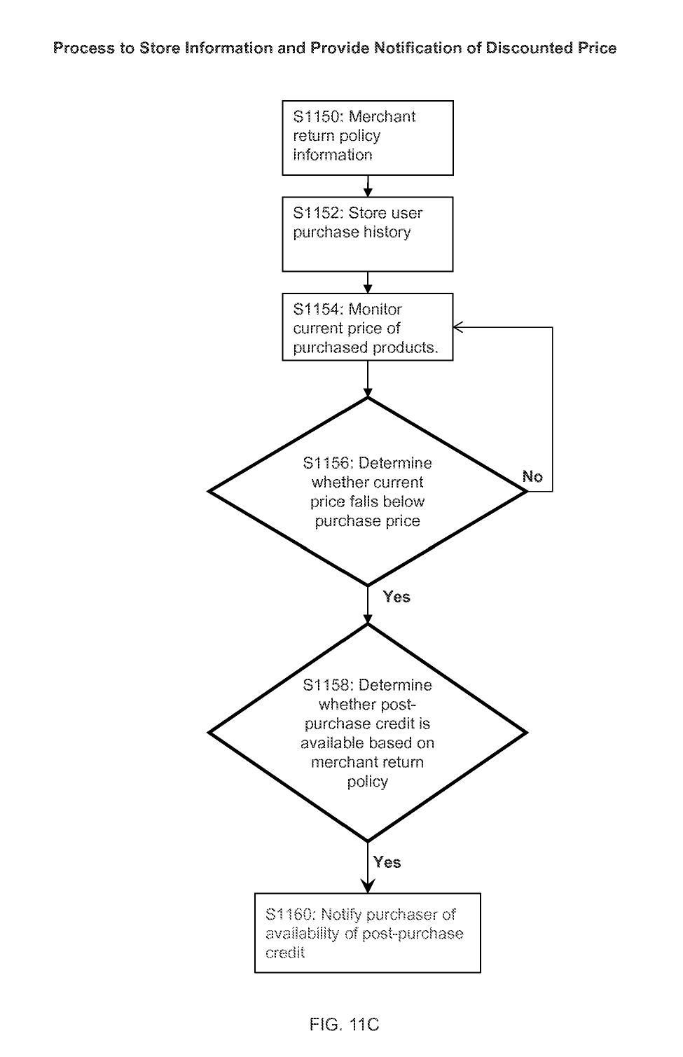

FIGS. 11A-B are component flow charts of various exemplary embodiments of the item storage and discount notification process.

FIG. 11A is illustrated in two parts, FIG. 11A Part 1 and FIG. 11A Part 2 solely due the lack of sufficient space for the illustration on a single page; the separation is not intended to express or imply any statement about the process. In a step S1102, software, such as item storing software 210, may be provided for download and installation by users in order to interface between the storage and notification system, on one hand, and product or merchant websites, on the other hand. The user may choose to download a bookmarklet or a browser plug-in that can be used in conjunction with a variety of web browser platforms (e.g., in conjunction with a first-party website and/or third-party websites). FIGS. 4A and 4B show exemplary processes related to step S1102 for a user to obtain software to interface between the program product and websites offering items for sale in accordance with exemplary embodiments of the present invention, and the exemplary screen shots of FIGS. 5A and 5B show a webpage providing item storing software 210. In embodiments, the item storing software 210 may be provided through downloadable software, such as computer software or a mobile application for a smart phone. In alternative embodiments, the user's browsing information, e.g., on product and merchant websites, may be stored for future analysis. In a step S1104, the storage and notification system may receive via the software 210 a request to store information related to an item for sale. In some implementations, rather than downloading and installing software on the user's device, the software may be accessible to the user on a website hosting said software (including but not limited to a first-party website, a third-party merchant website, or a third-party publisher website), e.g., in the form of an applet, button, and/or a like mechanism.

In a step S1106, the system may determine whether the user is logged into the system. If the user is logged in, step S1112 may be performed. If the user is not logged in, at a step S1108, the user may be prompted to log in or sign up for the website. If the system detects that the user has an existing account with the item storing software 210, the system can present a modal as depicted in the screenshot in FIG. 7 and/or otherwise ask the user to sign in using the user's specific, chosen unique email address and password. This sign-in modal can also provide to the user the option to log in using existing email accounts or accounts on social networks, such as Google+ 708 and Facebook 710, to name a few. If the system does not detect an existing user account with the item storing software 210, the system can present a modal as depicted in the screenshot in FIG. 6 and/or otherwise ask the user to create a new account using a unique email address and password. This modal can also provide the user the option to create an account leveraging existing email accounts or accounts on social networks, such as Google+ 612 and Facebook 614, to name a few. Then, at a step S1110, the user's login credentials may be verified before proceeding to step S1112.

In alternative embodiments, for example, a user, instead of being provided with the software to download and install, may be provided with a portal which may have embedded technology (e.g., a web applet and/or other embedded software) in order to allow the user to visit merchant websites via the embedded technology. In such embodiments, the user may, after verifying the user's credentials in a manner similar to step S1110, receive via the portal a request to store information related to an item for sale, and may then proceed to step S1112. In some implementations, browsing data obtained via the embedded technology may be stored for future analysis.

In embodiments, in a step S1112, the system may determine whether item and item details such as price 808, size selection options 810 (e.g. small, medium, large) and color selection options 808f (e.g. red, orange, blue) were recognized after login step S1106. If recognized, the system can proceed with step S1118. If not recognized, in a step S1114 the system may determine if the item itself was recognized. This step can include performing recognition of an item title and identifying, processing, and/or displaying a picture of the item. If the item remains unrecognized, then an error may be reported in a step S1116, and an error message may be displayed to the user.

If the item was recognized, then in a step S1120 a request for item price and alert preferences from user may be presented to the user, e.g., through a software interface. Step S1120 may be better understood through the exemplary screen shot of FIG. 8C of the interface provided by the software to store information related to an item for sale for later action in accordance with exemplary embodiments of the present invention. In step S1124 the item price and alert preferences may be received at the computer system from the user.

If in step S1112 it is determined that item and price are recognized, then in a step S1118, a request for item and alert details is sent to the user and/or displayed via an interface. These item details can comprise user selections to specify product characteristics, to choose among variants, and/or to define a product variant. Item details can include options such as size 810 and/or color 842, among others. In embodiments, the user can select these details, such as by using a drop down menu provided by the item storing software 210. In addition, the user can indicate notification preferences, e.g., using drop down menu 812. The item storing software 210 may provide a user with a price notification preference setting, e.g., an option to receive notifications when an item is discounted at all 822, when an item is discounted at 25% 824, or when an item is discounted at 50% 826, to name a few. The software 210 may provide an option for a user to specify a discount amount or discount percentage 828 or a sale price 830 at which a sale notification is triggered. In embodiments, the item storing software 210 may provide a user with a preference setting to automatically purchase items for sale via express pay, e.g., a ‘strike price’. The purchase preference setting may provide an option to purchase items for sale when an item is discounted to any extent 832, when an item is discounted at 25% 834, when an item is discounted at 50% 836, or when an item is discounted by some other amount or percentage, to name a few. In embodiments, the software 210 may provide an option for a user to specify a discount percentage 838 or a sale price 840 at which the item may be automatically purchased by the system using a user's stored account information. This account information will include credit card, billing and shipping information previously provided by the user and stored in the user profile data 216.

Following either step S1118 or step S1124, the item selections, price and alert preferences may then be stored, e.g., in the item profile table 220, in a step S1122. The system can then proceed to a step S1126.

If in step S1126 the system determines that the user specified a category, the system may, in a step S1130, store in the specified category the information related to the item.

If in step S1126 the system determines that the user did not specify category information, in a step S1128 the information related to the item may be stored without a category or in a default category. In embodiments, the system may provide automatic recognition of categories (e.g., by product type, merchant, or brand, to name a few) and may store items accordingly. If no category information was received, step S1134 may follow. If category information was received in step S1126 (such that there is no longer a lack of category information), then in step S1130 the item may be stored in the specified category.

In a step S1134 the computer system may proceed to store user preferences related to criteria for the receipt of discount notifications.

In a step S1136, the user's discount notification preferences may be confirmed. If changed, (i.e., not confirmed), the system may store the new user notification preferences. If unchanged, in a step S1138, the system may monitor the price of the item. In some embodiments, the system may also monitor a price of a product variant. The system may monitor the price of the item as displayed on a merchant website. In addition, the system can determine whether a coupon code is active that may be applied to the item and result in an additionally discounted item price.

In a step S1140, the system may determine whether an item's or product variant's price has changed since the last monitored price. Price change can include a price increase or decrease and can be the result of an item markdown as displayed on the merchant website, or due to a discounted price that is reflected when an item is selected for purchase on the merchant website and/or a coupon code is entered into the merchant website. If the item price has changed since the last monitored price, the system can proceed to step S1142. The system may also display the updated price, e.g., on website associated with the computer system, as depicted in FIG. 9A as item price data 908. If the current price did not change since the last monitored price, the system may continue in step S1138 to monitor the price. This monitoring will take place either indefinitely, until the user requests that the system no longer store information related to the previously requested item, and/or until the system receives an indication that the user (or another user, as in the case of a gift registry) purchased the item.

In a step S1144 the system may determine whether an item's price satisfies the discount notification criteria. If the current price does not satisfy the notification criteria, the system may continue in step S1138 to monitor the price. If in step S1144 the system determines that the current price meets one or more notification criteria, in a step S1146 the system may provide a notification to the user. The notification preferences of the user may be used to generate an electronic notification, which can include a particular notification type according to the user's preferences (e.g., text message, push notification, instant message, Facebook message, and/or email notification, to name a few).

FIG. 11B illustrates another embodiment of the process described in FIG. 11A, Part 1 and 11A, Part 2. In a step S1102, software, such as item storing software 210, may be provided for download and installation by users in order to interface between the storage and notification system and product websites or merchant websites. The user may choose to download a bookmarklet or a browser plug-in that can be used in conjunction with a variety of web browser platforms and/or the user may be provided with a software application for download. Step S1102 may be better understood through the flow charts of FIGS. 4A and 4B, which present exemplary processes for a user to obtain software to interface between the computer system and websites offering items for sale in accordance with exemplary embodiments of the present invention, as well as through the exemplary screen shots of FIGS. 5A and 5B, which show a webpage providing item storing software 210.

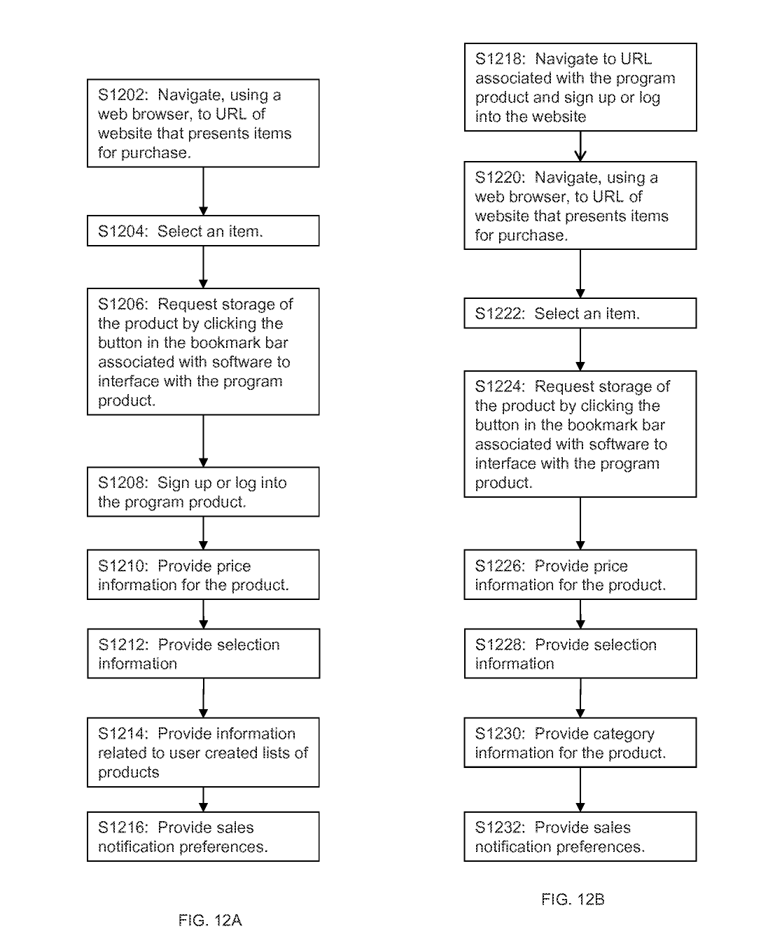

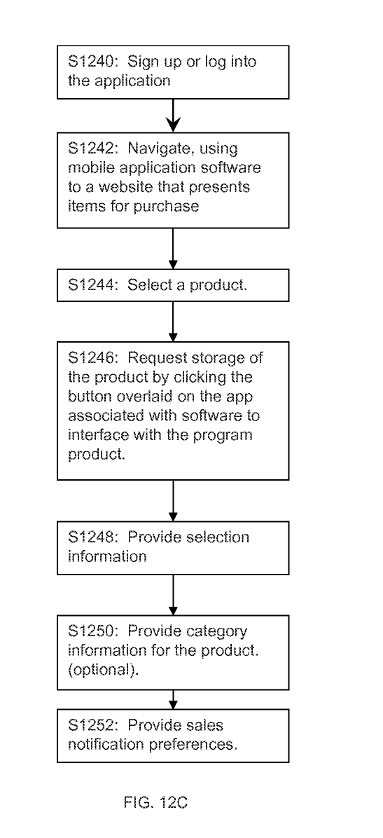

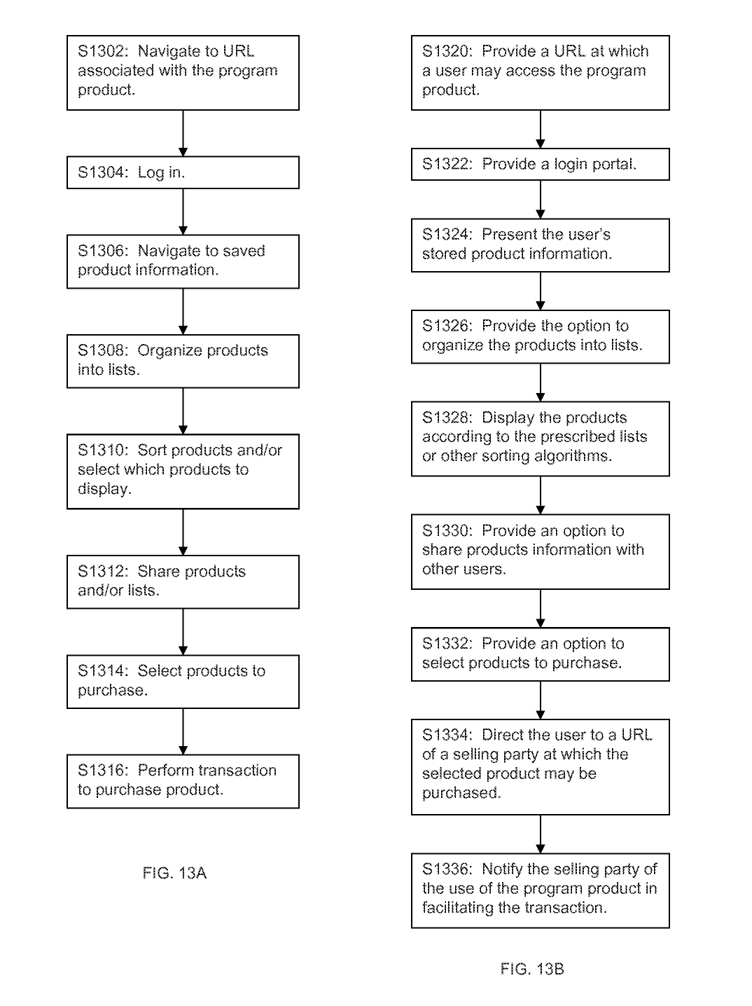

In a step S1104, the storage and notification system may receive via the software 210 a request to store information related to an item for sale. The system may receive this request via downloadable software or via a user interfacing with a web browser on a user electronic device, which is described in detail in FIGS. 12A and 12B and depicted in screenshots in FIGS. 8A-F.

In embodiments, in step S1112, the system may determine whether item and item details such as price 808, size selection options 810 (e.g. small, medium, large), and color selection options 808f (e.g. red, orange, blue) were recognized after step S1104. If so, system may proceed with step S1118. If not, in step S1114 the system may determine if the item was recognized. This can include the recognition of item title and identifying, processing, and/or displaying a picture of the item. If not, then an error may be reported in step S1116, and an error message may be displayed to the user.

If in step S1114 the item was recognized, then in step S1120 a request for item price and alert preferences may be presented to the user. Step S1120 may be better understood through the exemplary screen shot of FIG. 8C of the interface provided by the software to store information related to an item for sale for later action in accordance with exemplary embodiments of the present invention. In step S1124 the item price and alert preferences may be received from the user.

If in step S1112 is the system determines that item and price are recognized, then in step S1118, a request is sent to the user and/or displayed on the interface (e.g., the webpage) for item and alert details. These item details can include user selections of options such as size 810 and/or color 842, among others. The user can select these details using a drop down menu provided in the item storing software 210. In addition, the user can indicate notification preferences using a drop down menu 812. The item storing software 210 may provide a user with a price notification preference setting, e.g., an option to receive notifications when an item is discounted to any extent 822, when an item is discounted at 25% 824, or when an item is discounted at 50% 826, to name a few. The software 210 may provide an option for a user to specify a discount percentage 828 or a sale price 830 at which a sale notification is triggered. In embodiments, the item storing software 210 may provide a user with a preference setting to automatically purchase items for sale via express pay, e.g., a ‘strike price’. The purchase preference setting may provide an option to purchase items for sale when an item is discounted at all 832, when an item is discounted at 25% 834, or when an item is discounted at 50% 836, to name a few. In embodiments, the software 210 may provide an option for a user to specify a discount percentage 838 or a sale price 840 at which the item may be automatically purchased by the system using a user's stored account information. This account information can include credit card, billing and shipping information previously provided by the user and stored in the user profile data 216.

Before proceeding with step S1122, user log in must be verified, starting with step S1106. In a step S1106, the system may determine whether the user is logged into the system. If the user is logged in, step S1122 may be performed. If the user is not logged in, at a step S1108, the user may be prompted to log in or sign up for the website. If the user has an existing account with the item storing software 210, the system can present a modal as depicted in the screenshot in FIG. 7 and/or can ask the user to sign in using the user's specific, chosen unique email address and password. This modal can also provide to the user the option to log in leveraging existing email accounts or accounts on social networks, such as Google+ 708 or Facebook 710, to name a few. If the user does not yet have an account with the item storing software 210, the system can present a modal as depicted in the screenshot in FIG. 6 and ask the user to create a new account using a unique email address and password. This modal can also provide the user the option to create an account leveraging existing email accounts or accounts on social networks, such as Google+ 612 or Facebook 614, to name a few. Then, at a step S1110, the user's login credentials may be verified before proceeding to step S1122 in which all variant details may then be stored.

Following either step S1106 or step S1110, the item selections, price and alert preferences may then be stored, e.g., in a stored item profile table 220, in a step S1122. The system can then proceed to step S1126, e.g., as shown in FIG. 11A, Part 1.

FIG. 11C illustrates an exemplary process to store information and provide notification of a discounted price. This process may be performed using a computer system and/or associated software, such as item storing software 210. In embodiments, the functions attributed to item storing software 210 may be performed by one or more other software modules running on one or more processors and/or on a computer system. In a step S1150, the system will store information related to the return policy for any product variant that is tracked in the item storing software 210. This return policy information may be acquired through the computer's domain-specific data extraction software (e.g., utilizing scrapers, API feeds, and/or the like) that can read every individual product variant's page and store and categorize return policy information automatically as attributes at the product variant level. This information may include such information as how many days from the purchase date the item may be returned, whether the merchant will honor post-purchase price adjustments, to name a few.

In a step S1152, the system will store purchase history related to an item that has been tracked using the item storing software 210 and purchased on a third-party website. This data is stored in shopping profile data 206 and may include the name of the merchant at which the item was purchased, the item title, item price at the time or purchase, whether coupon codes where used during the purchase, and the specific item return policy information, to name a few.

Once an item has been purchased and the information related to that purchase stored in step S1152, the system will monitor the current price that product variant. This monitoring of the current price can be due to a price provided by data extraction software or via a system admin. In step S1154, the system may compare the current item price with the item price at the time of purchase as stored in step S1152. If the system determines in a step S1156 that the item's price has dropped below the item's price at the time the item was purchased, then the system proceeds to step S1158. This is true whether the items current price is lower that the price at the time of purchase due to a change in price as displayed on the third-party website or because of an effective reduced price when an item is taken through the checkout process and/or a coupon code is applied.

In step S1158, the attributes associated with the return policy of the product variant in the database may be retrieved and brought to the system's decision framework for review and matching to determine whether the user may be eligible for a post-purchase credit by the merchant. If the system determines that a post-purchase credit is available then it proceeds to step S1160.

In step S1160 the system may proceed to access stored user preferences related to criteria for the receipt of post-purchase credit notifications. In embodiments, post-purchase credit notification preferences may specify to receive a notification for any post-purchase credit amount or for a certain post-purchase credit amount or percentage (e.g., 25% off), to name a few. Accordingly, the system may provide one or more notifications to a user that a post-purchase credit is available.

An exemplary user process for the storage of information relating to items for sale is depicted by the flow chart in FIG. 12A. In a step S1202, a user may use a web browser to navigate to the URL of a website that presents items for sale. In embodiments, such as website may be a merchant's website. In a step S1204, the user may select an item that is available for purchase on the website whose information the user wishes to store.

In a step S1206, the user may request storage of the item using item storing software 210. In the exemplary embodiment of FIG. 12A, such software 210 can associated with a bookmarklet or bookmark button residing in the bookmarks bar of the web browser or a browser plug-in. Such software can also be a downloadable application or a portion thereof. In embodiments, the software 210 may be activated by clicking on the bookmark button. In embodiments, the software 210 may also be activated by clicking on a browser plug-in. In some implementations, rather than downloading and installing software on the user's device, the software may be accessible to the user on a third-party website (e.g., a third-party merchant or a third-party publisher website) hosting said software.

In a step S1208, the user is required to sign up or log in to the item storage and discount notification system. If the user has an existing account with the item storing software 210, the system will present a pop-up window 702 and ask the user to sign in using the user's specific, chosen unique email address and password. This modal also provides the user the option to log in leveraging existing email accounts or accounts on social networks, such as Google+ 708 or Facebook 710, to name a few. If the user does not yet have an account with the item storing software 210, the system will present a registration screen 602 and ask the user to create a new account using a unique email address and password. This screen also provides the user the option to create an account leveraging existing email accounts or accounts on social networks, such as Google+ 612 or Facebook 614, to name a few.

In a step S1210, the user may be required to provide price information for the product 808c. In embodiments, the software 210 or another aspect of the system may provide the price information 808 automatically. In a step 1212, the user may provide selection information, indicating the specific size 810 and color 842 they wish to be tracked. In a step S1214, the user may provide category information 814 to be used to organize the information related to the item for sale. In embodiments, category information may be required. In a step S1216, the user may be prompted to provide sales notification preferences 812. In embodiments, such preferences will identify criteria to be used in determining when the system will provide notifications of price changes to the user.

An exemplary user process for the storage of information relating to items for sale is depicted by the flow chart in FIG. 12B. In step S1218, a user can sign up or log into the website accordance with exemplary embodiments of the present invention. If the user has an existing account with the item storing software 210, the system will present a log in modal 702 and ask the user to sign in using the user's specific, chosen unique email address and password. This modal also provides the user the option to log in leveraging existing email accounts or accounts on social networks, such as Google+ 708 or Facebook 710, to name a few. If the user does not yet have an account with the item storing software 210, the system will present a registration modal 602 and ask the user to create a new account using a unique email address and password. This modal also provides the user the option to create an account leveraging existing email accounts or accounts on social networks, such as Google+ 612 or Facebook 614, to name a few.

In a step S1220, a user may use a web browser to navigate to the URL of a website that presents items for sale. A user may navigate to a merchant's website via URL links provided the website of the present invention, such as the “Featured Stores” page. Alternatively, the user may navigate to a merchant's website via another browser window.

In a step S1222, the user may select an item that is available for purchase on the website whose information the user wishes to store.

In a step S1224, the user may request storage of the item using item storing software 210. In the exemplary embodiment of FIG. 12B, such software 210 is associated with a bookmarklet or bookmark button residing in the bookmarks bar of the web browser or a browser plug-in. In embodiments, the software 210 is activated by clicking on the bookmark button. In embodiments, the software 210 may also be activated by clicking on a browser plug-in.

In a step S1226, the user may be required to provide price information for the product 808c. In embodiments, the software 210 or another aspect of the system may provide the price information 808 automatically. In a step S1228, the user may provide selection information, indicating the specific size 810 and color 842 they wish to be tracked. In a step S1230, the user may provide category information 814 to be used to organize the information related to the item for sale. In embodiments, category information may be required. In a step S1232, the user may be prompted to provide sales notification preferences 812. In embodiments, such preferences will identify criteria to be used in determining when the system will provide notifications of price changes to the user.

An exemplary user process for the storage of information relating to items for sale is depicted by the flow chart in FIG. 12C. In step S1240, a user can sign up or log into the application. If the user has an existing account with the item storing software, the system will present a screen 2808 and ask the user to sign in using the user's specific, chosen unique email address and password. This modal also provides the user the option to log in leveraging existing email accounts or accounts on social networks such as Facebook 2814 or Google+ 2816, to name a few. If the user does not yet have an account with the item storing software, the system will present a screen 2818 and ask the user to create a new account using a unique email address and password. This modal also provides the user the option to create an account leveraging existing email accounts or accounts on social networks, such as Facebook 2824 or Google+ 2826, to name a few.

In step S1242, a user can navigate, using a mobile application software, to a website that presents items for purchase. In step S1244, user can select a product on the website. In step S1246, the user can request to store the selected product by clicking the button 3216 overlaid on the app associated with the software to interface with the program product. In step S1248, the user can provide the selection information, indicating the specific size 3206 and color 3208 they wish to be tracked. In embodiments, in step S1250, the user can provide category information 3212 for the product. In step S1252, the user can provide sales notification preferences 3210. In embodiments, such preferences will identify criteria to be used in determining when the system will provide notifications of price changes to the user.

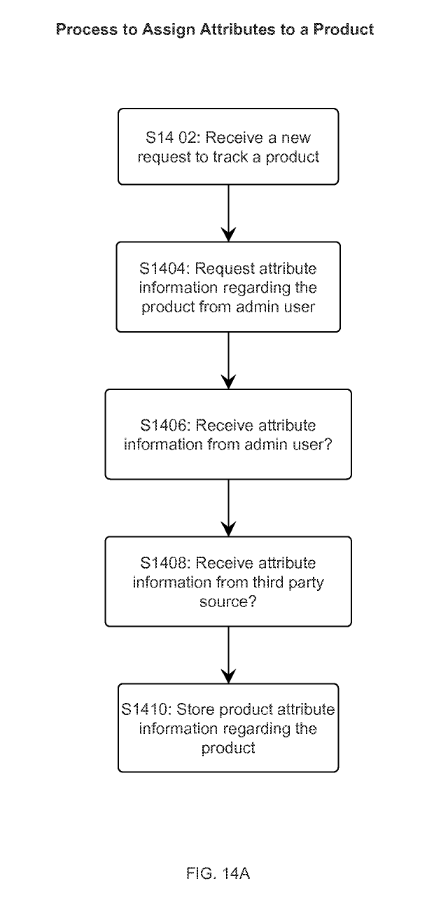

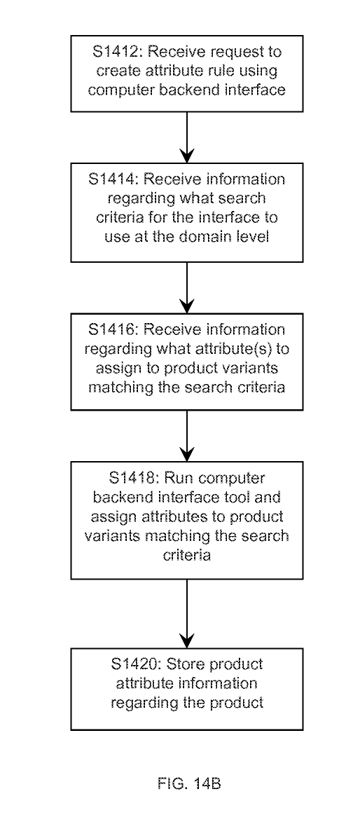

An exemplary user process for accessing and acting upon stored item information is shown in a flow chart in FIG. 13A. In a step S1302, a user may navigate to a URL associated with the item storage and discount notification system. In embodiments, the URL will specify the location of a website related to the system. In a step S1304, the user may be required to log into the website, and the user may log in accordingly. In a step S1306, the user may navigate to a webpage 902 associated with stored item information. In a step S1308, the user may organize the products into categories and lists 916. In embodiments, step S1308 may be optional. In embodiments, the products may already be organized into lists or other categories. In a step S1310, the user may sort the products according to one or more criteria, such as price, date added, merchant, category, to name a few. Also in a step S1310, the user may select which products to display by selecting specific categories or lists 920. For example, the user may select the “Shoes” category to display, which would display only items stored in, labeled as, and/or otherwise associated with that category. In a step S1312, the user may share product information for one or more products 914 and/or entire lists or categories 922. In embodiments, the user may select any of e-mail, social networking sites, or other communication channels by which to share product information. In a step S1314, the user may select products to purchase 912. In a step S1316, the user may perform a transaction to purchase one or more products.

A system-side process corresponding to an exemplary user process for accessing and acting upon stored item information is shown in a flow chart in FIG. 13B. In a step S1320, the system may provide a URL at which a user may access the item storing and discount notification system. In a step S1322, the system may provide a login portal 702, which may accept and/or require a user ID and/or password. In a step S1324, the system may present the user's stored product information. In embodiments, stored product information may be presented on a webpage 902. In a step S1326, the system may provide the option to organize the products into categories or lists 916. In a step S1328, the system may display the product information according to the prescribed lists 920 and/or other sorting algorithms. In a step S1330, the system may provide options and/or links to share product information 912 and/or lists 920 with other users. In a step S1332, the system may provide an option to select products for purchase 912. In a step S1334, the system may direct the user to a URL of a selling party, e.g., a merchant, at which the selected product may be purchased. In a step S1336, the system may notify the selling party of the use of the system in facilitating the transaction.

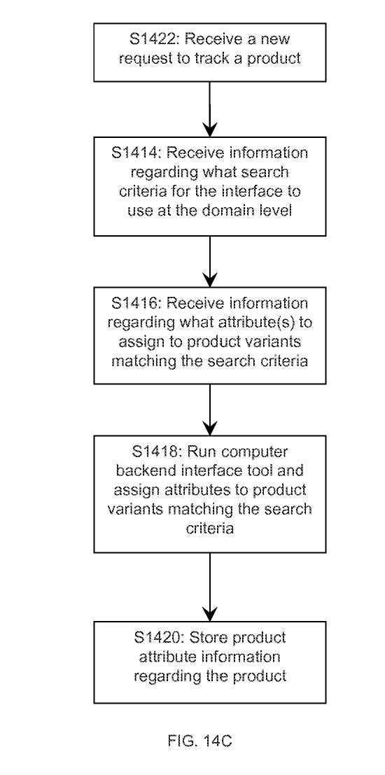

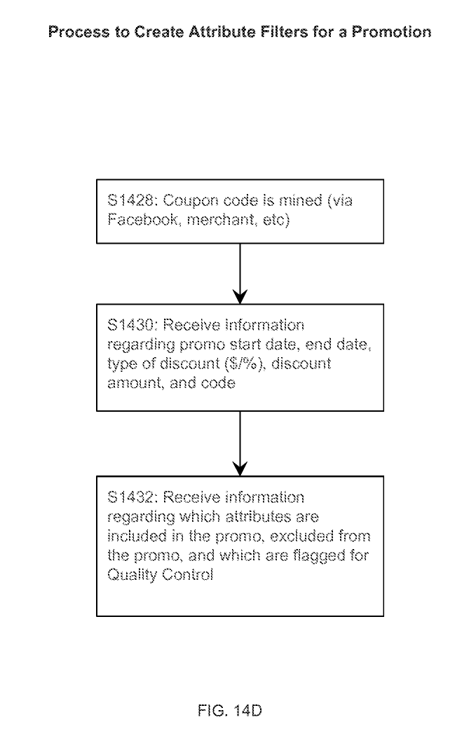

FIGS. 14A-D are flow charts of exemplary processes for attribute assignment and filtering in accordance with exemplary embodiments of the present invention. Such processes may be performed by a computer system.

Referring to FIG. 14A, in a step S1402 a computer system can trigger a request to track a specific product's net effective pricing for sale on a third party ecommerce site. Such pricing may be stored in one or more databases.

In step S1404, the computer system can store the specific SKU or product variant in the database and identify, based on recognition of the SKU and unique identifiers as well as the specific third party ecommerce site, attributes or defining qualities needed to better classify the SKU.

In step S1406, the user admin may be prompted by the computer system to classify requisite SKU attributes, e.g., so that the dataset is complete and comprehensive.

In step S1408, the computer system may receive attribute information from a third-party source, such as a merchant computer system.

In step S1410, the computer system may store all requisite attributes and correlate such defining qualities at the product variant level and often at the product level. A product variant can have upwards of 100s of attributes associated with it to better define and analyze the specific details of the SKU and product makeup.

Referring to FIG. 14B, the user admin can define, using a computer backend interface, rules (e.g., regular expressions) at the domain level requisite for necessary attribute and product categorization. Accordingly, a computer system may receive and/or store such input. For example, a computer system and/or user admin may be prompted (e.g., at step S1412) to determine how to categorize data, e.g., via determining attributes for a commerce website which may be useful for categorization of a product and/or product variant (e.g., at step S1414). The computer system may generate and/or receive instructions on how to categorize information based on those attributes (e.g., step S1416). The computer system may store said instructions and use them to categorize (e.g., step S1418) product information that will be tagged and stored in the database.

In step S1420, the computer system may store all requisite attributes and/or tags provided for particular product data during a categorization process and correlate such defining qualities at the product variant and often at the product level. A product variant can have upwards of 100s of attributes associated with it to better define and analyze the specific details of the SKU and product makeup.

Referring to FIG. 14C, in a step S1422 a computer system can trigger a request to the database track a specific product's net effective pricing for sale on a third party ecommerce site. In a step S1414 the user admin can define, using a computer backend interface, rules (e.g., regular expressions) at the domain level requisite for necessary attribute and product categorization. Accordingly, a computer system may receive and/or store such input. For example, a computer system and/or user admin may determine attributes for a commerce website which may be useful for categorization of a product and/or product variant, and the computer system may generate and/or receive instructions on how to categorize information based on those attributes. The computer system may store said instructions and use them to categorize product information that will be tagged and stored in the database.

In step S1420, the computer system may store all requisite attributes and/or tags provided for particular product data during a categorization process and correlate such defining qualities at the product variant and often at the product level. A product variant can have upwards of 100s of attributes associated with it to better define and analyze the specific details of the SKU and product makeup.

Referring to FIG. 14D in a step S1428 a store specific promotion or discount that is not reflected in the product variant's advertised price can be mined and collected, known as a coupon code. Coupon code data may comprise any of a coupon code (e.g., an alphanumeric text string), product attribute data associated with the coupon code, and/or coupon code redemption data (e.g., expiration date, information about required purchases, such as a minimum purchase or a specific product, and/or merchant information, to name a few). The store specific promotion can come from a variety of sources including the store's homepage or promotional page. The store can proactively communicate the information to the user admin via their affiliate marketing channels, email communications, and/or integrated API or automated resources, social media, or other methods of communication or messaging, to name a few.

In step S1430, the information retrieved from step S1426 may be codified and entered by a user admin into the computer's database according to the computer system's unique system of tagging and codifying and classifying stipulations, rules, and exceptions of the promotion. The information can be entered according to a specific methodology that matches and syncs with the computer's internal algorithm and matching mechanisms. A specialized computer interface may be used to enter such data into the database.

In step S1432, the information and specifications input in step S1428 can be used by the computer system to create a rule automatically to apply the promotion to the product variants, exclude the promotion from the product variants, and/or in rare unique cases flag product variant for review of the promotion. The product variants may be tagged with a promotional status according to the matching mechanism of the attributes assigned to the product variant and the stipulations, rules and the exceptions of the promotion referenced in step S1428.

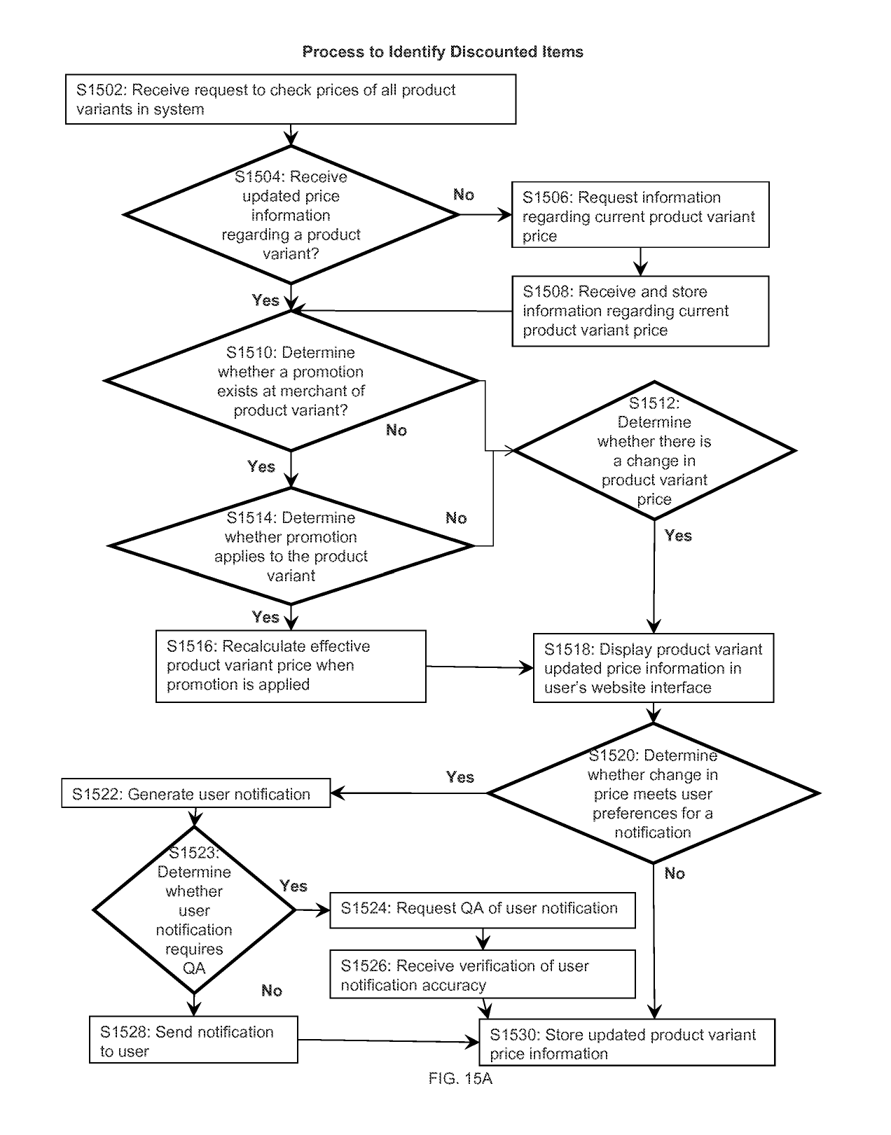

FIGS. 15A-B are a flow charts of an exemplary administrative flow chart to identify discounted items in accordance with exemplary embodiments of the present invention.

Referring to FIG. 15A, step S1502 refers to a process, e.g., a daily process or a process run at other intervals, by which a computer system can trigger a request for the data extraction software, or several instances of the data extraction software, to fetch the current price of all product variants stored in the database of the item storing software 210. In embodiments, data extraction software may be computer software or code that can fetch the price of a product variant from a third-party website. The database may seek out a specific product variant's net effective pricing for sale on a third party merchant web site.

In step S1504, the system determines whether the data extraction software successfully returned a current price for a specific product variant from a third-party website. If the system successfully returned a current price for the product variant, then the system proceeds to step S1510.

However, in select cases, the system will not return an updated current price for the product variant and will cause the system to request quality assurance by a system administrator in step S1506. This failure of the data extraction software to successfully return a current price can be caused by a number of factors, including a malfunction in the data extraction software process, a mismatch between the product local ID information stored in the stored item profile table 218 and that local ID on the third-party website, to name a few. In addition, the data extraction software may not return an updated current price but instead set the possibly sold out status to equal true if the read data does not return a matching product. Such a status may flag an item for quality assurance review by an administrator, who may also fix broken links.

In step S1508, a system administrator performs a quality assurance review to set the correct current price of the product variant. If the product variant had been flagged as possibly sold out, the system administrator will perform quality assurance to determine whether the item is sold out on the merchant website and if so, will set the product variant flag sold out to true.

In step S1510, the system must determine whether the third-party website associated with the product variant currently has a live promotion. In order to make this determination, a computer system may mine data for one or more coupon codes to determine if one is active at the third-party merchant website associated with the product variant. Coupon code data may comprise any of a coupon code (e.g., an alphanumeric text string), product attribute data associated with the coupon code, and/or coupon code redemption data (e.g., expiration date, information about required purchases, such as a minimum purchase or a specific product, and/or merchant information, to name a few). Mining coupon code data can entail receiving by a computer system coupon code data from a merchant and/or accessing by a computer system coupon code data, e.g. from one or more merchant websites. Mining may be performed by computer software running on one or more processor configured to access and/or analyze merchant websites (e.g., scraping website data). Coupon code data may be stored in non-transitory computer-readable media comprising one or more databases.

If the system determines that there is no live promotion at the third-party merchant website associated with that product variant, then the system proceeds to step S1512.

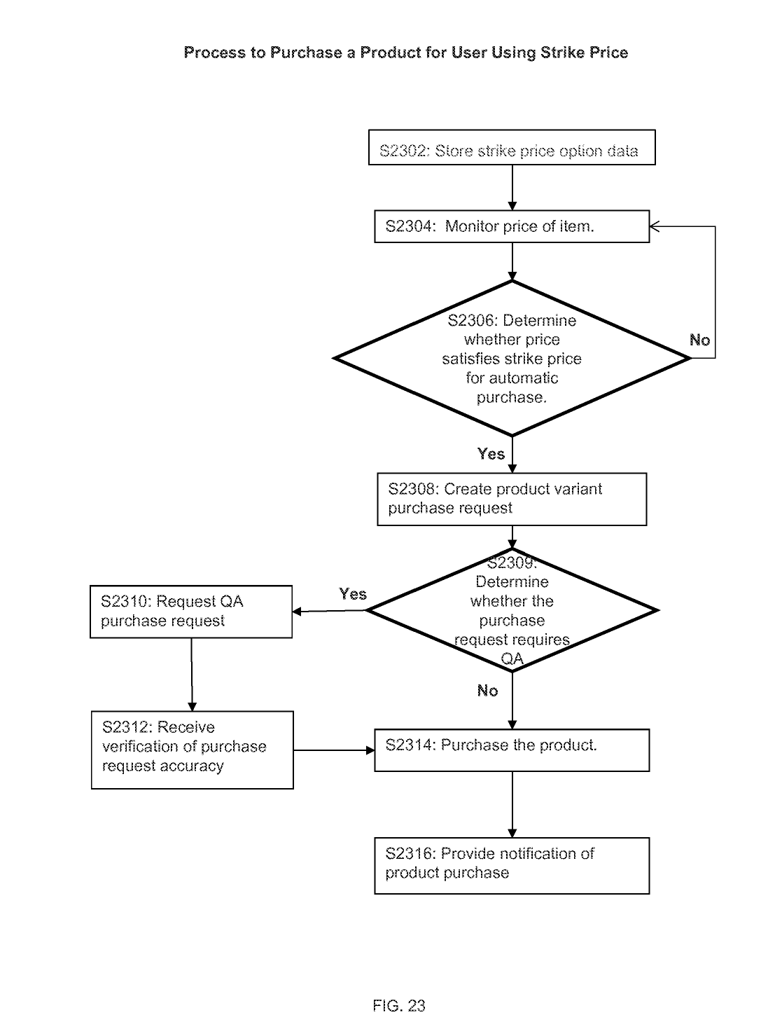

If the system determines that a live promotion does exist at the third-party website associated with that product variant, then the system proceeds to step S1514 to determine whether the promotion applies to that specific product variant. Step S1514 may be understood through the flow chart FIG. 23A of the exemplary process to apply coupon codes to a product and send a notification to the user as well as to apply a coupon code to a product in real-time when the item storing and discount notification technology is used on a retailer website. If step S1514 reveals that a promotion does apply to the product variant, the system proceeds to step S1516. If there is no live promotion that applies to the product variant, then the system proceeds to step S1512.

In step S1512, the system may determine whether a product variant's price has changed since the last monitored price. This updating of the current price can be due to a price provided by data extraction software or via a system admin in S1508. Price change can include a price increase or decrease and can be the result of a price markdown as displayed on the merchant website, or due to a discounted price that is reflected when an item is selected for purchase on the retail website, i.e. ‘added to cart’ and/or a coupon code is entered into the merchant website. If the product variant price has changed since the last monitored price, the system proceeds to step S1518 and displays that updated price on the system website for the product 908.

If step S1514 reveals that a promotion does apply to the product variant, the system proceeds to step S1516. In step S1516, the merchant promotion is flagged as applied to the specific product variant and the computer can then associate the specifics of the code with the product variant's current price. The current price of the product variant can come from the computer's automated sources or data extraction software or in some cases from a user admin who reviewed the product variant to ensure quality assurance. The current price may then be discounted further by the computer's algorithm and the information entered by the user admin and the current price with blankets for the product variant (e.g., the net effective price) may be updated and discounted further. Once this net effective price is calculated, the system proceeds to step S1518 and displays that updated price on the system website 908. The system will indicate that the product variant has a promotion applied to it and may provide information including coupon code, promo end date, to name a few.

In step S1520, the computer determines if the price has changed such that a price alert notification is necessary. The notification preferences of the user may be noted, which can include a particular notification type according to the user's preferences (e.g., text message, push notification, instant message, Facebook message, and/or email notification). The notification combination noted in the user's preferences in the database may be created and queued for quality assurance.

If these notification preferences have been met such that a notification is necessary, a notification will be generated in step S1522 and the system will proceed to step S1523. If a notification is not necessary, the system proceeds to step S1530.

In step S1523, the system determines whether the user notification requires quality assurance review, and if so proceeds to step S1524. If quality assurance is not necessary, the system proceeds to step S1530.

In step S1524, the notification has been flagged for quality assurance. The computer may allow the user admins (e.g., using specialized computer user interfaces) as well as additional computer processes to review the notifications for accuracy before automatically sending. In embodiments, the quality assurance step may be optional and review of a notification, in a step S1526, may be determined based on the user admin's proprietary knowledge of the merchant's promotional cadence and complexity of the promotion, which knowledge may be stored in one or more databases and/or programmed into computer code configured to apply one or more rules for notification evaluation. Once the system receives verification of quality assurance, the system sends notification(s) to the user.

In step S1530, the system stores all updated price information associated with the product variant. This includes the current price as displayed on the merchant website, and if applicable, the effective discounted price when the promotion is applied, promo code, promo end date, to name a few.

Referring to FIG. 15B, step S1502b refers to a process, e.g., a daily process, by which a computer system can trigger a request for data extraction software, or multiple instances of data extraction software, to fetch the current price of all items (e.g. “hukks”) stored in the database of the item storing software 210. In embodiments, data extraction software may be computer software or code that can fetch the price of an item from a third-party website. The database may seek out a specific item's net effective pricing for sale on a third party merchant website.

In step S1504b, the system determines whether the data extraction software successfully returned a current price for a specific item from a third-party website. If the system successfully returned a current price for the item, then the system proceeds to step S1510.

However, in select cases, the system will not return an updated current price for the item and will cause the system to request quality assurance by a system administrator in step S1506. This failure of the data extraction software to successfully return a current price can be caused by a number of factors, including a malfunction in the data extraction software, a mismatch between the product local ID information stored in the stored item profile table 218 and that local ID on the third-party website, to name a few. In addition, the data extraction software may not return an updated current price but instead set the possibly sold out status to equal true if the read data does not return a matching product. Such a status may flag an item for quality assurance review by an administrator, who may also fix broken links.

In step S1508, a system administrator performs a quality assurance review to set the correct current price of the product variant. If the product variant had been flagged as possibly sold out, the system administrator will perform quality assurance to determine whether the item is sold out on the merchant web site and if so, will set the product variant flag sold out to true.

In step S1510, the system must determine whether the third-party website associated with the product variant currently has a live promotion. In order to make this determination, a computer system may mine data for one or more coupon codes to determine if one is active at the third-party merchant website associated with the product variant. Coupon code data may comprise any of a coupon code (e.g., an alphanumeric text string), product attribute data associated with the coupon code, and/or coupon code redemption data (e.g., expiration date, information about required purchases, such as a minimum purchase or a specific product, and/or merchant information, to name a few). Mining coupon code data can entail receiving by a computer system coupon code data from a merchant and/or accessing by a computer system coupon code data, e.g. from one or more merchant websites. Mining may be performed by computer software running on one or more processor configured to access and/or analyze merchant websites (e.g., scraping website data). Coupon code data may be stored in non-transitory computer-readable media comprising one or more databases.

If the system determines that there is no live promotion at the third-party merchant web site associated with that merchant, then the system proceeds to step S1512.

If the system determines that a live promotion does exist at the third-party website associated with that product variant, then the system proceeds to step S1514 to determine whether the promotion applies to that specific product variant. Step S1514 may be understood through the flow chart FIG. 23A of the exemplary process to apply coupon codes to a product and send a notification to the user as well as to apply a coupon code to a product in real-time when the item storing and discount notification technology is used on a retailer web site. If step S1514 reveals that a promotion does apply to the product variant, the system proceeds to step S1516. If there is no live promotion that applies to the product variant, then the system proceeds to step S1512.

In step S1512, the system may determine whether a product variant's price has changed since the last monitored price. This updating of the current price can be due to a price provided by data extraction software or via a system admin in S1508. Price change can include a price increase or decrease and can be the result of a price markdown as displayed on the merchant website, or due to a discounted price that is reflected when an item is selected for purchase on the retail website, i.e. ‘added to cart’ and/or a coupon code is entered into the merchant website. If the product variant price has changed since the last monitored price, the system proceeds to step S1518 and displays that updated price on the system website for the product 908.

If step S1514 reveals that a promotion does apply to the product variant, the system proceeds to step S1516. In step S1516, the merchant promotion is flagged as applied to the specific product variant and the computer can then associate the specifics of the code with the product variant's current price. The current price of the product variant can come from the computer's automated sources or data extraction software or in some cases from a user admin who reviewed the product variant to ensure quality assurance. The current price may then be discounted further by the computer's algorithm and the information entered by the user admin and the current price with blankets for the product variant (e.g., the net effective price) may be updated and discounted further. Once this net effective price is calculated, the system proceeds to step S1518 and displays that updated price on the system website 908. The system will indicate that the product variant has a promotion applied to it and may provide information including coupon code, promo end date, to name a few.

In step S1520, the computer determines if the price has changed such that a price alert notification is necessary. The notification preferences of the user may be noted, which can include a particular notification type according to the user's preferences (e.g., text message, push notification, instant message, Facebook message, and/or email notification). The notification combination noted in the user's preferences in the database may be created and queued for quality assurance.

If these notification preferences have been met such that a notification is necessary, a notification will be generated in step S1522 and the system will proceed to step S1523. If a notification is not necessary, the system proceeds to step S1530.

In step S1523, the system determines whether the user notification requires quality assurance review, and if so proceeds to step S1524. If quality assurance is not necessary, the system proceeds to step S1530.

In step S1524, the notification has been flagged for quality assurance. The computer may allow the user admins (e.g., using specialized computer user interfaces) as well as additional computer processes to review the notifications for accuracy before automatically sending. In embodiments, the quality assurance step may be optional and review of a notification, in a step S1526, may be determined based on the user admin's proprietary knowledge of the merchant's promotional cadence and complexity of the promotion, which knowledge may be stored in one or more databases and/or programmed into computer code configured to apply one or more rules for notification evaluation. Once the system receives verification of quality assurance, the system sends notification(s) to the user.

In step S1530, the system stores all updated price information associated with the product variant. This includes the current price as displayed on the merchant website, and if applicable, the effective discounted price when the promotion is applied, promo code, promo end date, to name a few.

In embodiments, stored item data may comprise any of original price, item title, item selections, discount threshold, current price, price with blanket promotions, blanket promotions, inventory status, attributes, URL, image URL, image saved URL, local ID, item data ID, user's email, administrator assignment data. The original price may be the price at the time the item data is stored or the price initially offered by the merchant. The title may be obtained (e.g., read) from the URL of the item at the time the item data is stored. Selections may describe variants or options chosen by a user relating to the item, such as size, color, fabric, type, etc. Available variants may range by store and/or product type. The discount threshold may be selected by a user at the time that the item data is stored. The discount threshold may dictate a minimum discount necessary for a notification to be generated. Subsequent notifications may be dictated by a last notified price, which may be a price at which a user last received a notification or a price at which a notification was confirmed by an administrator (e.g., using a notifications tab). The current price may be the item price at the time of the last price check, which may be performed by data extraction software and/or an administrator. In embodiments, data extraction software may be computer software or code that can fetch the price of an item from a third-party website. The price with blanket promotions may be the current price minus any blanket promotion discount. Blanket promotions may be generally applied discounts, such as a store-wide sale (e.g. 20% off everything sold by a particular merchant) and/or a category sale (e.g., 15% off shoes), to name a few. In embodiments, administrators may enter blanket promotions into the system at the store level. Inventory status may indicate that an item is sold out or possibly sold out, to name a few. A sold out inventory status may indicate that the item is no longer available. The status may be reflected on a website storing and/or displaying item data. Links associated with the item information may be deactivated and/or the item may be removed from future checks for status updates (e.g., price updates, blanket discount/promotion updates, inventory updates, to name a few). Possibly sold out status may be set by data extraction software code if the read data does not return a matching product. Such a status may flag an item for manual check by an administrator, who may also fix broken links. An attribute may provide descriptive information associated with an item. Attributed may be set at the store level and edited at the stored data level by administrators. In embodiments, one or more computers may automate or partially automate this process, e.g., using machine learning. The URL may indicate the website from which item data was stored. The image URL may indicate the location of an image associated with the item, which may have been set at the time the item data was stored. The image saved URL may indicate another or the same image associated with an item. The local ID may define a product. In embodiments, the local ID may be a style number. In embodiments, the local ID may be found on a merchant's site. In embodiments, the local ID may be assigned by the system. The item data ID may be a unique numeric identifier generated by system and used to identify the stored item data in a database and/or on an administrative portal. Administrator assignment data may indicate which administrator is responsible for checking and/or maintaining an item's stored data.

Attributes may categorize stored item data and minimize blanket promotion check work. Attribute categories may be created at the domain level and attributes may be assigned at the stored item data level. An attribute needed status of previously attributed stored item data may become “True” when the current price changes (up or down).

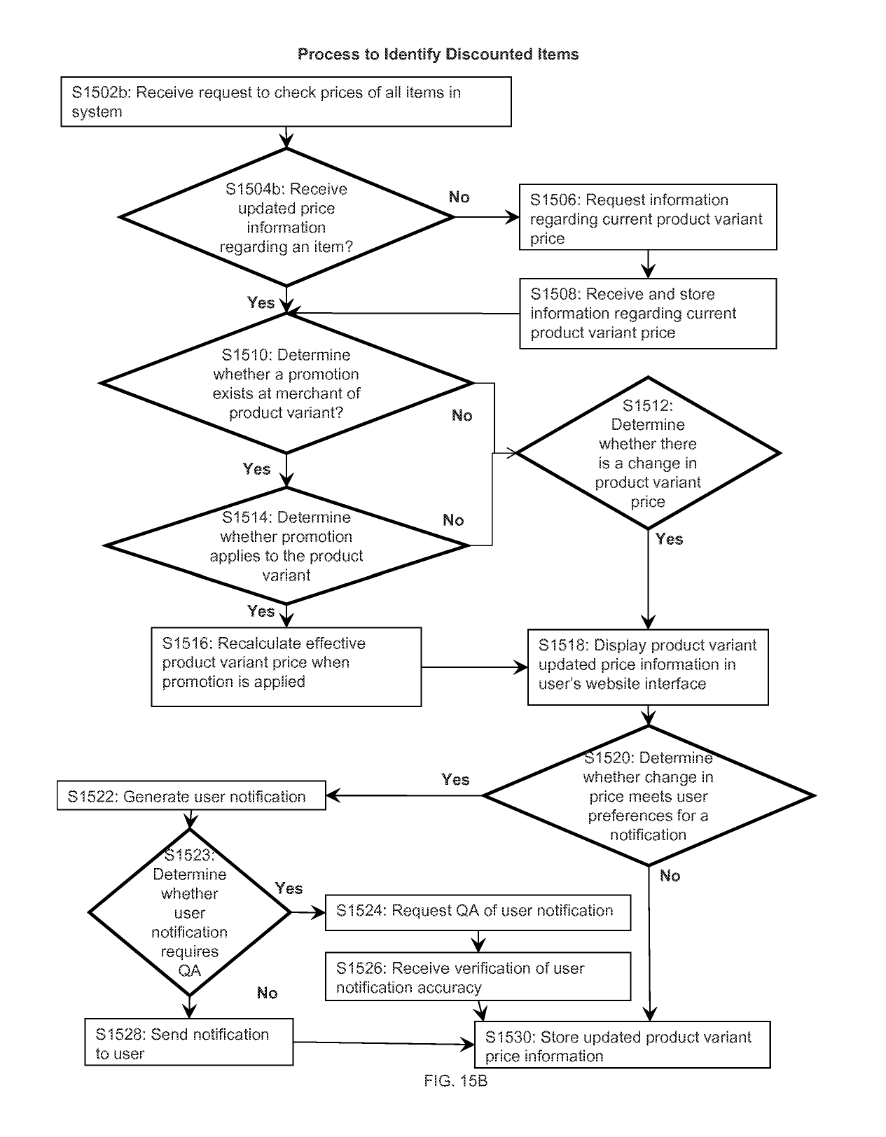

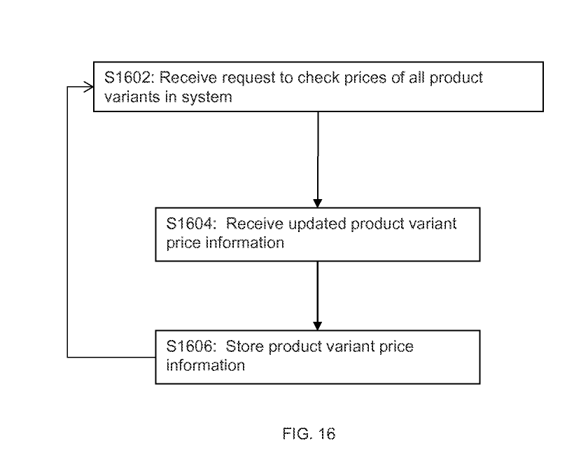

FIG. 16 is a flow chart of an exemplary administrative flow chart to identify discounted items in accordance with exemplary embodiments of the present invention and to store item price information for future analysis.

Referring to FIG. 16, step S1602 refers to a process, which may be a daily process, by which a computer system can trigger a request for data extraction software or multiple instances of the data extraction software, to fetch the current price of all product variants stored in one or more databases in one or more data servers 112 of the item storing software. In embodiments, data extraction software may be computer software or code that can fetch the price of a product variant from a merchant website. The database will seek out a specific product variant's net effective pricing for sale on a merchant website. The system may also request that a system administrator performs a quality assurance review to set the correct current price of the product variant.

In step S1604 the system receives updated product variant price information via a series of steps. Step S1604 may be better understood through the flow chart FIG. 15A of an exemplary administrative flow chart to identify discounted items in accordance with exemplary embodiments of the present invention.

In step, S1606, the system stores this updated current price information each day in the stored item price profile table 220, product profile table 308, and the product variant profile table 310. After the variant price information is stored, this process will be repeated starting at step S1602.

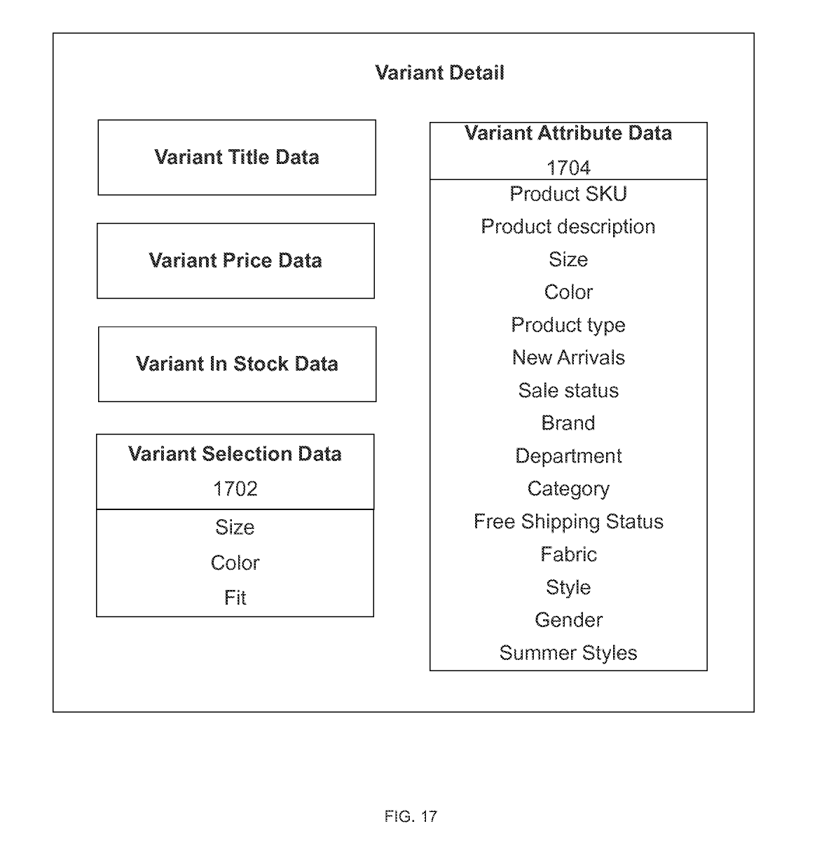

FIG. 17 is a schematic diagram of a website that presents exemplary attributes in accordance with exemplary embodiments of the present invention. The computer can store the specific item or product variant in the database and identify, based on recognition of the SKU and unique identifiers as well as the specific third party ecommerce site, attributes or defining qualities needed to better classify the item. Attributes 1704 for a product variant are implemented at the domain level and remain consistent for all product variants from the same merchant. Attribute values are identified at the variant level and are specific to the product variant being tracked in by the item storing software 210 and stored in the product variant profile table 310. In some implementations, other such attributes may also be implemented and/or identified in order to facilitate identification or tracking product variants.

Still referring to FIG. 17, a product variant's selection attributes 1702, including but not limited to size and color (other such examples are shown in 1704), are implemented at the variant level. Product variants may indicate an instance of a product with a specific set of attributes such as size or color that are used to indicate precisely which item configuration a user would like to purchase. A user may specify these variant selections 1702 when storing an item for sale to be tracked.

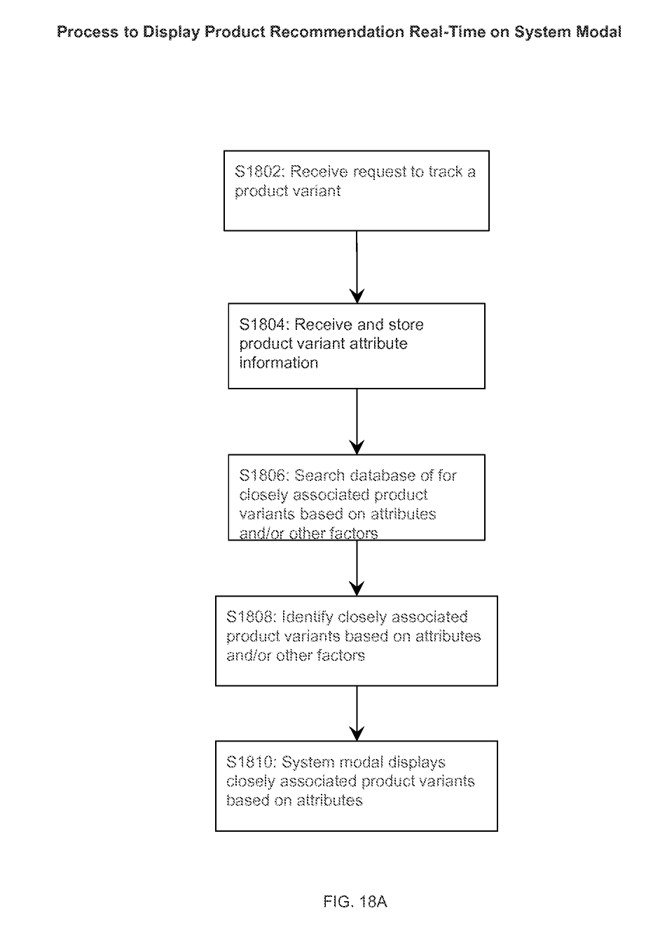

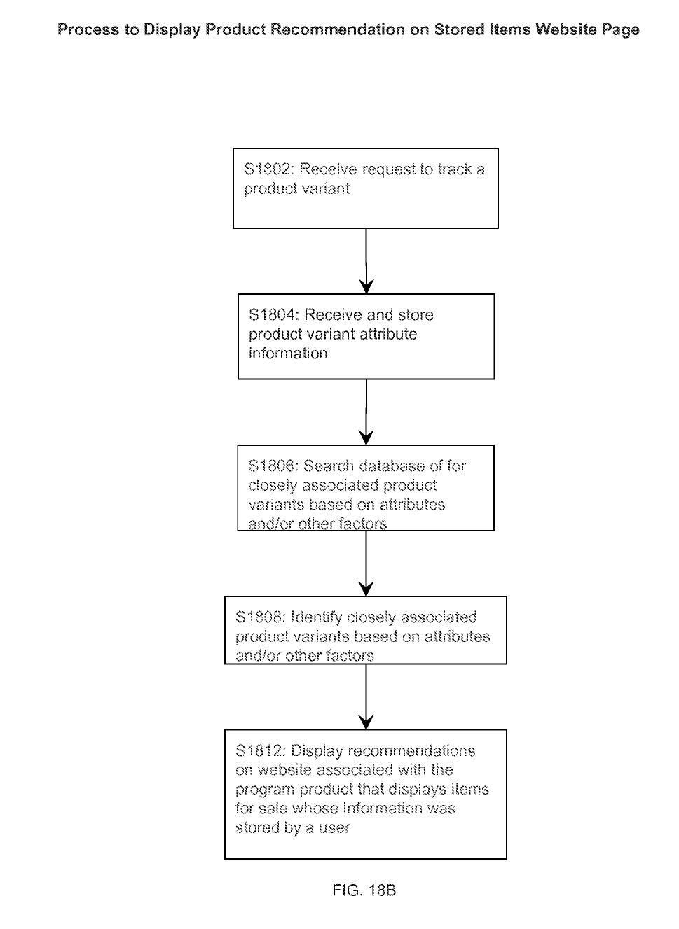

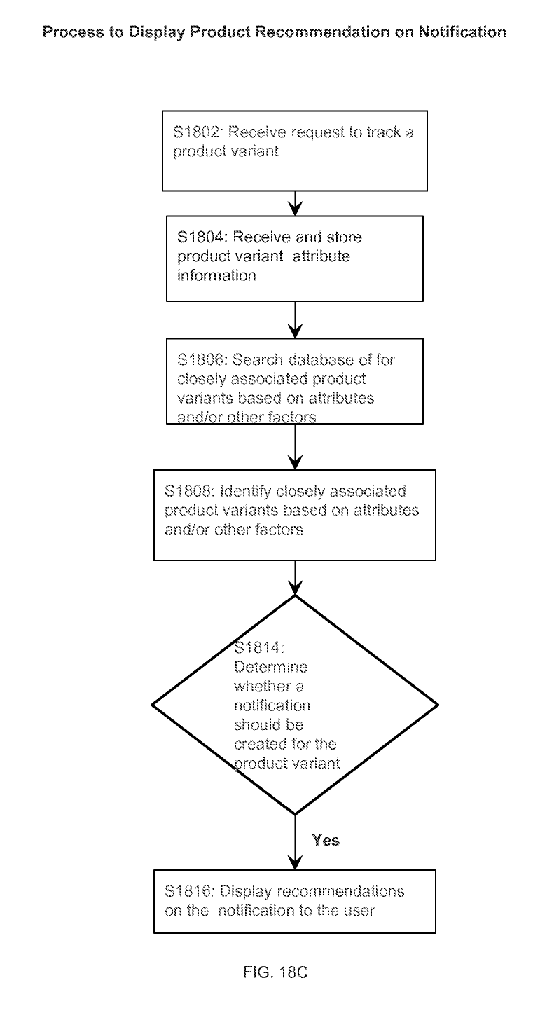

FIGS. 18A-C are flow charts of exemplary processes to display product recommendations in accordance with exemplary embodiments of the present invention.

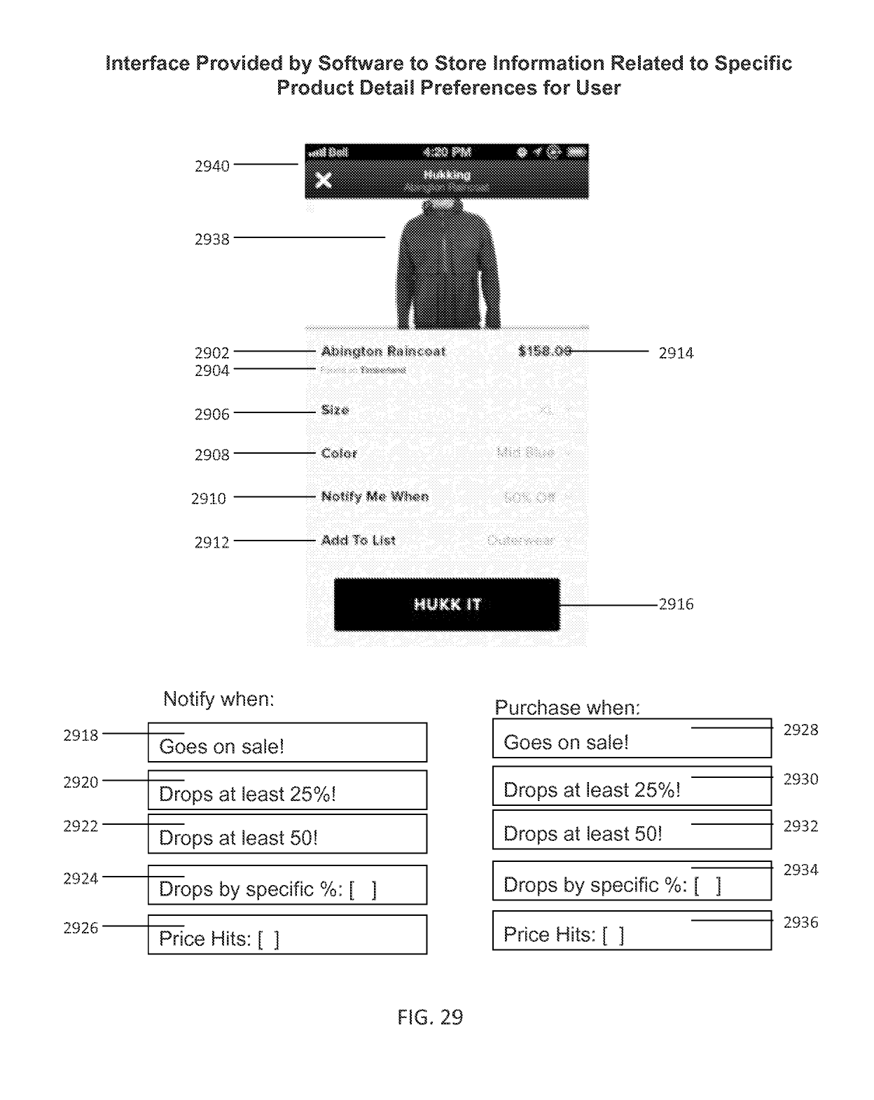

Referring to FIG. 18A, in step S1802, the storage and notification system may receive via the item storing software 210 a request to store information related to a product variant for sale. The system may receive this request via a user on a web browser, which may be better understood through the exemplary processes of FIGS. 12A and 12B and the exemplary screenshots of FIGS. 8A-8F. The system may also receive this request via a user on using mobile application software, which may be better understood through the exemplary process FIG. 12C and exemplary screenshot FIG. 29.

Still referring to FIG. 18A, in step S1804, after the request to track the product variant is received in step S1802, data extraction software may read the webpage of the product variant and receive and store unique product variant identifiers such as store url, product ID, SKU number, style number, URL, and product title. These identifiers also include item selections (e.g., size, color, width, to name a few). In addition, the data extraction software can read required regular expressions from every individual item's page and the regular expressions can be parsed according to the inputs and stipulations 51412 and categorized automatically at the product variant level 51416, as described with respect to FIG. 14B. All product variant attributes and read data can be stored in the computer's database in the product variant profile table 310 for easy reference, filtering, and/or application.

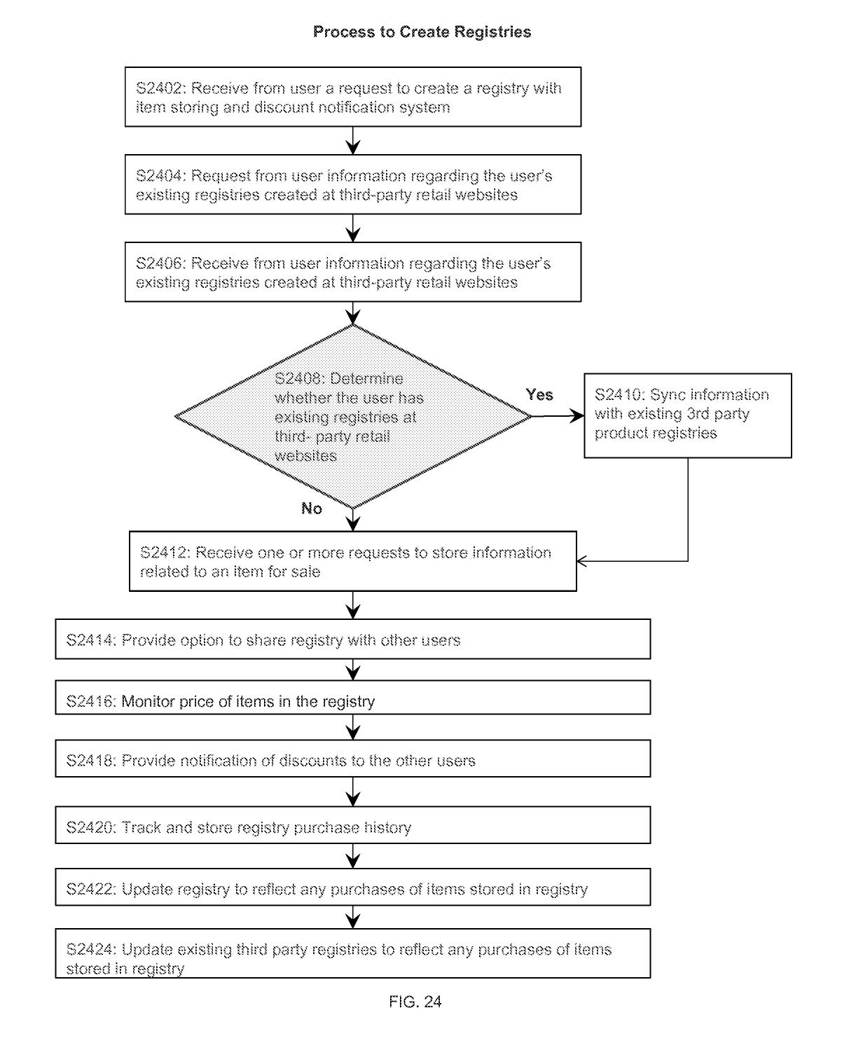

Still referring to FIG. 18A, in step 51806, the system searches the database for product variants that are associated with the product variant requested to be tracked by the item storing software 210 based on the matching of a variety of product attributes and/or a variety of other factors. This process of associating variants may be better understood through the flowcharts FIG. 24B and FIG. 24C of exemplary processes for creating associations between product variants in accordance with exemplary embodiments of the present invention. The system uses a set of rules to match specific, previously defined attributes across product variants and associate them as different types of user recommendations. In step S1808, the system identifies one or more product variants that are associated with the specific product variant requested by the item storing software 210, e.g., based on matching based on the matching of a variety of product attributes and/or a variety of other factors.

Still referring to FIG. 18A, in step 51810, the system displays an image of one or more of those associated (i.e. recommended) product variants (e.g., associated based on matching based on the matching of a variety of product attributes and/or a variety of other factors) to the user via the interface 802 provided by the software to store information related to an item for sale and/or other information for later action in accordance with exemplary embodiments of the present invention. An example of these recommended variants is depicted as 844 and 846 in FIG. 8F. The system may also display these recommended product variants within the mobile iOS application FIG. 29. In addition to displaying the image of the product variant, the system may provide the item title, merchant name, current price, any live, applicable coupon codes, an indication of whether the product variant is currently discounted (i.e. at a lower price that the ‘original’ price displayed on the website), and/or other information, and will provide a link to the product webpage on a third-party merchant website. The system may also provide an option to purchase one or more of the recommended product variants via an express pay feature. The express pay feature may be better understood through the exemplary screenshot FIG. 10E.

Referring to FIG. 18B, in step S1802, the storage and notification system may receive via the software 210 a request to store information related to an item for sale. The system may receive this request via a user on a web browser, which may be better understood through the exemplary processes FIGS. 12A and 12B and exemplary screenshots FIGS. 8A-8F. The system may also receive this request via a user on using mobile application software, which may be better understood through the exemplary process FIG. 12C and exemplary screenshot FIG. 29.

Still referring to FIG. 18B, in step S1804, after the request to track the product variant is received in step S1802, data extraction software, which may comprise computer software and/or specialized computer code, may read the webpage of the product variant and receive and store unique product variant identifiers such as store url, product ID, SKU number, style number, URL, and product title. These identifiers also include item selections (e.g., size, color, width, to name a few). In addition, the data extraction software can read required regular expressions from every individual item's page and the regular expressions can be parsed according to the inputs and stipulations S1412 and categorized automatically at the product variant level S1516, as described with respect to FIG. 14B. All product variant attributes and read data can be stored in the computer's database in the product variant profile table 310 for easy reference, filtering, and/or application.

Still referring to FIG. 18B, in step S1806, the system searches the database for product variants that are associated with the product variant requested to be tracked by the item storing software 210 based on the matching of a variety of product attributes. This process of associating variants may be better understood through the flowcharts FIG. 24B and FIG. 24C of exemplary processes for creating associations between product variants in accordance with exemplary embodiments of the present invention. The system uses a set of rules to match specific, previously defined attributes across product variants and associate them as different types of user recommendations. In step S1808, the system identifies one or more product variants that are associated with the specific product variant requested by the item storing software 210.

In step S1812, the system displays an image of one or more of those associated (i.e. recommended) product variants to the user via the website 902 displaying items stored by a user. An example of these recommended variants are depicted in 924 and 926 in FIG. 9B. In addition to displaying the image of the product variant, the system will provide the item title, merchant name, current price, any live, applicable coupon codes, an indication of whether the product variant is currently discounted (i.e. at a lower price that the ‘original’ price displayed on the website), and will provide a link to the product webpage on a third-party ecommerce website. The system may also provide an option to purchase one or more of the recommended product variants via an ‘Express Pay’ feature. The ‘Express Pay’ feature may be better understood through the exemplary screenshot FIG. 10E.

Referring to FIG. 18C, in step S1802, the storage and notification system may receive via the software 210 a request to store information related to an item for sale. The system may receive this request via a user on a web browser, which may be better understood through the exemplary processes FIGS. 12A and 12B and exemplary screenshots FIGS. 8A-8F. The system may also receive this request via a user on using mobile application software, which may be better understood through the exemplary process FIG. 12C and exemplary screenshot FIG. 29.

Still referring to FIG. 18C, in step S1804, after the request to track the product variant is received in step S1802, data extraction software may read the webpage of the product variant and receive and store unique product variant identifiers such as store url, product ID, SKU number, style number, URL, and product title. These identifiers also include item selections (e.g., size, color, width, to name a few). In addition, the data extraction software can read required regular expressions from every individual item's page and the regular expressions can be parsed according to the inputs and stipulations S1412 and categorized automatically at the product variant level S1416. All product variant attributes and read data can be stored in the computer's database in the product variant profile table 310 for easy reference, filtering, and/or application.

Still referring to FIG. 18C, in step S1806, the system searches the database for product variants that are associated with the product variant requested to be tracked by the item storing software 210 based on the matching of a variety of product attributes. This process of associating variants may be better understood through the flowcharts FIG. 24B and FIG. 24C of exemplary processes for creating associations between product variants in accordance with exemplary embodiments of the present invention. The system uses a set of rules to match specific, previously defined attributes across product variants and associate them as different types of user recommendations. In step S1808, the system identifies one or more product variants that are associated with the specific product variant requested by the item storing software 210.

In step S1814, the system may determine whether a notification should be sent to the user. This process may be better understood through the flow chart FIG. 17A of an exemplary administrative process to identify discounted items in accordance with exemplary embodiments of the present invention. If in step S1814 the system determines that a notification should be sent to the user, in step S1816 the system generates a notification that displays an image 1028 of one or more of the associated (i.e. recommended) product variants to the user via an email notification 1002d. In addition to displaying the image of the product variant, the notification will provide the item title, merchant name, current price, any live, applicable coupon codes, an indication of whether the product variant is currently discounted (i.e. at a lower price that the ‘original’ price displayed on the website), and will provide a link to the product webpage on a third-party ecommerce website. The system may also provide an option to purchase one or more of the recommended product variants via an ‘Express Pay’ feature. The ‘Express Pay’ feature may be better understood through the exemplary screenshot FIG. 10E.

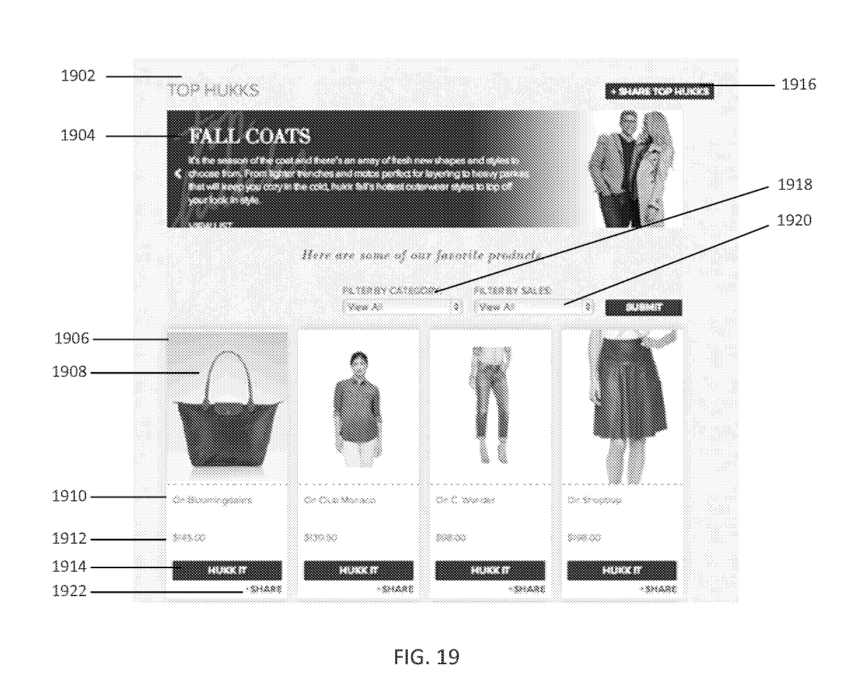

FIG. 19 is a screen shot of an exemplary website related to the process of identifying suggested product recommendations, displaying real-time price information for those products, providing a link to the product, and enabling a user to share suggested products with a user's contacts. The website 1902 associated with the computer system may display a list of suggested product recommendations, e.g., “Top Hukks”, “Fall Coats”, “Shoes We Love”, to name a few. A tile 1906 may contain a product image 1908, merchant name 1910, current product price 1912, a product description, direct link to save the product in item storing software 1914, and/or a sale notification, to name a few. A list of top stored items can be user-specific based upon their browsing history and on their items stored for price-tracking and purchasing history. A user may filter the product recommendations by category 1918, e.g. “Women's,” “Men's,” and “Under $100.” A user may also filter the product recommendations by sale status 1920, e.g. “Full Price” or “Sale.” In embodiments, a user may share the product recommendations through electronic mail or social networking websites 1922, e.g., Facebook, Twitter and Pinterest, to name a few. In embodiments, a user may share 1916 all tiles through electronic mail or social networking websites.

FIGS. 20A-B are flow charts of exemplary processes to apply coupon codes to a product and send a notification to the user as well as to apply a coupon code to a product in real-time when the item storing and discount notification technology is used on a merchant website.

Referring to FIG. 20A, in a step S2002 a computer system may mine data for one or more coupon codes. Coupon code data may comprise any of a coupon code (e.g., an alphanumeric text string), product attribute data associated with the coupon code, and/or coupon code redemption data (e.g., expiration date, information about required purchases, such as a minimum purchase or a specific product, and/or merchant information, to name a few). Mining coupon code data can entail receiving by a computer system coupon code data from a merchant and/or accessing by a computer system coupon code data, e.g. from one or more merchant websites. Mining may be performed by computer software running on one or more processor configured to access and/or analyze merchant websites (e.g., scraping website data). Coupon code data may be stored in non-transitory computer-readable media comprising one or more databases.

In a step S2004, the computer system may receive and store the coupon code and attribute filters for which product variants apply. The information may be input according to a specific methodology that matches and syncs with the computer's internal algorithm and matching mechanisms. The user admin, using a specialized computer user interface, can enter an infinite amount of rules and stipulations into a database according to the merchant's promotion stipulations, the regular expression pattern of the merchant's website, as well as internal proprietary knowledge of the merchant's promotional cadence and methodology held internally in the company by the user admins, which may be stored (e.g., as logical rules or conditions) in one or more database.

In step S2006, product variants in the computer's database potentially related to the coupon code may be identified and flagged for review. The product variant and all relevant previously noted attributes and definitions (anywhere from 1 to 100 plus attributes associated with such products) can be stored in a codified and organized manner in computer-readable media comprising one or more databases for automatic matching and review.

In step S2008, the attributes associated with the product variant in the database may be retrieved and brought to the system's decision framework for review and matching.

In step S2010, the information entered according to a specific methodology in step S2004 may be matched exactly to the information retrieved in step S2008. The computer will match the information according to the methodology entered and stipulated in step S2004 and the product variant will then continue along the computer's decision path.

In step S2012, the product variant may be saved in the computer's database with promotional code status set to “No”. The product variant's current price with blankets (e.g., net effective price) may remain unchanged and not discounted any further.

In step S2014, the computer may make the decision related to the product variant's attribute viability or other combination of checks and balances or combinations of variants to question or call certain product variants in for quality assurance given regular expressions, price changes, and/or other related attributes. The user admin or another automated computer source will review the product variant flagged for review and make a determination on the attribute status as well as the coupon code application for the associated product variant.

In step S2016, the coupon code may be flagged as applied to the specific product variant and the computer can then associate the specifics of the code with the product variant's current price. The current price of the product variant can come from the computer's automated sources or data extraction software or in some cased from a user admin who reviewed the product variant to ensure quality assurance. The current price may then be discounted further by the computer's algorithm and the information entered by the user admin and the current price with blankets for the product variant (e.g., the net effective price) may be updated and discounted further as per the data in step S2002.

In step S2018, the information entered according to a specific methodology in step S2004 may be matched exactly to the information retrieved in step S2008 by the user admin or another automated quality assurance process. The user admin or the computer's quality assurance process can match the information according to the methodology entered and stipulated in step 52004, and the product variant may then continue along the computer's decision path.

In step 52020, the computer may continue throughout the product variant decision process and determine if a notification needs to be generated. A notification may be generated along a very specific set of rules and paths according to the specific user's alert preferences and the product variant's historical price fluctuations. Notifications can be determined and sent at the user level, and this process may no longer be a product variant level decision process.

In step 52022, the computer may have determined that a price alert notification is necessary. The notification preferences of the user may be noted, which can include a particular notification type according to the user's preferences (e.g., text message, push notification, instant message, Facebook message, and/or email notification). The notification combination noted in the user's preferences in the database may be created.

In step 52023, the system determines whether the notification requires quality assurance review, and if so proceeds to step 52024. If quality assurance is not necessary, the system proceeds to step 52026.

In step 52024, the notification may be flagged for quality assurance. The computer may allow the user admins (e.g., using specialized computer user interfaces) as well as additional computer processes to review the notifications for accuracy before automatically sending. In embodiments, the quality assurance step may be optional and review of a notification may be determined based on the user admin's proprietary knowledge of the merchant's promotional cadence and complexity of the promotion, which knowledge may be stored in one or more databases and/or programmed into computer code configured to apply one or more rules for notification evaluation.

In step 52026, the one or more notification may be queued to be transmitted to the user. Once the notification is queued it may be accepted as true on the front end of the computer interface (e.g., the website). All front end and user facing assets of the computer may be updated and reflected so that the user may have access to real time net effective pricing in all communications with the company and not just the notification avenue.

In step S2028, once notification is set as not needed for the promotion or coupon code, it may be accepted as true on the front end of the computer interface (e.g., the website). All front end and user facing assets of the computer may be updated and reflected so that the user may have access to real time net effective pricing in all communications with the company and not just the notification avenue.

Referring to FIG. 20B, in a step S2002 a computer system may mine data for one or more coupon codes. Coupon code data may comprise any of a coupon code (e.g., an alphanumeric text string), product attribute data associated with the coupon code, and/or coupon code redemption data (e.g., expiration date, information about required purchases, such as a minimum purchase or a specific product, and/or merchant information, to name a few). Mining coupon code data can entail receiving by a computer system coupon code data from a merchant and/or accessing by a computer system coupon code data, e.g. from one or more merchant websites. Mining may be performed by computer software running on one or more processor configured to access and/or analyze merchant websites (e.g., scraping website data). Coupon code data may be stored in non-transitory computer-readable media comprising one or more databases.

Still referring to FIG. 20B, in a step S2004, the computer system may receive and store the coupon code and attribute filters for which product variants apply. The information may be input according to a specific methodology that matches and syncs with the computer's internal algorithm and matching mechanisms. The user admin, using a specialized computer user interface, can enter an infinite amount of rules and stipulations into a database according to the merchant's promotion stipulations, the regular expression pattern of the merchant's website, as well as internal proprietary knowledge of the merchant's promotional cadence and methodology held internally in the company by the user admins, which may be stored (e.g., as logical rules or conditions) in one or more database.

Still referring to FIG. 20B, step S2040, refers to a daily process by which a computer system can trigger a request for data extraction software, or multiple instances of the data extraction software, to fetch the current price of all product variants available for sale on third-party merchant websites with which the platform is compatible. The system can also trigger a request for data extraction software, or multiple instances of the data extraction software, to fetch attribute information for all such product variants.

In step S2042, the computer's domain-specific data extraction software can read the third party merchant website and return current product variant information including current price. Data extraction software may be computer software or code that can fetch the price of an item from a third-party website. The data extraction software can also fetch other unique identifiers such as store URL, product ID, SKU number, style number, URL, and product title. These identifiers include item selections (e.g., size, color, width, to name a few). In addition, the data extraction software can read required regular expressions from every individual product variant's webpage and the regular expressions can be parsed according to the inputs and stipulations 2008 and categorized automatically at the product variant level according to 2006. Step S2024 may be better understood through flowcharts FIGS. 15A-15C of an exemplary process for attribute assignment in accordance with exemplary embodiments of the present invention. All attributes and read data can be stored in the computer's database for easy reference, filtering, and/or application.

Still referring to FIG. 20B, in step S2044, the computer may store all requisite attributes and correlate such defining qualities at the product variant and often at the product level. A product variant can have upwards of 100s of attributes associated with it to better define and analyze the specific details of the SKU and product makeup. In addition, the computer can store the specific item in the database and identify, based on recognition of the SKU and unique identifiers as well as the specific third party ecommerce site, attributes, or defining qualities needed to better classify the SKU.

In step S2046, the storage and notification system may receive via the software 210 a request to store information related to a product variant for sale. The system may receive this request via a user on a web browser, which may be better understood through the exemplary processes FIGS. 12A and 12B and exemplary screenshots FIGS. 8A-8F. The system may also receive this request via a user on using mobile application software, which may be better understood through the exemplary process FIG. 12C and exemplary screenshot FIG. 29.

In step S2048, the information entered according to a specific methodology in step S2004 may be matched exactly to the information retrieved in step S2044. The computer will match the information according to the methodology entered and stipulated in step S2004 and the product variant will then continue along the computer's decision path.

In step S2050, the product variant may be saved in the computer's database with promotional code status set to “No”. The product variant's current price with blankets (e.g., net effective price) may remain unchanged and not discounted any further and in step S2052 the system displays the current price of the product variant 808 in the interface 802 provided by item storing software 210 in accordance with exemplary embodiments of the present invention.

In step S2054, the coupon code may be flagged as applied to the specific product variant and the computer can then associate the specifics of the code with the product variant's current price. The current price of the product variant can come from the computer's automated sources or data extraction software. The current price may then be discounted further by the computer's algorithm and the information entered by the user admin and the current price with blankets for the product variant (e.g., the net effective price) may be updated and discounted further as per the data in step S2002.

In step S2056, all front end and user facing assets of the computer may be updated and reflected so that the user may have access to real time net effective pricing in all communications with the company and not just the notification avenue. In particular, system displays the net effective price 848 of the product variant in the interface 802g provided by item storing software 210 in accordance with exemplary embodiments of the present invention as depicted in FIG. 8G. The item storing window 802g may contain a current price excluding a promotional discount 808g. In embodiments, the item storing software 210 may display the net effective price including available promotional discounts 848, a promotional code 850 and promotion end dates 852, to name few. This information related to the promotion was entered into in the system in step S2004 and automatically retrieved and entered by the system in step S2056.

FIG. 21A is a flow chart for an exemplary process that takes user stored items and transforms them into products and product variants.

Referring to FIG. 21A, in a step S2102 a computer system can trigger a request to the database track a specific item's net effective pricing for sale on a third party ecommerce site.

In step S2104, the computer can store the specific item in the database and identify, based on recognition of the SKU and unique identifiers as well as the specific third party merchant website, attributes, or defining qualities needed to better classify the SKU. These unique identifiers may include store URL, product ID, SKU number, style number, URL, and product title. These identifiers include item selections (e.g., size, color, width, to name a few). In addition, the item is stored in the system with a unique identifier (i.e. a “Hukk” ID) that associates the item with the user whom initiated the request to track it in step S2102.

In step S2106, the system evaluates all existing products in the database and determines whether the new item can be matched to an existing product based on the characteristics of the new item. Products may indicate a single item that is available for sale at one or more merchants. If the system can find a match, the system proceeds to step S2108. If the system cannot find a match, it proceeds to steps S2110 and S2114 to create a new product and product variant in the system.

In step S2110, the system creates a new, unique product based upon all the unique item attributes. In step S2114, the system creates a new, unique product variant that is associated with the product created in step S2110, where the unique product variant may embody some number of the permutations and/or variations of product attributes available for the unique product

If in step S2106 the system is able to match the item to an existing product in the database, the system merges the item with that product in step S2108. In step S2112, the system evaluates all existing product variants associated with the product and determines whether the item can be matched to an existing product variant based on the item attribute selections (e.g., size, color, width, to name a few). If the items finds a an existing product variant associated with the product for which all selections match with the new item, then the new item is merged with that product variant.

If there is no existing product variant with which the item matches on all existing selections, then the system proceeds to step S2118. In step S2118, the system creates a new, unique product variant that is associated with the product to which the item was matched in step S2108.

FIGS. 21B-C are flow charts of exemplary processes for creating associations between product variants in accordance with exemplary embodiments of the present invention. Referring to FIG. 21B, in a step S2120 a computer system can trigger a request to the database track a specific product variant's net effective pricing for sale on a third party ecommerce site.

In step S2122, the computer's domain-specific data extraction software can read the third party ecommerce site and return current product variant information including current price. Data extraction software may be computer software or code that can fetch the price of a product variant from a third-party website. The data extraction software can also fetch other unique identifiers such as store URL, product ID, SKU number, style number, URL, and product title. These identifiers include product variant selections (e.g., size, color, width, to name a few). In addition, the data extraction software can read required regular expressions from every individual product variant's page and the regular expressions can be parsed according to previously entered inputs and stipulations. Step 2122 may be better understood through the flowchart 15B of exemplary processes for attribute assignment in accordance with exemplary embodiments of the present invention. All attributes and read data can be stored in the computer's database for easy reference, filtering, and/or application.

In step S2124, the computer may store all requisite attributes and correlate such defining qualities at the product variant and often at the product level. A product variant can have upwards of hundreds of attributes associated with it to better define and analyze the specific details of the SKU and product makeup. In addition, the computer can store the specific product variant in the database and identify, based on recognition of the product variant and unique identifiers as well as the specific third party merchant website, attributes, or defining qualities needed to better classify the product variant.

In step 52126, the system creates associations between products and product variants based on a number of attributes associated with the products and product variants. This attribute information may include store ID, store url, product ID, SKU number, style number, URL, and product title, user ID, item selections (e.g., size, color, width, to name a few). In addition, the system may leverage user purchase history associated with the products and variants, saved in step S1152 in FIG. 11C. This information can be used to develop analytical insights regarding user behavior and purchase decision-making. This information may be used in the future to create product recommendations and price comparisons such as “Popular Products at Your Favorite Merchant”, “Recommended Products Based on Your Hukks”, “Similar Products at Other Merchants”, “Users Also Hukk′d”, “Users Also Purchased”, and “Compare Prices with Other Merchants”. To create these recommendations, the system uses a formula for a product recommendation algorithm in accordance with exemplary embodiments of the present invention. This algorithm is (stored items)*(Browsing history)*(Purchase history)*(Demographic information)*(Friends' recommendations)*(Intent to purchase history).

The algorithmic factors that can be used to provide users with recommendations for new products based on stored items, browsing history, demographic data, favored merchants, purchase history and product variant attributes such as color, size or type of product, to name a few. Other users connected to a user via social networks may affect their product recommendations based on the same set of factors.

Referring to FIG. 24C, step 52428 refers to a daily process by which a computer system can trigger a request for price verification process to fetch the current price of all product variants available for sale on third-party merchant websites with which the platform is compatible. The system can also trigger a request for data extraction software, or multiple instances of the data extraction software, to fetch attribute information for all such product variants.

In step 52422, the computer's domain-specific data extraction software can read the third party ecommerce site and return current product variant information including current price. Data extraction software may be computer software or code that can fetch the price of a product variant from a third-party website. The data extraction software can also fetch other unique identifiers such as store URL, product ID, SKU number, style number, URL, and product title. These identifiers include product variant selections (e.g., size, color, width, to name a few). In addition, the data extraction software can read required regular expressions from every individual product variant's page and the regular expressions can be parsed according to previously entered inputs and stipulations. Step 2422 may be better understood through the flowchart of FIG. 15B of exemplary processes for attribute assignment in accordance with exemplary embodiments of the present invention. All attributes and read data can be stored in the computer's database for easy reference, filtering, and/or application.

In step 52424, the computer may store all requisite attributes and correlate such defining qualities at the product variant and often at the product level. A product variant can have upwards of hundreds of attributes associated with it to better define and analyze the specific details of the SKU and product makeup. In addition, the computer can store the specific product variant in the database and identify, based on recognition of the product variant and unique identifiers as well as the specific third party merchant website, attributes, or defining qualities needed to better classify the product variant.

In step 52434, the system creates associations between products and product variants based on a number of attributes associated with the products and product variants. This attribute information may include store ID, store url, product ID, SKU number, style number, URL, and product title, user ID, item selections (e.g., size, color, width, to name a few). In addition, the system may leverage user purchase history associated with the products and variants, saved in step S1152 in FIG. 11G. This information can be used to develop analytical insights regarding user behavior and purchase decision-making. This information may be used in the future to create product recommendations and price comparisons such as “Popular Products at Your Favorite Merchant”, “Recommended Products Based on Your Hukks”, “Similar Products at Other Merchants”, “Users Also Hukk′d”, “Users Also Purchased”, and “Compare Prices with Other Merchants”. To create these recommendations, the system uses a formula for a product recommendation algorithm in accordance with exemplary embodiments of the present invention. This algorithm is (stored items)*(Browsing history)*(Purchase history)*(Demographic information)*(Friends' recommendations)*(Intent to purchase history).

The algorithmic factors that can be used to provide users with recommendations for new products based on stored items, browsing history, demographic data, favored merchants, purchase history and product variant attributes such as color, size or type of product, to name a few. Other users connected to a user via social networks may affect their product recommendations based on the same set of factors.

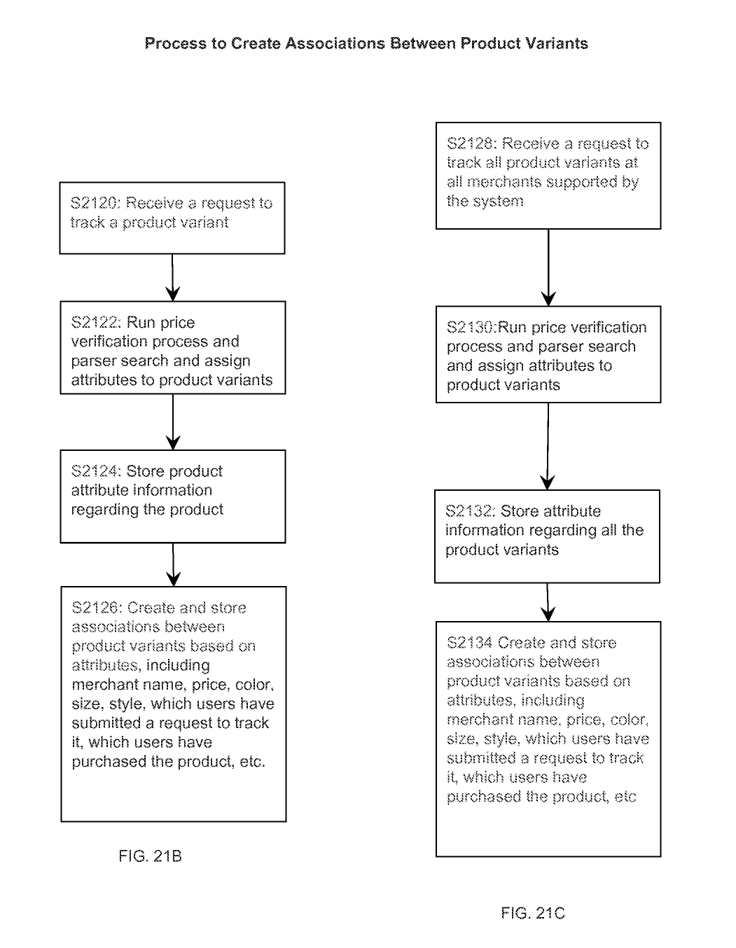

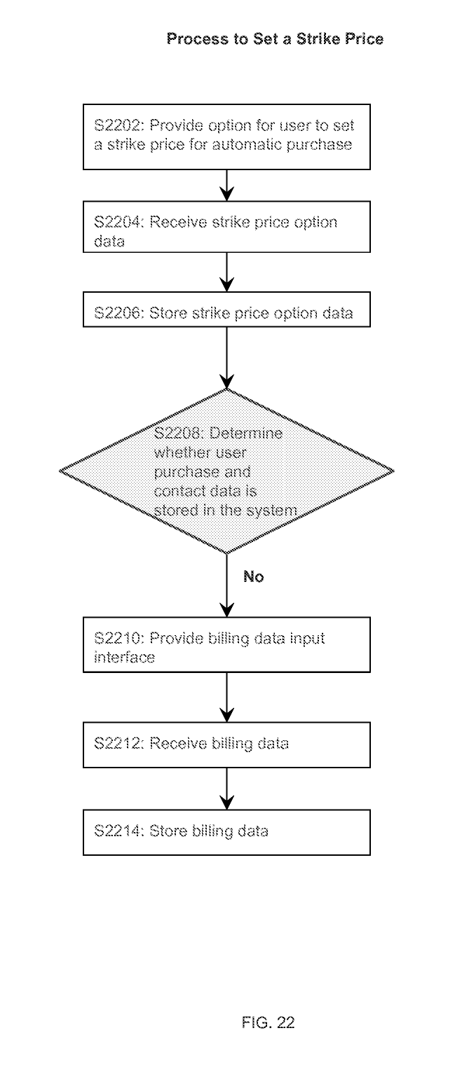

FIG. 22 is a flow chart of an exemplary process for setting strike prices for automatic purchase of chosen product variants. Users may conditionally set intermediate prices where they may not automatically purchase the product, but they will receive a notification. Merchants can receive access to actionable user data such as stored items, demographic information, purchase history, browsing habits and other metrics that can inform merchant decisions. Merchants may choose to give deals to users where strike prices indicate profitable opportunities to cut prices. Merchants may use user data to discover opportunities to upsell customers on additional products.

Referring to FIG. 22, in step 52202 the item storing software 210 may provide a user with a preference setting to automatically purchase items for sale via express pay, e.g., a strike price. The steps preceding 52202 are described in detail with respect to steps S1102-S1112 in FIG. 11A. The purchase preference setting may provide an option to purchase items for sale when an item is discounted at all 832, when an item is discounted at 25% 834, or when an item is discounted at 50% 836, to name a few. In embodiments, the software 210 may provide an option for a user to specify a discount percentage 838 or a sale price 840 at which a purchase is triggered.

In step 52204 the system receives these preferences from the user and stores them in the system in 52206.

In step 52208, the system determines whether the user's specific purchase information (e.g., credit card information, billing address, to name a few), contact information, and shipping preferences are stored in the system in the user profile table 216 and/or the shopping profile data 218. If purchase, contact and shipping data are not stored, then the system proceeds to step 52210 and presents an interface for the user to provide this data, which is received by the system 210 in 52212 and stored in the system 210 in 52214. Following this step, merchants can receive access to actionable user data such as stored items, demographic information, purchase history, browsing habits and other metrics that can inform merchant decisions. Merchants may choose to give deals to users where strike prices indicate profitable opportunities to cut prices. Merchants may use user data to discover opportunities to upsell customers on additional products.

Referring to FIG. 23, in step S2302 the item storing software 210 stores user preference settings for when the system should automatically purchase product variants for sale via express pay, e.g., a ‘strike price’.

In step S2304, the system monitors the price of the product variant. The monitoring of the price takes place on a daily basis. The system monitors the price of the product variant displayed on the website. In addition, the system determines whether a coupon code is active that may be applied to the item and result in an additionally discounted item price. Step S2304 may be better understood through flow chart FIG. 16 of an exemplary process to identify discounted items in accordance with exemplary embodiments of the present invention and through flow chart FIG. 20A of an exemplary processes to apply coupon codes to a product variant.

In a step S2306, the system may determine whether an item's price has changed such that it reaches the user specified ‘strike price’ and the system should purchase the product variant for sale on behalf of the user. If the price meets satisfies the strike price criteria, the system proceeds to step S2308. If the price does not satisfy the strike price criteria, the system may continue in step S2304 to monitor the price.

If in step S2306 the system determines that the current price satisfies the strike price criteria, a request to purchase the product variant will be generated in step S2308. In step S2309, the system determines whether the purchase request requires quality assurance review, and if so proceeds to step S2310. If quality assurance is not necessary, the system proceeds to step S2314.

In step S2310, this request to purchase the product variant may be created and queued for quality assurance by a user admin. The computer may allow the user admins (e.g., using specialized computer user interfaces) as well as additional computer processes to review the purchase request for accuracy before automatically purchasing the product. In embodiments, the quality assurance step may be optional and review of a purchase request may be determined based on the user admin's proprietary knowledge of the merchant's promotional cadence and complexity of the promotion, which knowledge may be stored in one or more databases and/or programmed into computer code configured to apply one or more rules for notification evaluation. Verification of purchase request accuracy may be received in step 52312.

In step 52314, the one or more purchase request may be queued to be transmitted to a third party web site. Once the purchase request is queued it may be accepted as true on the front end of the computer interface (e.g., the website). In step 52316, one or more notifications may be queued to be transmitted to the user to alert them of the purchase. At this time, all front end and user facing assets of the computer may be updated and reflected so that the user may have access to real time purchase status in all communications with the company and not just the notification avenue.

FIG. 24 is a flow chart of an exemplary process that can provide users with the ability to create product registries for weddings, babies, and other similar events. Users may select products for a registry of stored items or automatically import them from registries on other merchants' websites. The registry can stay synchronized with other registries and ensures that products that are sold out are marked off the lists of other associated merchant's online registries.

Referring to FIG. 24, in step 52402 the system receives a request from a user to create a new registry using the item storing software 210 and storing it on one or more of the databases of one or more data servers 112. The user may create this new registry on the website 902 associated with the program product that displays items for sale whose information was stored by a user in accordance with exemplary embodiments of the present invention. The user may select items for the registry by categorizing them as registry items via the data entry field 916. The user may also create this new registry by creating an account via a registry specific user interface that displays items for sale whose information was stored by a user in accordance with exemplary embodiments of the present invention with the specific. The items displayed on this interface are products specifically chosen by the user to be part of their registry for a life event such as wedding, new baby, new home, etc.

In step S2404, the system will request information from the user regarding any existing registries the user may have created at a third-party merchant website. This information may include merchant name, merchant website, log in information such as username and password, to name a few. The system receives this information from the user in S2406. Based upon information received in S2406, the system determines whether the user has existing registries at third-party merchant websites. If the user does not have any existing registries, the system proceeds to S2412. If the user does have existing registries, the system proceeds to step S2410.

In S2410, the system will use the information received in S2406 to sync with the user's existing registries created at third party merchant websites. The system will gather data regarding the specific items included in the third party merchant registry. This data may include merchant name, merchant website URL, product name, product URL, product ID, current product price, product in-stock status, product selections (e.g. size, color), number of items requested by the user, product purchase status (i.e. whether this items has been purchased on the third party web site for the user), to name a few. This information will be captured and used to create a list of products displayed on the website associated with the program product that displays items for sale.

In step S2412, the system may receive one or more requests by the user to store information related to an item for sale that the user wishes to include in their registry via the item storing software 210. The system may receive this request via a user on a web browser or via a user on using mobile application software.

In step S2414, the system may provide the option for the user to share the registry with other users. A user may share a single tile of the registry through electronic mail or social networking websites, e.g., Facebook, Twitter and Pinterest, to name a few. A user may share all tiles of the registry through electronic mail or social networking websites.

In step S2416, the system monitors the price of the product variants in the registry. The monitoring of the prices takes place on a daily basis. The system monitors the price of the product variants displayed on the merchant websites. The system may monitor the price of the product variant at the merchant website at which the user initiated the request to track the product, and may also monitor the price of the product variant at other merchant websites that present the same product variant for sale. In addition, the system determines whether a coupon code is active that may be applied to the item and result in an additionally discounted item price. Step 52416 may be better understood through flow chart FIG. 15 of an exemplary process to identify discounted items in accordance with exemplary embodiments of the present invention and through flow chart FIG. 20A of an exemplary processes to apply coupon codes to a product variant.

In a step 52418, the computer determines if the price has changed such that a price alert notification is necessary to either the original user that created the registry and/or any of the users with whom the registry has been shared. The notification preferences of each user may be noted and can include a particular notification type according to the user's preferences (e.g., text message, push notification, instant message, Facebook message, and/or email notification). The notification combination noted in the user's preferences in the database may be created and queued for quality assurance.

In 52420, the system will store purchase history related to an item that has been tracked using the item storing software 210 and purchased on a third-party merchant website. This information may include the name of the merchant at which the item was purchased, the item title, item price at the time or purchase, whether coupon codes where used during the purchase, the number of items purchased, and the specific item return policy information, to name a few. This information is gathered from multiple sources, including direct purchases made via the items storing software platform as well as data that has been integrated from the existing third party merchant registries.

In step 52422 the system will display all gathered product variant information on each tile in the registry website to indicate that an item has been purchased. In step S2424, the item storing software 210 sends information to the websites of the third party merchant registries to reflect the purchase status of items that have been purchased.

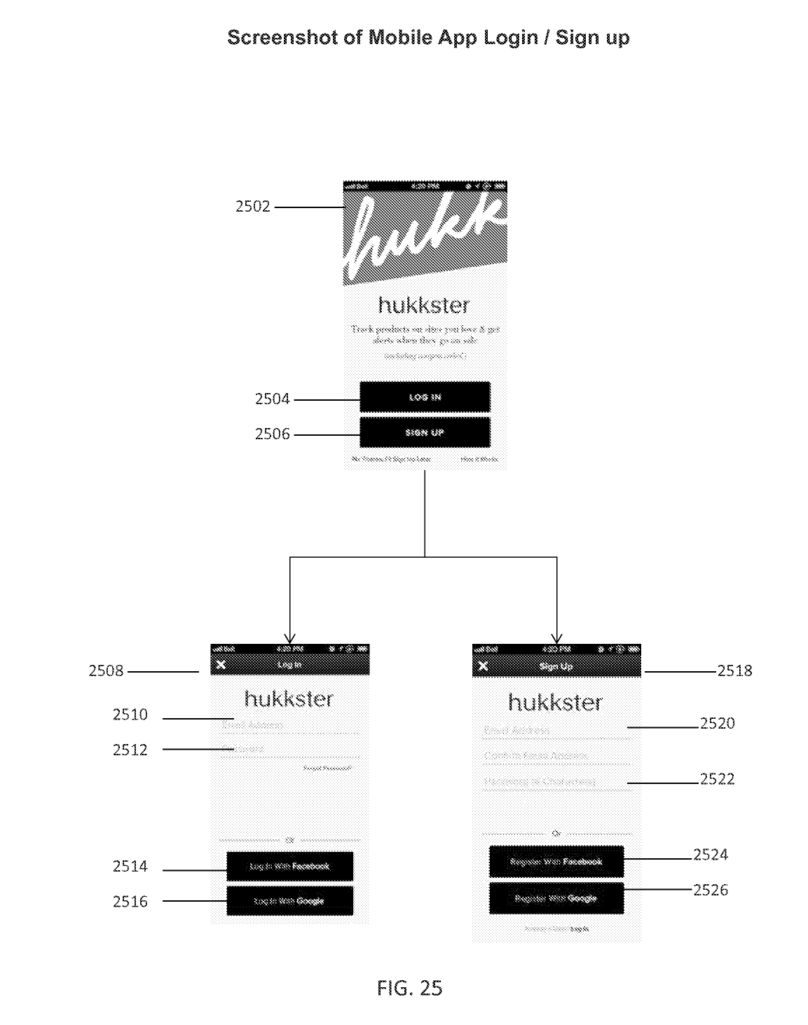

FIG. 25 is an exemplary screen shot of a registration screen and log in screen on the mobile iOS application in accordance with exemplary embodiments of the present invention. A new user may register for monitoring services by opening the mobile iOS application 2502 and selecting the registration request option 2506, e.g. “sign up” button. A registration screen 2518 may then be generated. To register, the website may request input of a unique email 2520 and a unique password 2522. The user may also register using a social network, such as Facebook 2524, or Google+ 2526, to name a few.

Further referring to FIG. 25, if the user has an existing account with the item storing software 210, the user may log in by opening the mobile iOS application 2502 and selecting the log in request option 2504. A login screen 2508 may then be generated. To log in, the website may request the user's chosen, unique username 2510 and password 2512. In embodiments, a username may be an email address. In embodiments, a user's log in may be associated with a social network, such as Facebook 2514 or Google+ 2516, to name a few.

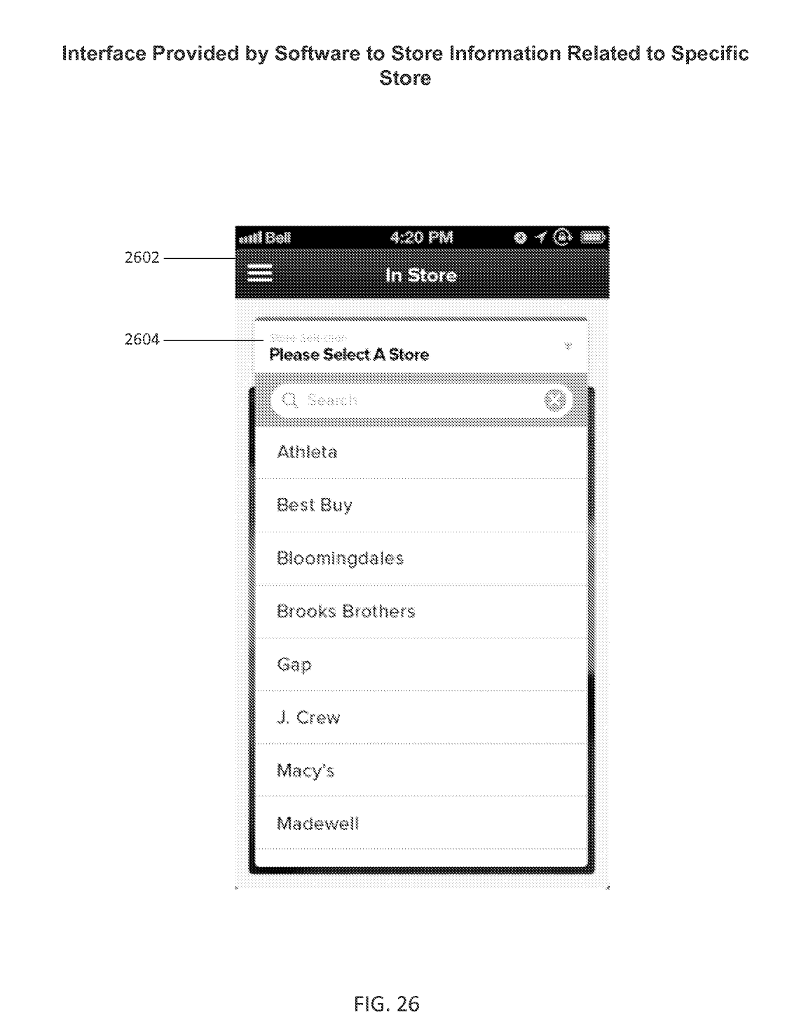

A user may use item storing software 210 to identify and store information related to items for sale found in a merchant's brick and mortar store. FIG. 26 is an exemplary screen shot of the interface provided by the software to save information associated with a product that user may wish to track. In embodiments, a user may use the mobile iOS application to request to track the information associated with a physical product found in a specific merchant's store. Upon a user's activation of the item storing software 210, e.g., by clicking a button requesting to store information via a physical product, the item storing software 210 may present a window 2602 displaying the store names. In embodiments, the store list may be auto-completed or populated in a selection menu 2604, e.g., a drop-down list. A user may then select the applicable store name 2604 of the product the user wishes to track.

FIG. 27 is an exemplary screen shot of the interface provided by the software to instruct the user on how to obtain the information necessary to store an item for sale found in a brick and mortar store. Upon a user selecting the associated store via the drop-down list 2704, the item storing software 210 may generate a window with store specific instructions on how to store product information 2702 (e.g., “style code”). In embodiments, the window 2702 may contain merchant identification information (such as a merchant name) 2704, an image of a merchant's physical price tag 2706, and an image of the store specific information 2708 required for saving a product in the item storing software 210, to name a few. A user may type the applicable product number, e.g. “style code”, into a data entry box 2710.

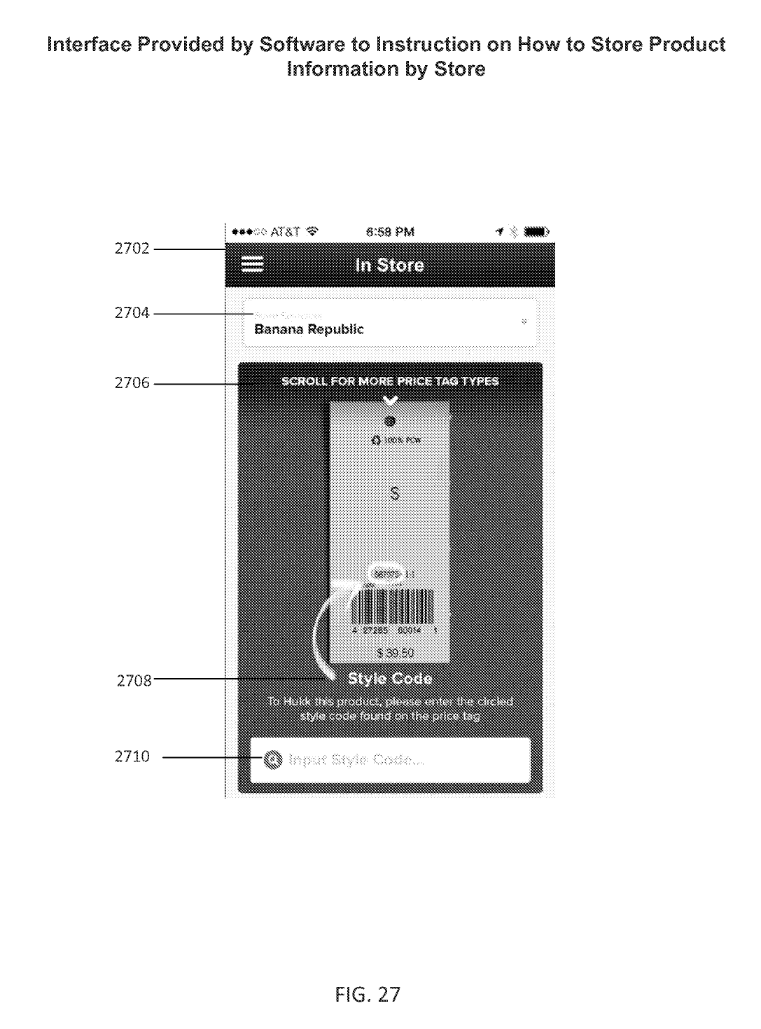

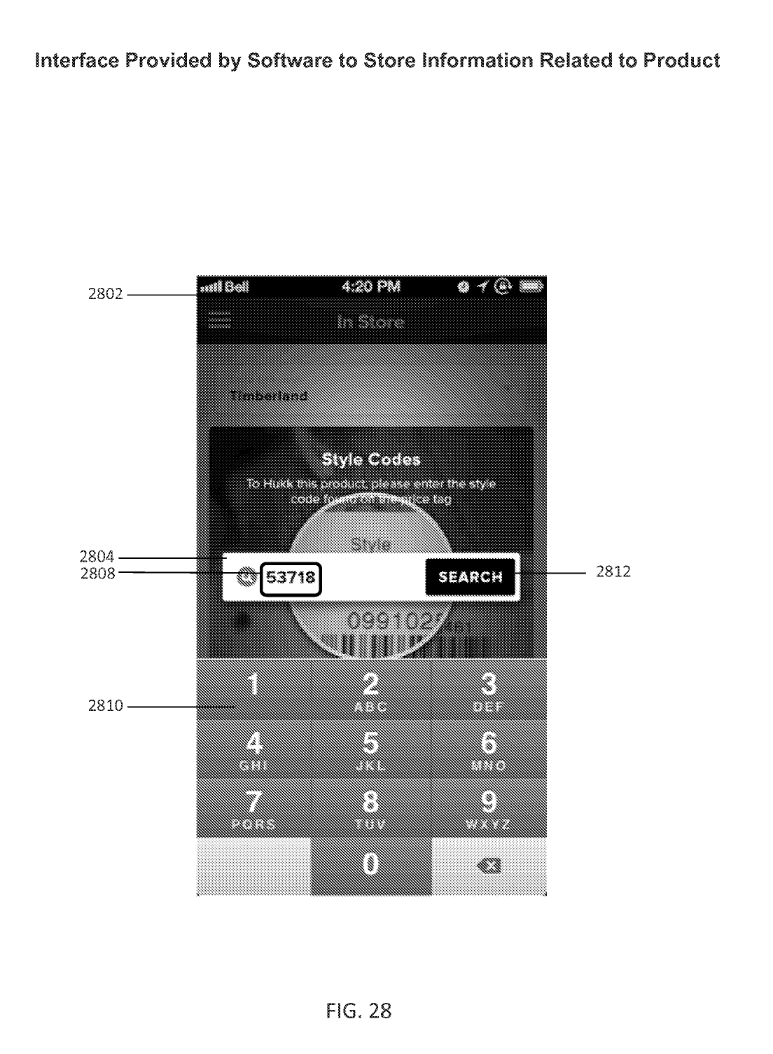

FIG. 28 is an exemplary screen shot of the interface provided by the software to allow the user to enter the requisite information, (e.g., “style code”) to store information associated with the product they wish to track. Upon a user's activation of the item storing software 210, e.g., by clicking the data entry box, an item storing window may be generated 2802. The item storing window 2802 may contain a data entry box for the product identification number 2804, e.g. “style code,” and a keypad to enter the applicable product identification number 2810, to name a few. A user may enter the product identification number 2808 via the data entry box 2804 and hit the search key 2812. Upon entering the search key 2812, the item storing software 210 will search for the item in the store website and display that item for review in item storing window 2840.

A user may use item storing software 210 to identify and store information related to items for sale. FIG. 29 shows an exemplary screen shot of the interface provided by item storing software 210 on a mobile iOS application in accordance with exemplary embodiments of the present invention. The item storing software 210 interfaces between the program product and one or more merchant websites that present items for sale. Upon a user's activation of the item storing software 210, e.g., by clicking a button to request storing product information, an item storing window 2940 may be generated. The item storing window 2940 may contain a product image 2938, a product name 2902, a product description, a product price 2914, product specifications, e.g. size 2906 and color 2908, and/or merchant identification information (such as a merchant name) 2904, to name a few. In embodiments, the item storing software 210 may automatically recognize and display any combination of these product identification data. For example, in embodiments, the item storing software 210 may automatically recognize the product price 2914. In embodiments, the software 210 may provide the user with an input field for any combination of the product identification data.

Still referring to FIG. 29, the item storing software 210 may provide a user with a price notification preference setting 2910, e.g., an option to receive notifications when an item is discounted at all 3218, when an item is discounted at 25% 2920, or when an item is discounted at 50% 2922, to name a few. In embodiments, the software 210 may provide an option for a user to specify a discount percentage 2924 or a sale price 2926 at which a sale notification is triggered. In embodiments, the item storing software 210 may provide a user with a preference setting to automatically purchase items for sale via express pay, e.g., a ‘strike price’. The purchase preference setting may provide an option to purchase items for sale when an item is discounted at all 2928, when an item is discounted at 25% 2930, or when an item is discounted at 50% 2932, to name a few. In embodiments, the software 210 may provide an option for a user to specify a discount percentage 2934 or a sale price 2936 at which the item may be automatically purchased by the system using a user's stored account information. This account information will include credit card, billing and shipping information previously provided by the user and stored in the user profile data 216. In embodiments, the software 210 may provide an option 2912 to categorize the product information to be stored, such as by adding to a list, e.g., Summer Clothing, Shoes, Home Goods, to name a few. In embodiments, categories may be provided by the system, e.g., via a drop-down list of predetermined categories, or may be user input, e.g., through a data entry field. In embodiments, a user's existing categories may be auto-completed or populated in a selection menu, e.g., a drop-down list. The item storing software 140 may provide a button 2916 to close the item storing window 2940 and store the product information and user preferences, e.g., price notification preferences 2910 and product categorization 2912. The item storing software 210 may provide a user with a price notification preference setting, e.g., an option to receive notifications when an item is discounted at all 822, when an item is discounted at 25% 824, or when an item is discounted at 50% 826, to name a few.

In embodiments, the program product and/or portions of the program product may be optimized and/or provided for one or more mobile applications for mobile devices running one or more operating systems, e.g., an iPhone application, an Android application, an application for Windows mobile devices, to name a few.

The invention may help reduce the number of emails sent to a user. For example, instead of subscribing to multiple newsletters from multiple merchants, which may include products that do not interest a user, a user may use the program product to receive notifications only of items of interest to the user.

In embodiments, the invention may be used to comparison shop. A user may store information related to a product from multiple merchants, using the invention to aggregate price information from the multiple merchants.

In embodiments, the invention may have psychological impacts on consumers. The program product may dissuade users from impulse purchase, which can involve a decision to purchase an item without premeditation and/or thorough analysis, to name a few. Users may be inclined to wait for a discount.

Systems in accordance with the present invention may associate stored items to a database of products based upon store URL, product ID, SKU number, style number, URL, and product title. Product variants may be matched based upon the above as well as item selections (e.g., size, color, width, to name a few).

A database may contain information regarding user browsing, tagging (expressing interest), and purchasing. This information can be leveraged to develop analytical insights regarding user behavior and purchase decision-making.

An administrative system contains ‘dashboard’ to highlight the volume of product variants currently being tracked by the item storing and discount notification system and the overall workload and expected time to complete daily process of blanket promotion creation, blanket promotion application, assigning attributes to products, price check, and final quality assurance review.

An administrative system may include a scheduling and assigning system that can assign tasks to workers and collaborators based upon their schedule and permissions (i.e., which tasks in the system they have authorization to perform).

An administrative system can include a performance review system that can monitor and report on workers′/collaborators' efficiency, accuracy, and/or adherence to schedules.

An administrative system can contain business rules that can dictate when quality assurance review must take place on a particular notification or when system reaches confidence level that quality assurance review is not required (e.g., checked 10% of notifications from a particular store with zero errors, ok to send rest of notifications without quality assurance check).

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A system comprising:
one or more processing modules; and
one more non-transitory memory storage modules storing computing instructions configured to run on the one or more processing modules and perform:
receiving a request associated with a pre-defined user purchase criteria for a product of one or more products from a software application (“app”) installed on an electronic device of a user, wherein the product is stored in a user database;
retrieving a pre-determined threshold price, for the product;
monitoring prices for the product and at least one discount applicable to the product at one or more websites of retailers based on the pre-defined user purchase criteria and the pre-determined threshold price;
based on the monitoring, determining when an effective price for the product matches the pre-defined user purchase criteria and is less than the pre-determined threshold price for the product, wherein the effective price is determined based on the at least one discount, and the at least one discount has a coupon code;
confirming whether the coupon code is active;
when the coupon code is confirmed to be active, transmitting a notification comprising the coupon code and a period of time when the coupon code remains active from a particular website of a particular retailer to the software app to be displayed on a graphical user interface of the electronic device of the user, wherein the user (a) accepts the notification, (b) declines the notification, or (c) requests other coupons, and wherein the one or more websites comprise the particular website, and the retailers comprise the particular retailer; and
upon acceptance of the notification by the user, automatically displaying the coupon code to the graphical user interface of the electronic device of the user.

2. The system of claim 1, wherein the pre-defined user purchase criteria comprises a product identifier, a brand, a target price, shipping information, or payment information.

3. The system of claim 1, wherein automatically displaying the coupon code further comprises automatically displaying coupon redemption data associated with the coupon code.

4. The system of claim 1, wherein the computing instructions are further configured to perform:
automatically executing a product purchase transaction at the effective price for the product for the user.

5. The system of claim 1, wherein the at least one applicable discount for the product are provided to the user via at least one of an email, a push notification, and a SMS text message.

6. The system of claim 1, wherein the computing instructions are further configured to perform:
confirming the whether the product of the one or more products is in stock when the effective price for the product matches the pre-defined user purchase criteria, wherein a result of the confirming whether the product of the one or more products is in stock is received from a product-discount search device in a retail store.

7. The system of claim 6, wherein the product-discount search device is a mobile device.

8. The system of claim 1, wherein the at least one discount further comprises a cart checkout coupon or a price markdown.

9. The system of claim 1, wherein the computing instructions are further configured to perform:
updating a record in the user database indicating that the at least one discount is applicable for the product associated with the pre-defined user purchase criteria.

10. The system of claim 1, wherein the computing instructions are further configured to perform:
querying the user database for the at least one product matching the pre-defined user purchase criteria to provide the product to the user as a recommendation.

11. A method comprising:
receiving, with a computer system using one or more processors, a request associated with a pre-defined user purchase criteria for a product of one or more products from a software application (“app”) installed on an electronic device of a user, wherein the product is stored in a user database;
retrieving, with the computer system, a pre-determined threshold price, for the product;
monitoring, with the computer system, prices for the product and at least one discount applicable to the product at one or more websites of retailers based on the pre-defined user purchase criteria and the pre-determined threshold price;
based on the monitoring, determining, with the computer system, when an effective price for the product matches the pre-defined user purchase criteria and is less than the pre-determined threshold price for the product, wherein the effective price is determined based on the at least one discount, and the at least one discount having a coupon code;
confirming, with the computer system, whether the coupon code is active;
when the coupon code is confirmed to be active, transmitting, with the computer system, a notification comprising the coupon code and a period of time when the coupon code remains active from a particular website of a particular retailer to the software app to be displayed on a graphical user interface of the electronic device of the user, wherein the user (a) accepts the notification, (b) declines the notification, or (c) requests other coupons, and wherein the one or more web sites comprise the particular website, and the retailers comprise the particular retailer; and
upon acceptance of the notification by the user, automatically displaying, with the computer system, the coupon code to the graphical user interface of the electronic device of the user.

12. The method of claim 11, wherein the pre-defined user purchase criteria comprises a product identifier, a brand, a target price, shipping information, or payment information.

13. The method of claim 11, wherein automatically di splaying the coupon code further comprises automatically displaying coupon redemption data associated with the coupon code.

14. The method of claim 11, further comprising:
automatically, with the computer system, executing a product purchase transaction at the effective price for the product for the user.

15. The method of claim 11, wherein the at least one discount and product information for the product are provided to the user via at least one of an email, a push notification, and a SMS text message.

16. The method of claim 11, further comprising:
confirming, with the computer system, the whether the product of the one or more products is in stock when the effective price for the product matches the pre-defined user purchase criteria, wherein a result of the confirming whether the product of the one or more products is in stock is received from a product-discount search device in a retail store

17. The method of claim 16, wherein the product-discount search device is a mobile device.

18. The method of claim 11, wherein the at least one discount further comprises a cart checkout coupon or a price markdown.

19. The method of claim 11, further comprising:
updating, with the computer system, a record in the user database indicating that the at least one discount is applicable for the product associated with the pre-defined user purchase criteria.

20. The method of claim 11, further comprising:
querying, with the computer system, the user database for the at least one product matching the pre-defined user purchase criteria to provide the product to the user as a recommendation.
